(19) United States
(12) Patent Application Publication
(10) Pub. No.: US 2002/0008799 A1
(43) Pub. Date: Jan. 24, 2002

(54) Liquid crystal display unit

(75) Inventors: Masuyuki Ota, Matsutou (JP); Masahiro Ishii, Mobara (JP); Masayuki Hikiba, Mobara (JP); Keiichirou Ashizawa, Mobara (JP); Takanori Nakayama, Mobara (JP)

Correspondence Address: Stanley P. Fisher, Reed Smith Hazel & Thomas LLP, Suite 1400, 3110 Fairview Park Drive, Falls Church, VA, 22042-4503, US

(73) Assignee: Hitachi, Ltd.

(21) Appl. No.: 09/899,855

(22) Filed: Jul. 9, 2001

(30) Foreign Application Priority Data
Jul. 10, 2000 (JP) 2000-208587

(51) Int. Cl. G02F 1/136

(52) U.S. Cl. 349/43

(57) ABSTRACT

In a liquid crystal display unit in IPS or FFS mode having a wide viewing angle, when a current is supplied to the unit so as to make display continuously, black spot-like unevenness (small dark or white spots) is produced. Since liquid crystal with low resistivity is used in IPS or FFS mode, impurities in the liquid crystal flow during display to form indeterminate black unevenness, or stay in an end portion of a display pattern producing an after image. To prevent this in a liquid crystal display unit, new electrodes or wires connected to at least one group of the scanning or video signal lines through-holes for restraining small dark or white spots are formed on the protective film, and electrodes connected to at least one group of the pixel electrodes, the opposed electrodes and opposed voltage signal lines are formed on opposite sides of the new electrodes or wires for restraining small dark or white spots.

### BACKGROUND OF THE INVENTION

The present invention relates to a liquid crystal display unit, and particularly relates to an active-matrix type liquid crystal display unit.

Active-matrix type liquid crystal display units using active devices typified by thin film transistors (TFTs) have come into wide use as display terminals for OA machines or the like because they have characteristics of being thin, light in weight and having a high picture quality as CRTs.

Such display system of liquid crystal display units are roughly classified into the following two modes. One mode is a mode in which liquid crystal is interposed between two substrates in which transparent electrodes are arranged respectively. In this mode, the liquid crystal is actuated by a voltage applied to the transparent electrodes, so that light entering the liquid crystal is modulated and displayed. Most of products currently put into wide use adopt this system. The other mode is a mode in which liquid crystal is actuated by an electric field between two electrodes arranged on one and the same substrate. Thus, light entering the liquid crystal is modulated and displayed. This mode has a feature of having an considerably wide viewing angle, and is adopted chiefly in a part of liquid crystal monitor products.

The features of the latter mode are, for example, disclosed in the documents of JP-A-5-505247 or JP-B-63-21907, JP-A-6-160878, JP-A-9-15650, JP-A-7-225388, JP-A-7-306417, JP-A-11-202356, U.S. Pat. No. 5,754,266, 2,701,698, 5,910,271, and so on.

Further, of the former mode, one in which electrodes are provided on a protective film is disclosed in JP-A-5-165059, JP-A-5-323373, JP-A-2000-89255, or U.S. Pat. No. 5,334,859.

However, it has been confirmed that, when a current is supplied to the liquid crystal display unit configured in the latter mode so that a display is made continuously, black spot-like unevenness (hereinafter referred to as “small dark or white spots”) is produced in places. In addition, it has been confirmed that such nuclear stains are apt to be produced particularly in a liquid crystal display unit using liquid crystal having cyano groups, as disclosed in JP-A-7-225388 or JP-A-7-306417.

In addition, it has been made apparent that there is another problem in the latter mode. That is, although liquid crystal with low resistivity can be used as disclosed in JP-A-7-306417, such liquid crystal has a tendency to capture impurities easily. Such impurities in the liquid crystal flow during display so as to form indeterminate black unevenness, or stay in an end portion of a display pattern so as to be observed as an after image (image persistence).

The present invention was developed on the basis of such circumstances. It is an object of the present invention to provide a liquid crystal display unit which prevents small dark or white spots which are evils peculiar to mass production of liquid crystal display units in an IPS (In-Plane Switching) mode or an FFS (Fringe-Field Switching) mode, and which has a wide viewing angle, high picture quality and high reliability.

### SUMMARY OF THE INVENTION

Of the inventions disclosed in this specification, the summary of typical one will be described briefly as follows. That is, there is provided a liquid crystal display unit in an IPS mode or in an FFS mode in which scanning signal lines, video signal lines, pixel electrodes and opposed electrodes for displaying an image are formed under a passivation film formed on one of a pair of substrates; a new electrode or wire for restraining nuclear stains is formed on the passivation film; and the new electrode or wire for restraining small dark or white spots is connected to the electrodes or wires for displaying an image through a through hole.

Thus, spot-like black unevenness (small dark or white spots) which may be produced when there are protective film defects on the respective electrodes and wires can be restrained.

Incidentally, in the present invention, cathode-side electrodes or wires include the scanning signal lines. Further, electrodes or wires having higher potential than the scanning signal lines are regarded as anode-side electrodes or wires. Such anode-side electrodes or wires include electrodes or wires required for displaying an image, such as the video signal lines, the pixel electrodes, the opposed electrodes, and so on.

In addition, in the present invention, electrodes connected to at least the pixel electrodes or the opposed electrodes are formed on opposite sides of the new electrode for restraining nuclear stains.

Thus, the lowering of the contrast ratio or the production of vertical smear caused as a side effect of the new electrode for restraining small dark or white spots can be restrained.

### BRIEF DESCRIPTION OF THE DRAWINGS

FIG. 1 is a plan view showing one pixel in a liquid crystal display portion of an active-matrix type color liquid crystal display unit in Embodiment 1 of the present invention;

FIG. 2 is a plan view showing the periphery of the pixel in the liquid crystal display portion of the active-matrix type color liquid crystal display unit in Embodiment 1 of the present invention;

FIG. 3 is a sectional view of a liquid crystal switching area portion, taken on line A-A′ in FIG. 1;

FIG. 4 is a sectional view of a thin film transistor device TFT portion, taken on line B-B′ in FIG. 1;

FIG. 5 is a sectional view of a storage capacitance Cstg portion, taken on line C-C′ in FIG. 1;

FIG. 6 is a sectional view of an ST electrode ST portion, taken on line D-D′ in FIG. 1;

FIG. 7 is a plan view for explaining the configuration of a matrix circumferential portion of a display panel;

Diagrams (a) and (b) of FIG. 8 are a plan view and a sectional view showing the vicinity of a connection portion between a gate terminal GTM and a gate wire GL;

Diagrams (a) and (b) of FIG. 9 are a plan view and a sectional view showing the vicinity of a connection portion between a drain terminal DTM and a video signal line DL;

Diagrams (a) and (b) of FIG. 10 are a plan view and a sectional view showing the vicinity of a connection portion among a common electrode terminal CTM1, a common bus line CB1 and a common voltage signal line CL;

Diagrams (a) and (b) of FIG. 11 are a plan view and a sectional view showing the vicinity of a connection portion among a common electrode terminal CTM2, a common bus line CB2 and the common voltage signal line CL;

FIG. 12 is a circuit diagram including a matrix portion and its periphery of an active-matrix type color liquid crystal display unit according to the present invention;

FIG. 13 is a chart showing driving waveforms of the active-matrix type color liquid crystal display unit according to Embodiment 1 of the present invention;

FIG. 14 is a flow chart of sectional views of a pixel portion and a gate terminal portion, showing Steps A to C of a manufacturing process on a substrate SUB1 side;

FIG. 15 is a flow chart of sectional views of the pixel portion and the gate terminal portion, showing Steps D and E of the manufacturing process on the substrate SUB1 side;

FIG. 16 is a flow chart of sectional views of the pixel portion and the gate terminal portion, showing Step F of the manufacturing process on the substrate SUB1 side;

FIG. 17 is a top view showing the state where peripheral driving circuits have been mounted on a liquid crystal display panel;

FIG. 18 is a diagram showing the sectional structure of a tape carrier package TCP in which an integrated circuit chip CHI constituting a driving circuit has been mounted on a flexible wiring board;

FIG. 19 is a main portion sectional view showing the state where the tape carrier package TCP has been connected to the scanning signal circuit terminal GTM of the liquid crystal display panel PNL;

FIG. 20 is an exploded perspective view of a liquid crystal display module;

FIG. 21 is a diagram showing the angle between a rubbing direction and the transmission axis of a polarizing plate in Embodiment 1;

FIG. 22 is a plan view showing one pixel of a liquid crystal display portion of an active-matrix type color liquid crystal display unit according to Embodiment 2 of the present invention;

FIG. 23 is a sectional view of an ST electrode ST, taken on line D-D′ in FIG. 22;

FIG. 24 is a plan view showing one pixel of a liquid crystal display portion of an active-matrix type color liquid crystal display unit according to Embodiment 3 of the present invention;

FIG. 25 is a sectional view of an ST electrode ST, taken on line D-D′ in FIG. 22;

FIG. 26 is a plan view showing one pixel of a liquid crystal display portion of an active-matrix type color liquid crystal display unit according to Embodiment 4 of the present invention;

FIG. 27 is a plan view showing the periphery of the pixel of the liquid crystal display portion of the active-matrix type color liquid crystal display unit according to Embodiment 4 of the present invention;

FIG. 28 is a sectional view of an ST electrode ST portion and an auxiliary capacitance Cadd portion, taken on line D-D′ in FIG. 26;

FIG. 29 is a plan view showing one pixel of a liquid crystal display portion of an active-matrix type color liquid crystal display unit according to Embodiment 5 of the present invention;

FIG. 30 is a plan view showing one pixel of a liquid crystal display portion of an active-matrix type color liquid crystal display unit according to Embodiment 6 of the present invention;

FIG. 31 is a plan view showing one pixel of a liquid crystal display portion of an active-matrix type color liquid crystal display unit according to Embodiment 7 of the present invention;

FIG. 32 is a plan view showing one pixel of a liquid crystal display portion of an active-matrix type color liquid crystal display unit according to Embodiment 8 of the present invention;

FIG. 33 is a plan view showing one pixel of a liquid crystal display portion of an active-matrix type color liquid crystal display unit according to Embodiment 9 of the present invention;

FIG. 34 is a chart showing driving waveforms of an active-matrix type color liquid crystal display unit according to Embodiment 12 of the present invention;

FIG. 35 is a plan view showing one pixel of a liquid crystal display portion of an active-matrix type color liquid crystal display unit according to Embodiment 13 of the present invention;

FIG. 36 is a plan view showing one pixel of a liquid crystal display portion of an active-matrix type color liquid crystal display unit according to Embodiment 14 of the present invention;

FIG. 37 is a plan view showing one pixel of a liquid crystal display portion of an active-matrix type color liquid crystal display unit according to Embodiment 15 of the present invention;

FIG. 38 is a plan view showing one pixel of a liquid crystal display portion of an active-matrix type color liquid crystal display unit according to Embodiment 16 of the present invention;

FIG. 39 is a plan view showing one pixel of a liquid crystal display portion of an active-matrix type color liquid crystal display unit according to Embodiment 17 of the present invention;

FIG. 40 is a plan view showing one pixel of a liquid crystal display portion of an active-matrix type color liquid crystal display unit according to Embodiment 18 of the present invention;

FIG. 41 is a plan view showing one pixel of a liquid crystal display portion of an active-matrix type color liquid crystal display unit according to Embodiment 19 of the present invention;

FIG. 42 is a plan view showing one pixel of a liquid crystal display portion of an active-matrix type color liquid crystal display unit according to Embodiment 22 of the present invention;

FIG. 43 is a plan view showing one pixel of a liquid crystal display portion of an active-matrix type color liquid crystal display unit according to Embodiment 23 of the present invention;

FIG. 44 is a sectional view of an ST electrode ST portion, taken on line E-E′ in FIG. 43;

FIG. 45 is a plan view showing a connection portion between the ST electrode ST and a video signal line in the vicinity of the lower side of the liquid crystal display portion (in an area out of a qualified display area) of the active-matrix type color liquid crystal display unit according to Embodiment 23 of the present invention;

FIG. 46 is a plan view showing one pixel of a liquid crystal display portion of an active-matrix type color liquid crystal display unit according to Embodiment 24 of the present invention;

FIG. 47 is a sectional view of an ST electrode ST portion, taken on line F-F′ in FIG. 46;

FIG. 48 is a plan view showing one pixel of a liquid crystal display portion of an active-matrix type color liquid crystal display unit according to an embodiment of the present invention;

FIG. 49 is a plan view showing one pixel of a liquid crystal display portion of an active-matrix type color liquid crystal display unit according to an embodiment of the present invention;

FIG. 50 is a plan view showing one pixel of a liquid crystal display portion of an active-matrix type color liquid crystal display unit according to an embodiment of the present invention;

FIG. 51 is a plan view showing one pixel of a liquid crystal display portion of an active-matrix type color liquid crystal display unit according to an embodiment of the present invention;

FIG. 52 is a plan view showing one pixel of a liquid crystal display portion of an active-matrix type color liquid crystal display unit according to an embodiment of the present invention;

FIG. 53 is a plan view showing one pixel of a liquid crystal display portion of an active-matrix type color liquid crystal display unit according to an embodiment of the present invention;

FIG. 54 is a plan view showing one pixel of a liquid crystal display portion of an active-matrix type color liquid crystal display unit according to an embodiment of the present invention;

FIG. 55 is a plan view showing one pixel of a liquid crystal display portion of an active-matrix type color liquid crystal display unit according to an embodiment of the present invention;

FIG. 56 is a plan view showing one pixel of a liquid crystal display portion of an active-matrix type color liquid crystal display unit according to an embodiment of the present invention;

FIG. 57 is a plan view showing one pixel of a liquid crystal display portion of an active-matrix type color liquid crystal display unit according to an embodiment of the present invention;

FIG. 58 is a plan view showing one pixel of a liquid crystal display portion of an active-matrix type color liquid crystal display unit according to an embodiment of the present invention;

FIG. 59 is a plan view showing one pixel of a liquid crystal display portion of an active-matrix type color liquid crystal display unit according to an embodiment of the present invention;

FIG. 60 is a sectional view showing one pixel of the liquid crystal display portion of the active-matrix type color liquid crystal display unit according to the embodiment of the present invention;

FIG. 61 is a plan view showing one pixel of a liquid crystal display portion of an active-matrix type color liquid crystal display unit according to an embodiment of the present invention;

FIG. 62 is a plan view showing one pixel of a liquid crystal display portion of an active-matrix type color liquid crystal display unit according to an embodiment of the present invention;

FIG. 63 is a plan view showing one pixel of a liquid crystal display portion of an active-matrix type color liquid crystal display unit according to an embodiment of the present invention;

FIG. 64 is a plan view showing one pixel of a liquid crystal display portion of an active-matrix type color liquid crystal display unit according to an embodiment of the present invention;

FIG. 65 is a plan view showing one pixel of a liquid crystal display portion of an active-matrix type color liquid crystal display unit according to an embodiment of the present invention;

FIG. 66 is a plan view showing one pixel of a liquid crystal display portion of an active-matrix type color liquid crystal display unit according to an embodiment of the present invention;

FIG. 67 is a plan view showing one pixel of a liquid crystal display portion of an active-matrix type color liquid crystal display unit according to an embodiment of the present invention;

FIG. 68 is a plan view showing one pixel of a liquid crystal display portion of an active-matrix type color liquid crystal display unit according to an embodiment of the present invention;

FIG. 69 is a plan view showing one pixel of a liquid crystal display portion of an active-matrix type color liquid crystal display unit according to an embodiment of the present invention;

FIG. 70 is a plan view showing one pixel in a conventional example;

FIG. 71 is a view showing the principle with which a nuclear stain is produced on the anode side;

FIG. 72 is a view showing the principle with which a nuclear stain is produced on the cathode side;

FIG. 73 is a view showing an example of a molecular structure of a cyano liquid crystal;

FIG. 74 is a view showing an example of an oxidation reaction of a cyano liquid crystal;

FIG. 75 is a view showing the principle with which the production of a nuclear stain is restrained when an ST electrode is disposed on the anode side;

FIG. 76 is a view showing the principle with which the production of a small dark or white spot is restrained when an ST electrode is disposed on the cathode side;

FIG. 77 is a plan view showing another embodiment of a pixel of a liquid crystal display unit according to the present invention;

FIG. 78 is a sectional view taken on line A-A′ in FIG. 77;

FIG. 79 is a sectional view taken on line B-B′ in FIG. 77;

FIG. 80 is a sectional view taken on line C-C′ in FIG. 77;

FIG. 81 is a sectional view taken on line D-D′ in FIG. 77;

FIG. 82 is a sectional view taken on line E-E′ in FIG. 77;

FIG. 83 is a sectional view, correspondingly to FIG. 82, showing another embodiment of a liquid crystal display unit according to the present invention;

FIG. 84 is a plan view showing another embodiment of a pixel of a liquid crystal display unit according to the present invention;

FIG. 85 is a plan view showing another embodiment of a pixel of a liquid crystal display unit according to the present invention; and

FIG. 86 is a sectional view taken on line F-F′ in FIG. 85.

### DESCRIPTION OF THE PREFERRED EMBODIMENTS

The present invention will be described specifically below. Incidentally, all the combinations of the following embodiments belong to the category of the present invention.

(Embodiment 1)

<<Active-Matrix Liquid Crystal Display Unit>>

An embodiment in which the present invention has been applied to an active-matrix type color liquid crystal display unit will be described below. Incidentally, in the drawings described below, parts having the same functions are referenced correspondingly, and they are not described repeatedly.

<<Plane Configuration of Matrix Portion (Pixel Portion)>>

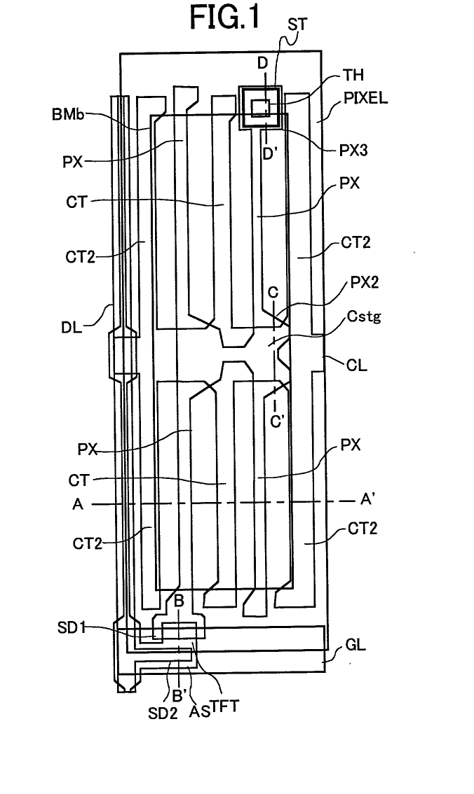

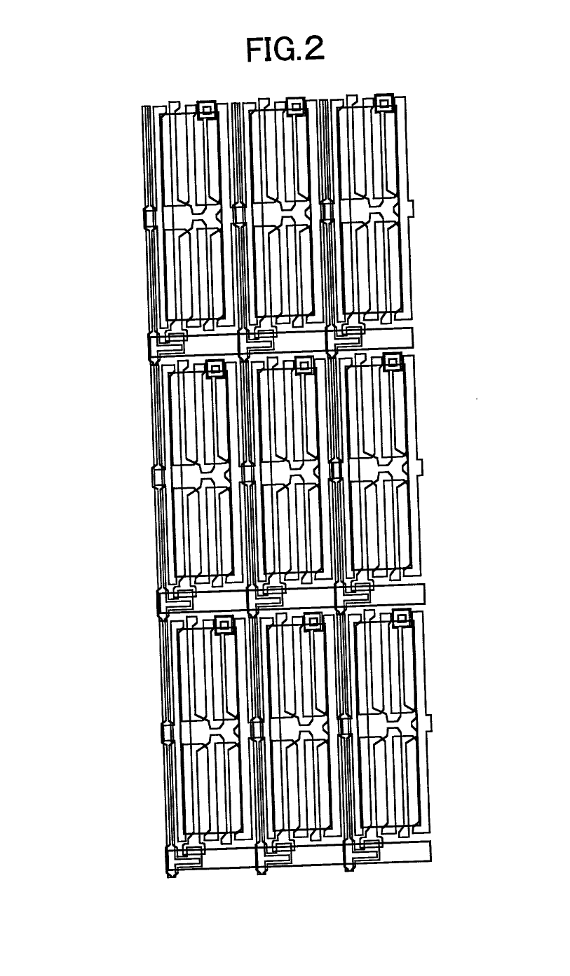

FIG. 1 is a plan view showing one pixel of an active-matrix type color liquid crystal display unit according to the present invention. FIG. 2 is a plan view showing the relationship between the pixel in FIG. 1 and its periphery.

As shown in FIGS. 1 and 2, each pixel PIXEL is disposed in a cross area defined by two adjacent scanning signal lines (gate signal lines or horizontal signal lines) GL and two adjacent video signal lines (drain signal lines or vertical signal lines) DL (that is, in an area enclosed by four signal lines). Each pixel PIXEL includes a thin film transistor TFT, a storage capacitance Cstg, a pixel electrode PX, opposed electrodes CT and CT2, and an opposed voltage signal line CL. Such scanning signal lines GL and such opposed voltage signal lines CL are disposed in a plurality of horizontal lines so as to extend in the left/right direction in FIGS. 1 and 2 respectively. On the other hand, such video signal lines DL are disposed in a plurality of vertical lines so as to extend in the upper/lower direction respectively. The pixel electrode PX is formed of a conductive film d3, and electrically connected to the thin film transistor TFT through a source electrode SD1 formed integrally with the pixel electrode PX. On the other hand, the opposed electrodes CT and CT2 are formed of a conductive film g3, and electrically connected to the opposed voltage signal line CL. A drain electrode SD2 of the thin film transistor TFT is formed of one and the same conductive film d3 as the pixel electrode PX. The drain electrode SD2 is formed integrally with the video signal line DL. Incidentally, a part of the scanning signal line GL is also used as the gate electrode of the thin film transistor TFT. Further, the storage capacitance Cstg is formed by overlaying the opposed voltage signal line CL and a part PX2 of the pixel electrode on each other.

The pixel electrode PX and each of the opposed electrodes CT and CT2 are opposed to each other so as to generate an electric field between the pixel electrode PX and each of the opposed electrodes CT and CT2. The electric field is substantially parallel with the substrate surface or has a component parallel with the substrate surface. The optical conditions of liquid crystal LC are controlled by the electric field. Thus, display is controlled. The pixel electrode PX and the opposed electrodes CT and CT2 are formed like comb teeth so that they are electrodes elongated vertically in FIGS. 1 and 2, respectively.

Each pixel is arranged so that the number O (the number of comb teeth) of the opposed electrodes CT and the number P (the number of comb teeth) of the pixel electrodes PX in one pixel always have a relation of O=P−1 (O=1 and P=2 in this embodiment). In addition, the number of the opposed electrodes CT2 is indispensably set to be two. As a result, the opposed electrodes CT and CT2 and the pixel electrodes PX are disposed alternatively, and the opposed electrodes CT2 are always adjacent to the video signal lines DL. Thus, electric flux lines from the video signal lines DL can be shielded by the opposed electrodes CT2 so as to prevent the electric field between the opposed electrodes CT and CT2 and the pixel electrode PX from being affected by electric fields generated from the video signal lines DL. Since the opposed electrodes CT2 are always supplied with electric potential from the outside through the opposed voltage signal line CL, the potential of the opposed electrodes CT2 is stable. Accordingly, there is little fluctuation in the potential even if the opposed electrodes CT2 are adjacent to the video signal lines DL. As a result, the geometric distance between the pixel electrode PX and the video signal line DL becomes so long that the parasitic capacitance between the pixel electrode PX and the video signal line DL is reduced on a large scale. Thus, the fluctuation of pixel electrode potential Vs caused by a video signal voltage can be also suppressed.

As a result, crosstalk (failure in picture quality called vertical smear) generated vertically can be suppressed.

In order to increase the aperture ratio, the electrode width of the pixel electrode PX is made as small as the accuracy of finishing can allow. In addition, in order to increase the aperture ratio, the electrode width of the opposed electrode CT is also made as small as the accuracy of finishing can allow. In this embodiment, the electrode width of the pixel electrode PX is made 5 μm, and the electrode width of the opposed electrode CT is made 5 μm. Alternatively, the pixel electrode PX and the opposed electrode CT may be made different in electrode width. For example, the electrode widths of the pixel electrode PX and the opposed electrode CT may be made 4 μm, 6 μm, 7 μm, 8 μm, or the like, differently from each other, in accordance with circumstances on pixel design.

On the other hand, the electrode width of the video signal line DL may be made equal to the electrode width of the pixel electrode PX or the opposed electrode CT. To prevent disconnection, however, it is preferable that the video signal line DL is made a little wider than the pixel electrode PX or the opposed electrode CT. In this embodiment, the electrode width of the video signal line DL is made 8 μm. Here, the electrode width of the video signal line DL is set to be smaller than twice as large as the electrode width of the adjacent opposed electrode CT2. Alternatively, if the electrode width of the video signal line DL has been determined from the yield and the productivity, the electrode width of the opposed electrode CT2 adjacent to the video signal line DL is set to a value larger than ½ of the electrode width of the video signal line DL. This is because electric flux lines generated from the video signal line DL are absorbed by the opposed electrodes CT2 on the opposite sides of the video signal line DL. To absorb electric flux lines generated from an electrode width, an electrode has to have an electrode width not smaller than the first-mentioned electrode width.

Accordingly, it will go well if each of the opposed electrodes CT2 on the opposite sides of the video signal line DL absorbs electric flux lines generated from half (4 μm wide) of the electrode of the video signal line DL. Therefore, the electrode width of each opposed electrode CT adjacent to the video signal line DL is set to be larger than ½ of the electrode width of the video signal line DL.

In addition, to actuate liquid crystal molecules in the area between the opposed electrode CT2 and the pixel electrode PX, the opposed electrode CT2 has to absorb electric flux lines of the pixel electrode PX so as to generate an electric field. Therefore, the electrode width of the opposed electrode CT2 has to be larger than ½ of the electrode width of the pixel electrode PX. Thus, to satisfy both the conditions described above, the electrode width of the opposed electrode CT2 has to be not smaller than a value obtained by adding ½ of the electrode width of the pixel electrode PX to ½ of the electrode width of the video signal line DL. In this embodiment, the electrode width of the opposed electrode CT2 is set to be 10 μm. In addition, as a whole, it is preferable that a value which is obtained by adding the total width of the pixel electrodes PX to the width of the video signal line is set to be not larger than the sum of the widths of the opposed electrodes CT and CT2.

Thus, the electric field between the pixel electrode PX and the opposed electrodes CT and CT2 can be applied effectively and uniformly, while crosstalk, particularly vertical (lengthwise) crosstalk can be prevented from being produced by the influence of video signals.

In addition, it is preferable that the widths of the pixel electrode PX, the opposed electrodes CT and CT2, and the video signal line DL with respect to the thickness direction of a liquid crystal layer are made larger than the thickness of the liquid crystal layer, which will be described later, in order to apply a sufficient electric field to the whole of the liquid crystal layer.

The electrode width of the scanning signal line GL is set to satisfy a resistance value enough to apply a sufficient scanning voltage to a gate electrode GT of a tail-end-side pixel (on the opposite side to a scanning electrode terminal GTM which will be described later). In addition, the electrode width of the opposed voltage signal line CL is also set to satisfy a resistance value enough to apply a sufficient opposed voltage to an opposed electrode CT of a tail-end-side pixel (a pixel furthest from common bus lines CB1 and CB2 which will be described later, that is, a pixel between the common bus lines CB1 and CB2).

On the other hand, the electrode distance between the pixel electrode PX and the opposed electrodes CT and CT2, the number of the pixel electrodes PX and the number of opposed electrodes CT are determined in accordance with the pixel pitch, the liquid crystal material, particularly the driving voltage parameters peculiar to the liquid crystal material, and the withstand voltage of a video signal drive circuit (signal-side driver). This is because the electric field intensity to attain the maximum transmissivity varies in accordance with the liquid crystal material. Thus, the electrode distance is set in accordance with the liquid crystal material so as to obtain the maximum transmissivity in a range of the maximum amplitude of a signal voltage set in accordance with the withstand voltage of the video signal drive circuit (signal-side driver) to be used. In this embodiment, since the pixel pitch is set to be 99 μm, the electrode distance and the number of the pixel electrodes PX are set to 13.5 μm and 4 respectively on the basis of the driving voltage parameters determined by permittivity anisotropy Δε and twist elastic constant K22 of the liquid crystal material, which will be described later.

Incidentally, the specific numeric values shown in this embodiment are afforded only by way of example. It is apparent that the same effect as that in the present invention can be obtained by any desired setting so long as the values are within a range to satisfy the above-mentioned relations.

The most essential constituent which is the substance of the present invention is an ST electrode ST shown in FIG. 1 (occasionally referred to as “first electrode” in this specification). Stains (small dark or white spots) darkened in black circular spots can be reduced by this ST electrode ST. In this embodiment, the ST electrode ST is connected to a part PX3 of the pixel electrode through a through hole TH. The detail will be described below.

<<ST Electrode: First Electrode>>

The ST electrode ST which is the substance of the present invention can reduce stains (nuclear stains) getting dark in black circular spots with electric conduction time.

FIG. 70 shows a plan view of one pixel in a conventional example. In the pixel in FIG. 70, there is no electrode on a protective film PSV, while respective electrodes and respective wires are perfectly insulated from liquid crystal by the protective film PSV. Small dark or white spots are produced by the retention rate of liquid crystal lowered by the electrode reaction caused by a DC current flowing into the liquid crystal. The principle will be shown below.

It has been considered that the reason why a current flows into the liquid crystal in the conventional pixel is that two electrodes different in potential are exposed onto the protective film PSV so that a leak current flows between the electrodes. However, as a result of observing small dark or white spot portions by using a microscope, only one defect in an insulating film can be observed in most of the small dark or white spot portions. From this fact, there is inferred a mechanism caused by a current generated by a charge of electricity given from an exposed electrode to a protective film capacitance for another electrode. In this case, even if there is only one defect in the protective film, a charging current flows to produce a small dark or white spot.

Therefore, trial pieces in which defects were formed in protective films PSV and insulating films GI on purpose were manufactured to confirm the states of small dark or white spot s. As a result, a small dark or white spot was produced in an area where a defect was made on only one electrode, and two small dark or white spots were observed in an area where defects were provided in two electrodes having different potentials respectively. Thus, it was made clear that such stains were produced in the defect portions respectively. Also from this fact, it was confirmed that small dark or white spots were produced by the electrode reaction caused by a charging current supplied to the protective film capacitance.

The detailed mechanism is shown in FIGS. 71 and 72. As shown in FIG. 71, for example, on an anode-side electrode with high potential, a foreign substance made of metal and causing a defect in a protective film, or the electrode itself is oxidized into positive ions. The positive ions charge a protective film capacitance for another electrode up to the anode-side potential. Such a charging current also flows into surrounding pixel capacitance so that the area charged to the anode-side potential is expanded. In the charged area, positive ions increase. Accordingly, ion concentration becomes so high that the resistivity of the liquid crystal falls off. Thus, the retention rate of a voltage applied to the liquid crystal falls off. As a result, in a normally black mode to obtain black with no voltage applied, pixels around the defect protective film become darker than the further surrounding pixels so as to be observed as black spot-like luminance unevenness.

On the other hand, as shown in FIG. 72, on the a cathode-side electrode with low potential, liquid crystal molecules are reduced and decomposed into negative ions. The negative ions charge a protective film capacitance for another electrode down to the cathode-side potential. Such a charging current also flows into surrounding pixel capacitance so that the area charged to the cathode-side potential is expanded. In the charged area, negative ions increase. Accordingly, ion concentration becomes so high that the resistivity of the liquid crystal falls off. Thus, the retention rate of a voltage applied to the liquid crystal falls off. As a result, in the same manner as in the case of the anode-side electrode, pixels around the protective film defect become darker than the further surrounding pixels so as to be observed as black spot-like luminance unevenness.

Here, XY in FIG. 72 designates a liquid crystal molecule, and X and Y− designate decomposed states thereof. In addition, α+ and β− designate the states where impurity ions or dopants are dissociated in the liquid crystal, and Z+ designates an ion from a foreign substance or an electrode dissolved and ionized.

A cyano liquid crystal having cyano groups is so low in resistivity that it cannot be used in a TFT-LCD of a Twisted Nematic system. However, particularly in a system (IPS system or FFS system) in which an electric field (including a fringe electric field) substantially parallel to a substrate surface is applied, it is advantageous that the cyano liquid crystal is used because it has high-speed response and it can be driven with a low voltage. FIG. 73 shows an example of a molecular structure of such a cyano liquid crystal. Incidentally, FIG. 73 shows only a part of the molecular structure.

For example, such a liquid crystal molecule makes a reduction reaction in a cathode as shown in FIG. 74, so as to be decomposed into a neutral parent body portion and a cyano ion. Thus, in the conventional pixel, a black spot-like stain (small dark or white spot) is produced if there is only one protective film defect. Such a small dark or white spot cannot be distinguished in an early stage in which there occurs no reaction. However, if current conduction is kept on, a reaction advances so that the small dark or white spot reaches a distinguishable level so as to cause a failure in display.

According to the present invention, therefore, an electrode or an electric conductor given a potential on purpose is mounted on the protective film. In other words, an electrode or an electric conductor given a potential is formed on a protective film or under an alignment film. As a result, the protective film capacitance is charged beforehand, so that it becomes difficult for a charging current to flow even if there arises a protective film defect and an electrode is therefore exposed.

Thus, an electrode reaction (electrochemical reaction) in the cathode or the anode is suppressed so that dissolution of metal ions and reduction of liquid crystal molecules are suppressed. In other words, an electrode reaction is a phenomenon which occurs only after a current flows. There occurs no electrode reaction if no current flows. Thus, small dark or white spots are restrained from being produced. As a result, the retention rate of a voltage applied to the liquid crystal molecules is prevented from lowering, so that small dark or white spots are reduced. FIG. 75 shows a case where the ST electrode ST is installed on the anode side, while FIG. 76 shows a case where the ST electrode ST is installed on the cathode side.

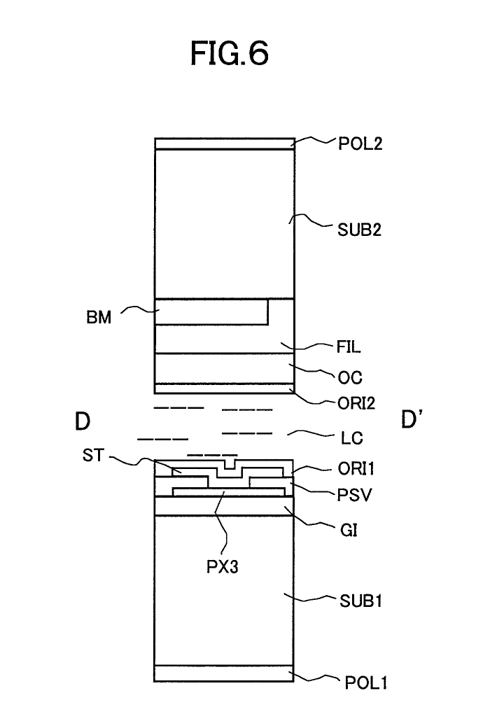

In this embodiment, the ST electrode ST is formed of a metal film (a layer containing metal atoms) il, and connected to a pixel electrode part PX3 through a through hole TH. Further, it is always necessary to supply the ST electrode ST with a potential from the outside. Since there is no effect if the ST electrode ST is a floating electrode, the through hole TH is made in the protective film PSV as shown in FIGS. 1 and 6, so as to connect the ST electrode ST to another electrode. In this embodiment, the ST electrode ST is connected to the pixel electrode part PX3 formed integrally with the pixel electrode PX.

In addition, a seat larger than the pixel electrode PX as shown in FIG. 1 is provided integrally with the pixel electrode PX in a portion corresponding to the through hole TH at a pixel electrode end. Thus, the pixel electrode part PX3 can always come in contact with the ST electrode even if the through hole or the ST electrode ST has a finishing variation in manufacturing.

In such a manner, in this embodiment, the ST electrode ST electrically connected to the pixel electrode is formed on the protective film PSV. As a result, any electrode is charged stationarily by the ST electrode ST up to a capacitance (protective film capacitance) consequently formed between the liquid crystal and each of the pixel electrode PX and the opposed electrodes CT and CT2 by use of the protective film PSV or the protective film PSV and the insulating film GI as dielectric. Thus, such an electrode is substantially equal in potential to the ST electrode ST with respect to DC (equal potential with respect to a DC component in the case of AC). Even if the electrode is exposed to the liquid crystal layer due to a foreign substance or the like, there is no fear that a charging current flows. Accordingly, there occurs no electro chemical reaction (electrode reaction) in the vicinity of the exposed electrode. That is, by forming the ST electrode ST on the protective film PSV, it is possible to prevent a charging current from flowing into the protective film capacitance for another electrode because of a protective film defect on the electrode. Thus, nuclear stains can be restrained from being produced.

Particularly in the present invention, the gate electrode GT or the scanning signal line GL is defined as a cathode-side electrode or wire. Further, an electrode or wire with a potential higher than that of the gate electrode GT or the scanning signal line GL is defined as an anode-side electrode or wire. Such anode-side electrodes or wires include the source electrode SD1, the drain electrode SD2, the video signal line DL, the pixel electrode PX, the opposed electrodes CT and CT2, and the opposed voltage signal line CL. As described above, in this embodiment, the ST electrode ST is electrically connected to the pixel electrode PX by way of example as the anode-side electrode or wire. However, the ST electrode ST may be connected to an electrode or wire constituted by one or both of a cathode and an anode. Combinations of these members and effects peculiar thereto will be described later as other embodiments.

In addition, although a metal film (a layer containing metal atoms) is used for the ST electrode ST in this embodiment, ITO or IZO may be used. Alternatively, metal for forming an auto-oxidizable film, such as aluminum, an aluminum alloy, or the like, may be used. This is because auto-oxidizable metal such as ITO, IZO, aluminum, an aluminum alloy, or the like, is an oxide, which is more difficult to produce an oxidation reaction after formation of the ST electrode ST, compared with any other metal film. Particularly, since the ST electrode ST is provided on the protective film PSV, if there occurs an oxidation reaction, there is a fear that electrons or positive holes flow out so that metal ions are dissolved into a liquid crystal material. It is therefore preferable to use such an oxide film. Note that a metal material which is not an oxide may be used if there is not such a fear.

Incidentally, it will go well if at least one ST electrode ST is present in a plurality of pixels on the basis of the above-mentioned detailed mechanism. Alternatively, a plurality of ST electrodes ST may be formed in one pixel as shown in Embodiments 7 and 8 which will be described later. Further, not to say, one ST electrode ST may be provided in one pixel as shown in this embodiment.

Although the ST electrode ST has an electrode shape, it may be shaped, for example, into a wire (occasionally referred to as “first wire” in this specification).

<<Sectional Configuration of Matrix Portion (Pixel Portion)>>

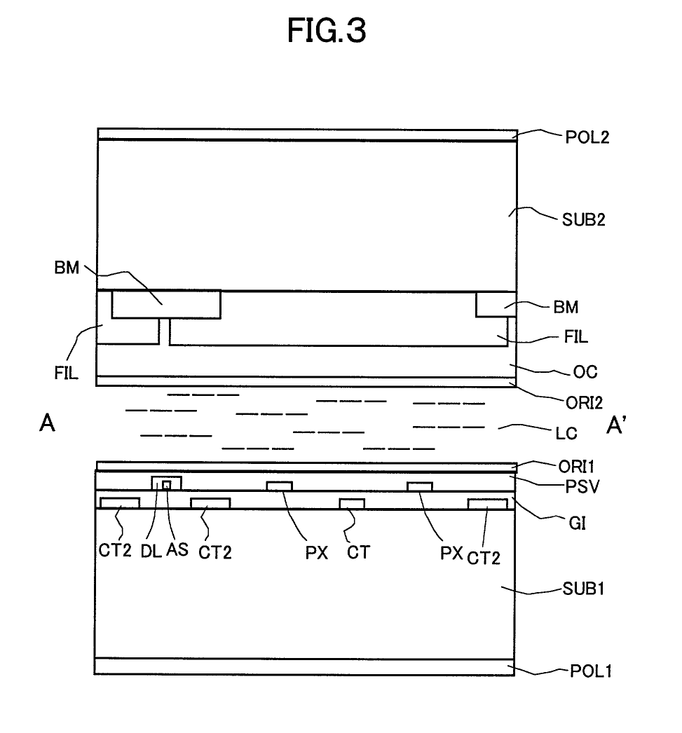

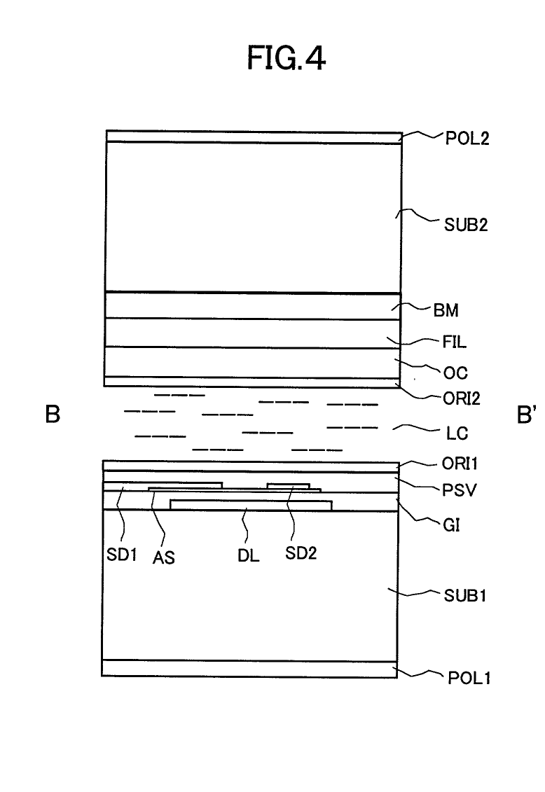

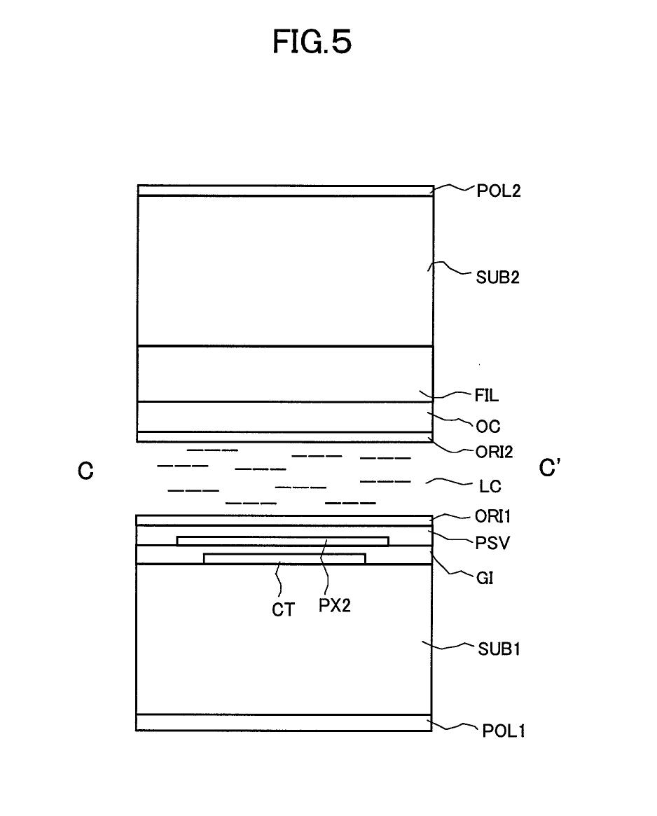

FIG. 3 is a view showing a sectional view taken on line A-A′ in FIG. 1. FIG. 4 a sectional view of a thin film transistor TFT, taken on line B-B′ in FIG. 1. FIG. 5 is a view showing a section of a storage capacitance Cstg, taken on line C-C′ in FIG. 1. As shown in FIGS. 3 to 5, with respect to a liquid crystal layer LC, the thin film transistor TFT, the storage capacitance Cstg and a group of electrodes are formed on the side of a lower transparent glass substrate SUB1, while a color filter FIL and a light shielding black matrix pattern BM are formed on the side of an upper transparent glass substrate SUB 2.

In addition, alignment films ORIl and ORI2 for controlling the initial alignment of the liquid crystal are provided on the inner (liquid crystal LC side) surfaces of the transparent glass substrates SUB1 and SUB2 respectively. Polarizing plates (disposed in crossed Nicol) with polarizing axes crossed at right angles are provided on the outer surfaces of the transparent glass substrates SUB1 and SUB2 respectively.

In addition, FIG. 6 shows a sectional view taken on line D-D′ in FIG. 1. The ST electrode ST must be formed on the protective film PSV. In other words, the ST electrode ST is formed under the alignment film ORI1. Further in other words, a conductive film is formed on the protective film PSV or under the alignment film ORI1. It will go well if this conductive film has a volume resistivity of not larger than 1,011 Ω·cm. It is more preferable that the volume resistivity is not larger than 104 Ω·cm. In this embodiment, a transparent conductive film il (Indium-Tin-Oxide ITO: NESA film) is used as the conductive film material of the ST electrode ST. Although metal may be used as the material of the ST electrode ST, as the material provided on the protective film PSV, ITO which is stable as material is preferred in consideration of contamination of the liquid crystal material. IZO (Indium-Zn-Oxide) is likewise preferable. When metal is used, a material such as Al (including an Al alloy) difficult to cause an electrochemical reaction (electrode reaction) is preferred to a material such as Cr or the like having a low standard potential to cause an electrode reaction easily.

Further, the ST electrode ST has to be supplied with a potential from the outside. There is no effect if the ST electrode is a floating electrode. Therefore, as shown in FIGS. 1 and 6, the ST electrode ST is connected to another electrode through the through hole TH made in the protective film PSV. In this embodiment, the ST electrode ST is connected to the pixel electrode part PX3 formed integrally with the pixel electrode PX.

<<TFT Substrate>>

The structure of the lower transparent glass substrate SUB1 side (TFT substrate) will be described below in more detail.

<<Thin Film Transistor TFT>>

The thin film transistor TFT operates so that the source-drain channel resistance decreases if positive bias is applied to the gate electrode GT which is a part of the scanning signal line GL. On the other hand, if the bias is made zero, the thin film transistor TFT operates so that the channel resistance increases.

The this film transistor TFT has the gate electrode GT, an insulating film GI, an i-type semiconductor layer AS made of i-type (intrinsic, that is, doped with no conductivity type deciding impurity) amorphous silicon (Si), and a pair of a source electrode SD1 and a drain electrode SD2. Note that the source and the drain are essentially determined by the bias polarity applied therebetween, and the bias polarity is reversed in operation in the circuit of this liquid crystal display unit. It should be therefore understood that the source and the drain replace each other in operation. However, in the following description, representation is made in such a manner that one is fixed to the source while the other is fixed to the drain, for the sake of convenience.

<<Gate Electrode GT>>

The gate electrode GT is formed continuously to the scanning signal line GL so that a partial area of the scanning signal line GL is formed as the gate electrode GT. The gate electrode GT is a portion which is out of the active area of the thin film transistor TFT. In this embodiment, the gate electrode GT is formed of a single-layer conductive film g3. As the conductive film g3, for example, a chromium-molybdenum alloy (Cr—Mo) film formed by sputtering may be used, but the conductive film g3 is not limited thereto. For example, Cr, Mo, W, Ti, Ta, Al, Cu, or an alloy mainly made one or more of them, may be used. To obtain a low resistance, it is preferable that Al, Cu, or an alloy mainly made of one or more of them is used. In addition, the gate electrode GT may be formed of a laminate film having a laminate structure of two or more layers. Such a laminate structure may be useful for working such as tapering a section. That is, when a laminate structure of layers different in corrosion potential is used, a thin upper layer of the layers is formed into a vertical shape or an inverted tapered shape, while a lower layer thicker than the upper layer is formed into a normal tapered shape. Thus, the wire as a whole has a substantially normal tapered shape so that the coverage of an insulating film or the like covering the wire is compensated.

Incidentally, Cr—Mo, Cr—W, Cr—Ti, Cr—Ta, or the like, is used as the thin upper layer, and Cr is used as the thick lower layer. Consequently, the etching speed becomes the highest in the interface between the upper and lower layers by the influence of a cell reaction. As a result, the side end surface of the lower layer as a whole is worked into a normal tapered shape while the side end surface of the upper layer is worked into a shape perpendicular to the substrate surface or in to a slightly inverted tapered shape.

Incidentally, when Al is used, it is effective to alloy Al with Nd in order to suppress a hillock generated from Al. Alternatively, it is effective to anodize Al to form an anodic oxide film on the surface, by which a short-circuit failure with another electrode can be reduced.

<<Scanning Signal Line GL>>

The scanning signal line GL is formed of a conductive film g3. The conductive film g3 of the scanning signal line GL is formed in the same manufacturing step as the conductive film g3 of the gate electrode GT, so as to be integrated therewith. Through the scanning signal line GL, a gate voltage Vg is supplied from an external circuit to the gate electrode GT. Further, the portion where the scanning signal line GL crosses the video signal line DL is made thin enough to reduce the probability that the scanning signal line GL is short-circuited with the video signal line DL. Alternatively, the portion where the scanning signal line GL crosses the video signal line DL may be bifurcated so that the portion can be separated by laser trimming even if the scanning signal line GL is short-circuited with the video signal line DL.

<<Insulating Film GI>>

In the thin film transistor TFT, the insulating film GI is used as a gate insulating film for giving an electric field to the semiconductor layer AS in cooperation with the gate electrode GT. The insulating film GI is formed on the gate electrode GT and the scanning signal line GL. As the insulating film GI, for example, a silicon nitride film formed by plasma CVD is selected, and formed to be 2,000 to 5,000 Å thick (about 3,500 Å in this embodiment). In addition, the insulating film GI serves as an interlayer insulating film between the scanning signal line GL and the video signal line DL and between the opposed voltage signal line CL and the video signal line DL, so as to contribute to electric insulation among those signal lines. The gate insulating film may be formed of a silicon oxide film.

If the thickness of the insulating film GI increases, the capacitance among wires and electrodes can be reduced so that the power consumption can be reduced and good picture quality without signal waveform distortion can be obtained. However, the increase of the film thickness causes the increase of a threshold voltage of the thin film transistor TFT or the lowering of mutual conductance gm. It is therefore preferable that the film thickness is in the above-mentioned range.

Further, although the insulating film GI is constituted by a single layer of silicon nitride in this embodiment, the insulating film GI may be formed as a laminate film of two or more layers of silicon nitride and an inorganic material such as silicon oxide or the like, two or more layers of organic materials, or two or more layers of an inorganic material and an organic material. Such a laminate film is effective in prevention of short-circuit among electrodes.

<<i-type Semiconductor Layer AS>>

The i-type semiconductor layer AS is formed of amorphous silicon so as to be 100 to 3,000 Å thick (about 1,200 Å thick in this embodiment). A layer d0 is an n(+)-type amorphous silicon semiconductor layer doped with phosphor (P) for ohmic contact. The layer d0 is left only in the portion where the i-type semiconductor layer AS is formed on its lower surface and the conductive layer d3 is formed on its upper surface.

The i-type semiconductor layer AS and the layer d0 are provided also in the two intersection portions (crossover portions) between the scanning signal line GL and the video signal line DL and between the opposed voltage signal line CL and the video signal line DL so as to be disposed between the signal lines GL and DL and between the signal lines CL and DL.

The i-type semiconductor layer AS in the crossover portions reduces the short-circuit between the scanning signal line GL and the video signal line DL and the short-circuit between the opposed voltage signal line CL and the video signal line DL in the crossover portions.

The i-type semiconductor layer AS is not limited to amorphous silicon, but it may be made of polysilicon or monocrystal silicon. When amorphous silicon is used, it is preferable that the i-type semiconductor layer AS is made as thin as possible in order to reduce a voltage retention failure caused by photoconduction.

<<Source Electrode SD1 and Drain Electrode SD2>>

Each of the source electrode SD1 and the drain electrode SD2 is formed of a conductive film d3 in contact with the n (+)-type semiconductor layer d0.

A chromium-molybdenum alloy (Cr—Mo) film formed by sputtering is used to form the conductive film d3 to be 500 to 3,000 Å thick (about 2,000 Å thick in this embodiment). Since the Cr—Mo film has a low stress, the conductive film d3 can be formed to be thick comparatively, so as to contribute to reduction in resistance of the wire. In addition, the Cr—Mo film is also superior in adhesiveness to the n(+)-type semiconductor layer d0. A high-melting-point metal (Cr, Mo, Ti, Ta, or W) film or a high-melting-point metal siliside (MoSi₂, TiSi₂, TaSi₂, or WSi₂) film other than the Cr—Mo film may be used as the conductive film d3. Alternatively, the conductive film d3 is formed to have a laminate structure of the above film and a film of Al, Cu, an alloy mainly made one or more of them, or the like.

After the conductive film d3 is patterned with a mask pattern, the n(+)-type semiconductor layer d0 is removed using the conductive film d3 as a mask. That is, the n(+)-type semiconductor layer d0 left on the i-type semiconductor layer AS, except the portion corresponding to the conductive film d3, is removed by self-alignment. At this time, the n(+)-type semiconductor layer d0 is etched so that all the thickness thereof is removed. Therefore, the surface portion of the i-type semiconductor layer AS is also etched slightly. However, it will go well if the degree of etching is controlled by etching time.

Incidentally, although channel formation is performed in this embodiment by use of a back channel etching (BCE) system as described above, a channel protection (CHP) system may be used. In the CHP system, an insulating film of silicon nitride or the like is used also on the i-type semiconductor layer AS so as to protect channels.

<<Video Signal Line DL>>

The video signal line DL is formed of the conductive film d3 which is the same layer as the source electrode SD1 and the drain electrode SD2. In addition, the video signal line DL is formed integrally with the drain electrode SD2. The other points are similar to those in the source electrode SD1 and the drain electrode SD2. To reduce the resistance, it is preferable that the video signal line DL is made to have a laminate structure of the conductive film d3 and a film of Al, Cu, an alloy mainly made of one or more of them, or the like.

<<Pixel Electrode PX>>

The pixel electrode PX is formed of the conductive layer d3 integrally with the source electrode SD2 and the pixel electrode parts PX2 and PX3. The actions of the liquid crystal molecules are controlled to obtain a display by a voltage applied between the pixel electrode and opposed electrodes which will be described later.

<<Opposed Electrodes CT and CT2>>

The opposed electrodes CT and CT2 are formed of the conductive layer g3 integrally with the opposed voltage signal line CL. The actions of the liquid crystal molecules are controlled to obtain a display by a voltage applied between the opposed electrodes and the above-mentioned pixel electrode.

The opposed electrode CT is designed to be applied with an opposed voltage Vcom. In this embodiment,the opposed voltage Vcom is set to be lower than an intermediate DC potential between a minimum-level driving voltage Vdmin and a maximum-level driving voltage Vdmax applied to the video signal line DL, by a feed through voltage ΔVs generated when the thin film transistor TFT is turned OFF. However, an AC voltage may be applied if the power supply voltage of an integrated circuit used in a video signal drive circuit is desired to reduce by approximately half.

<<Opposed Voltage Signal Line CL>>

The opposed voltage signal line CL is formed of a conductive film g3. The conductive film g3 of the opposed voltage signal line CL is formed in the same manufacturing step as the conductive film g3 of the gate electrode GT, the scanning signal line GL and the opposed electrode CT, and designed to be able to be electrically connected to the opposed electrode CT. Through the opposed voltage signal line CL, the opposed voltage Vcom is supplied from an external circuit to the opposed electrode CT. Further, the portion where the opposed voltage signal line CL crosses the video signal line DL is made thin to reduce the probability that the opposed voltage signal line CL is short-circuited with the video signal line DL. Alternatively, the portion where the opposed voltage signal line CL crosses the video signal line DL may be bifurcated so that the portion can be separated by laser trimming even if the opposed voltage signal line CL is short-circuited with the video signal line DL.

<<Storage Capacitance Cstg>>

The conductive film d3 is formed to overlap the opposed voltage signal line CL in the source electrode SD2 portion of the thin film transistor TFT. As is apparent from FIG. 5, this overlay forms a storage capacitor (electrostatic capacitance device) Cstg using the part PX3 (d3) of the pixel electrode PX as one electrode and the opposed voltage signal line CL as the other electrode. A dielectric film of the storage capacitance Cstg is formed of the insulating film GI used as the gate insulating film of the thin film transistor TFT.

As shown in FIG. 1, in plan, the storage capacitance Cstg is formed in a part of the opposed voltage signal line CL.

<<Protective Film PSV>>

The protective film PSV is provided on the thin film transistor TFT. The protective film PSV is formed chiefly to protect the thin film transistor TFT from moisture or the like. As the protective film PSV, a material high in transparency and superior in moisture resistance is used. For example, the protective film PSV is formed of a silicon oxide film or a silicon nitride film formed by a plasma CVD apparatus, or acrylic resin, epoxy, polyimide, or the like, so as to have a thickness in a range of from about 0.1 μm to about 3 μm.

It is preferable that the film thickness increases. By increasing the film thickness, an after image which is generated because DC voltage is retained in the liquid crystal material, the alignment film and the protective film can be reduced. However, if the film thickness is made too large, it becomes difficult to form the contact hole (through hole) TH. It is therefore preferable that the film thickness is in the above-mentioned range.

Although the protective film PSV is constituted by a single layer in this embodiment, the protective film PSV may be formed to have a laminate structure of two or more layers of inorganic materials, two or more layers of organic materials, or two or more layers of an inorganic material and an organic material, in order to increase the film thickness or to keep a more excellent protection effect.

As for the formation pattern of the protective film PSV, the protective film PSV is formed so that external connection terminals DTM and GTM are exposed in a circumferential portion of a display area. Incidentally, in this embodiment, the protective film PSV is patterned with the same photo mask as the insulating film GI, and worked together therewith. As a result, the number of steps is reduced so that the throughput can be improved. In addition, in a pixel portion, the through hole TH is provided for electric connection between the pixel electrode part PX3 and the ST electrode ST. In this embodiment, the through hole TH is blocked by the conductive film d3. Thus, the hole is formed to have a bottom at a level equal to the conductive film d3.

<<Color Filter Substrate>>

Next, returning to FIGS. 1 and 2, the configuration of the upper transparent glass substrate SUB2 side (color filter substrate) will be described in detail.

<<Light Shielding Film BM>>

A light shielding film BM (a so-called black matrix) is formed on the upper transparent glass substrate SUB2. Thus, transmitted light from unnecessary gap portions (gaps other than the gap between the pixel electrode PX and the opposed electrodes CT and CT2) is prevented from emitting from the display surface so that the contrast ratio can be prevented from being lowered. The light shielding film BM also plays a role to prevent external light or backlight from entering the i-type semiconductor layer AS. That is, the i-type semiconductor layer AS of the thin film transistor TFT is sandwiched between the light shielding film BM and the largish gate electrode GT which are disposed above and below the i-type semiconductor layer AS respectively. Thus, the i-type semiconductor layer AS is kept out of external natural light or backlight.

A line BMb shown in FIG. 1 shows the line for defining the boundary of an aperture portion of the light shielding film BM. The light shielding film BM is designed to extend like a matrix above the thin film transistor TFT and in the upper/lower and left/right directions thereof. This pattern is merely an example. The shape or the like of the aperture portion can be set desirably within a range not to make a sacrifice of the contrast or any other optical property. In a portion where the electric field direction goes out of order, such as a comb-teeth-like electrode end portion or the like, the display in the portion has one to one correspondence to video information in each pixel. In addition, the display becomes black if the video information designates black, and white if the video information designates white. Thus, such a portion can be used as a part of display.

The light shielding film BM is formed of a film which has a light shielding property from light and which is high in insulation performance so as not to affect the electric field between the pixel electrode PX and the opposed electrodes CT. In this embodiment, the light shielding film BM is formed of a resist material mixed with a black pigment, so as to be about 1.2 μm thick.

The light shielding film BM is formed like a matrix for each pixel in each row in the upper/lower and left/right directions so that available display areas in respective rows and respective columns are defined by the lines of the light shielding film BM. Accordingly, the outlines of pixels in the respective rows and the respective columns are made clear by the light shielding film BM. That is, the light shielding film BM has two functions as a black matrix and as a light shield for the i-type semiconductor layer AS.

The light shielding film BM is also formed like a picture frame in the circumferential portion, and the frame-like pattern is formed continuously to the pattern of the matrix portion shown in FIG. 1. The light shielding film BM in the circumferential portion is extended to the outside of a seal portion SL. Thus, leakage light such as reflected light or the like caused by a mounting machine such as a personal computer or the like is prevented from entering the matrix portion. At the same time, light such as backlight or the like is also prevented from leaking to the outside of the display area. On the other hand, the light shielding film BM is formed to stay about 0.3 to 1.0 mm inside from the edge of the substrate SUB2 so as to avoid the cut-off area of the substrate SUB2.

Although the black matrix BM is formed on the color filter substrate (another substrate than the TFT substrate), it may be formed on the TFT substrate. In such a case, a margin is allowed in the step of performing panel alignment between the color filter substrate and the TFT substrate so that the productivity is improved. In addition, the width of the black matrix can be narrowed so that the aperture ratio is improved.

<<Color Filter FIL>>

A color filter FIL is formed like stripes to repeat red, green and blue in a position opposite to each pixel. The color filter FIL is formed to overlap the edge portion of the light shielding film BM.

The color filter FIL can be formed as follows. First, red, green and blue pigments of acrylic resin or the like are mixed onto the surface of the upper transparent glass substrate SUB2 so as to form a base material. The base material is patterned by a photolithographic technique so that filters of respective colors(red,green and blue)are formed sequentially. To enhance the color purity, pigments of other colors such as cyan or the like may be mixed.

The color filter may be formed on the TFT substrate in the same manner as the black matrix.

<<Overcoat Film OC>>

An overcoat film OC is provided to prevent the dyestuffs of the color filter FIL from leaking to the liquid crystal LC, and to flatten the steps formed between the color filter FIL and the light shielding film BM. For example, the overcoat film OC is formed of a transparent resin material such as acrylic resin, epoxy resin, or the like.

Incidentally, when the color filter and the black matrix are formed on the TFT substrate, the overcoat film is also formed on the TFT substrate.

<<Liquid Crystal Layer and Polarizing Plate>>

Next, description will be made about the liquid crystal layer, the alignment film, the polarizing plate, and so on.

<<Liquid Crystal Layer>>

As the liquid crystal material LC, a nematic liquid crystal having a positive permittivity anisotropy Δε of 13.2 and a refractive index anisotropy Δn of 0.075 (589 nm, 20° C.) is used. The thickness (gap) of the liquid crystal layer is set to be 3.9 μm, and the retardation Δn·d is set to be 0.285. By this value of the retardation Δn·d, a maximum transmissivity can be obtained when the liquid crystal molecules are turned for 45° toward the electric field from the rubbing direction in cooperation with the alignment film and the polarizing plate which will be described later. Thus, transmitted light having little wavelength dependency can be obtained within a range of visible light. Incidentally, the thickness (gap) of the liquid crystal layer is controlled by polymer beads. Further, the liquid crystal material LC is not limited especially, but the permittivity anisotropy Δε may be negative. In addition, if the value of the permittivity anisotropy Δε is increased, the driving voltage can be reduced. Incidentally,if the refractive index anisotropy Δn is reduced, the thickness (gap) of the liquid crystal layer can be increased. As a result, the injecting time of the liquid crystal can be shortened, and the gap scattering can be reduced. Particularly, to make a white display without coloring, it is preferable that the retardation is in a range of from 0.25 to 0.32.

<<Alignment Film>>

As the alignment film ORI, polyimide is used. Rubbing directions RDR against the upper and lower substrates are made parallel with each other, and set at an angle of 75° with an applied electric field direction EDR. The relationship is shown in FIG. 21.

Incidentally, the angle of the rubbing directions RDR with the applied electric field direction EDR has to be not smaller than 45° but smaller than 90° when the permittivity anisotropy Δε of the liquid crystal material is positive. On the other band, when the permittivity anisotropy Δε is negative, the angle has to be larger than 0° but not larger than 45°.

<<Polarizing Plate>>

As for polarizing plates POL, a polarizing transmission axis MAX1 of a lower polarizing plate POL1 is made to be identical with the rubbing directions RDR, while a polarizing transmission axis MAX2 of an upper polarizing plate POL2 is made perpendicular to the rubbing directions RDR. The relationship is shown in FIG. 21. Thus, it is possible to obtain a normal close property that the transmissivity increases with the increase of the voltage (the voltage between the pixel electrode PX and the opposed electrodes CT and CT2) applied to a pixel according to the present invention. In addition, when no voltage is applied, an excellent black display can be made.

<<Configuration on the Periphery of Matrix>>

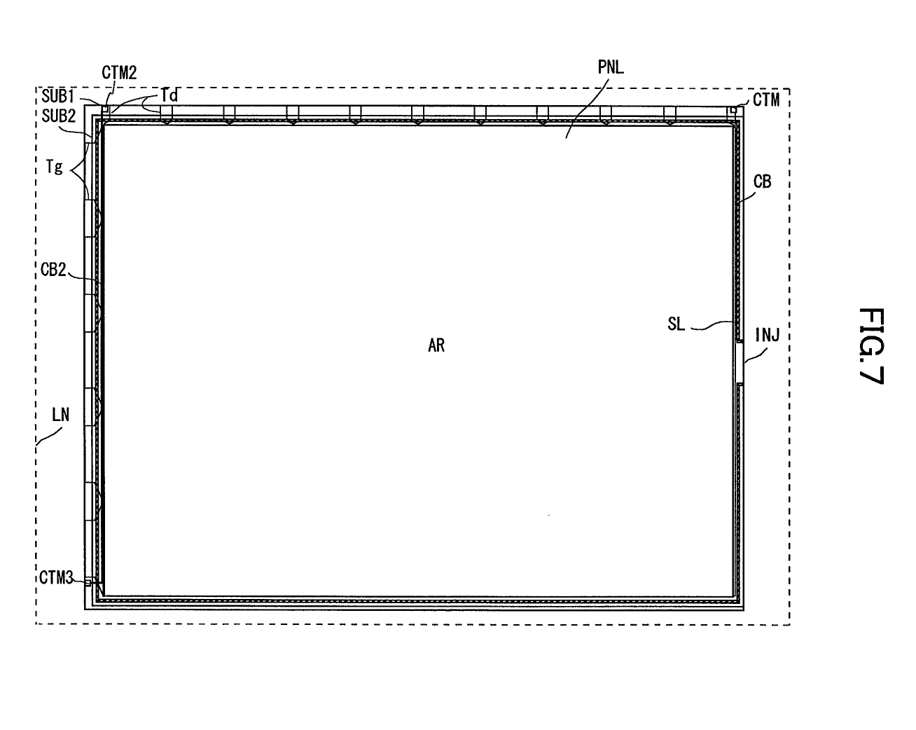

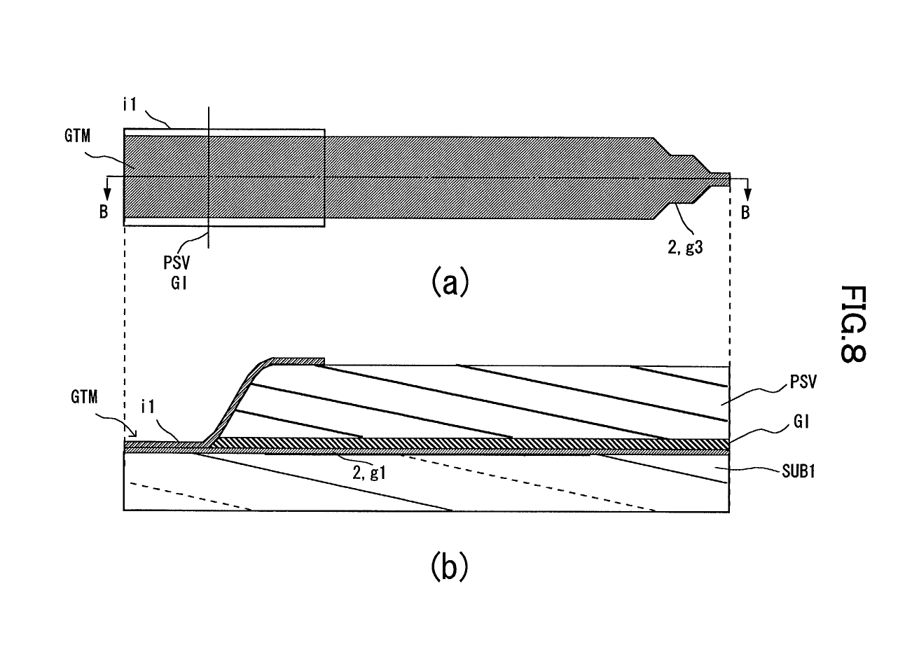

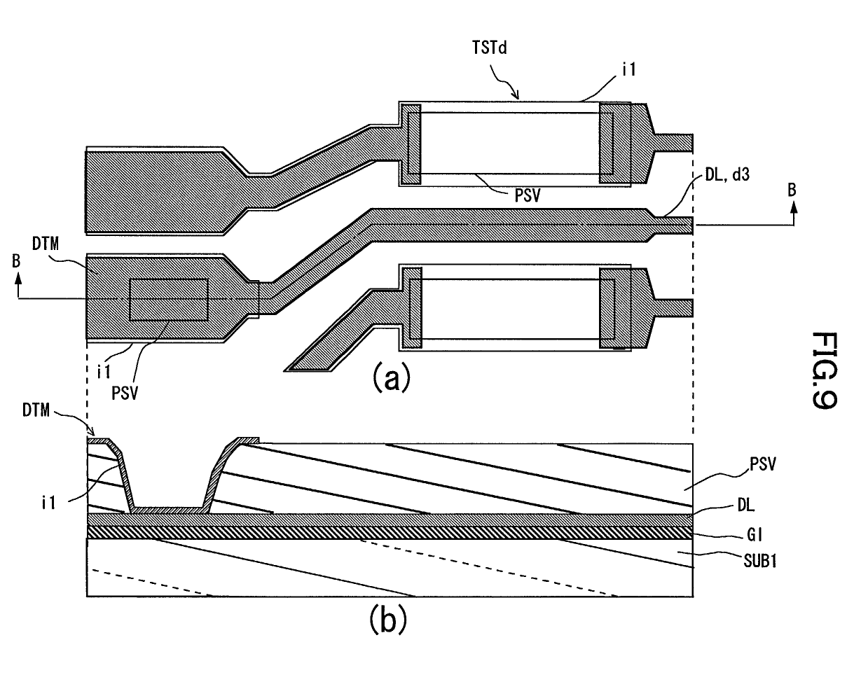

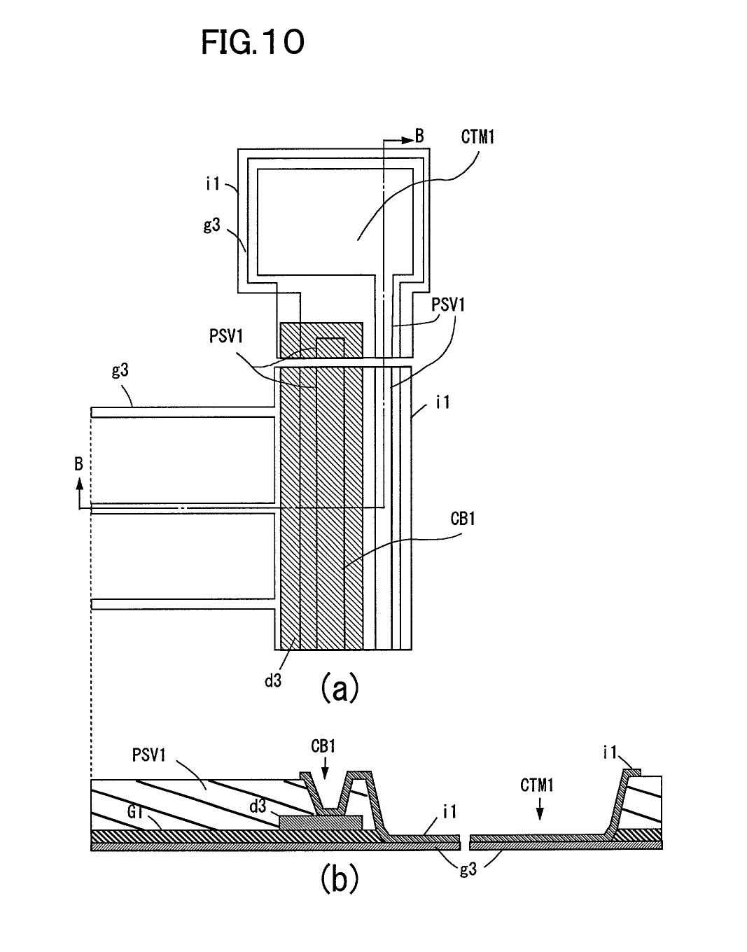

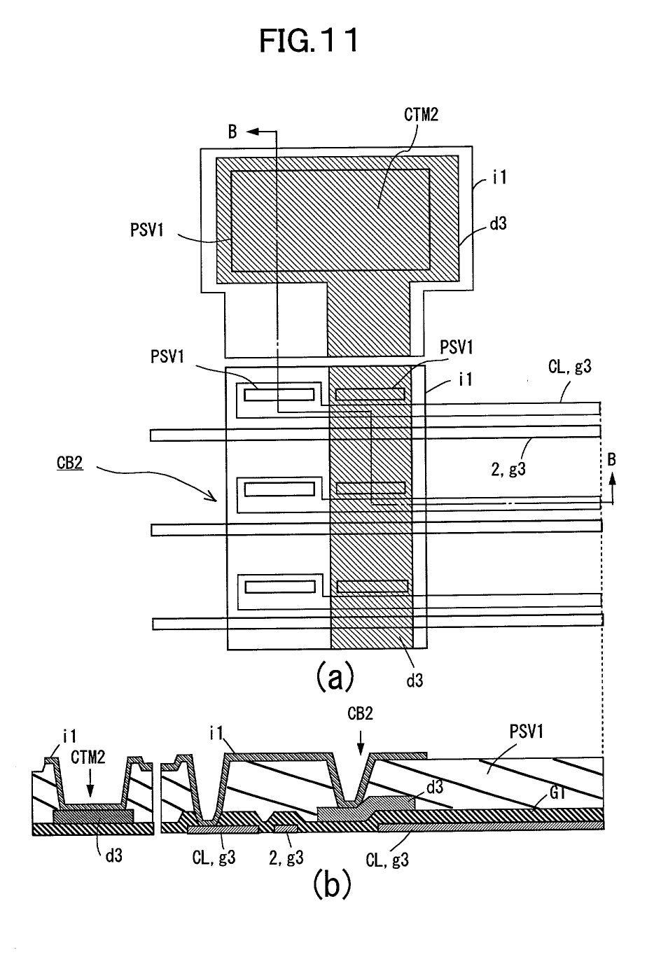

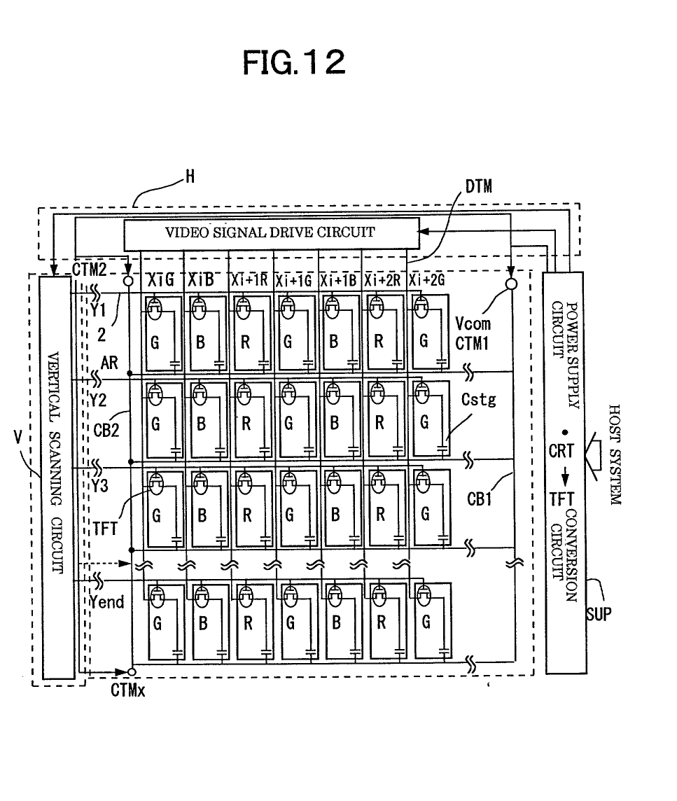

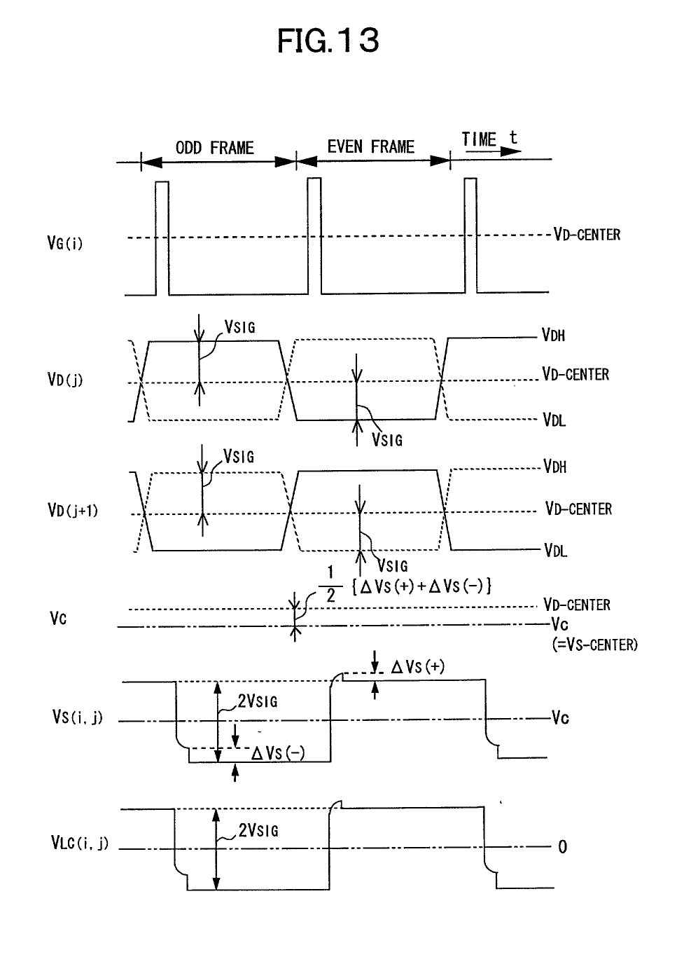

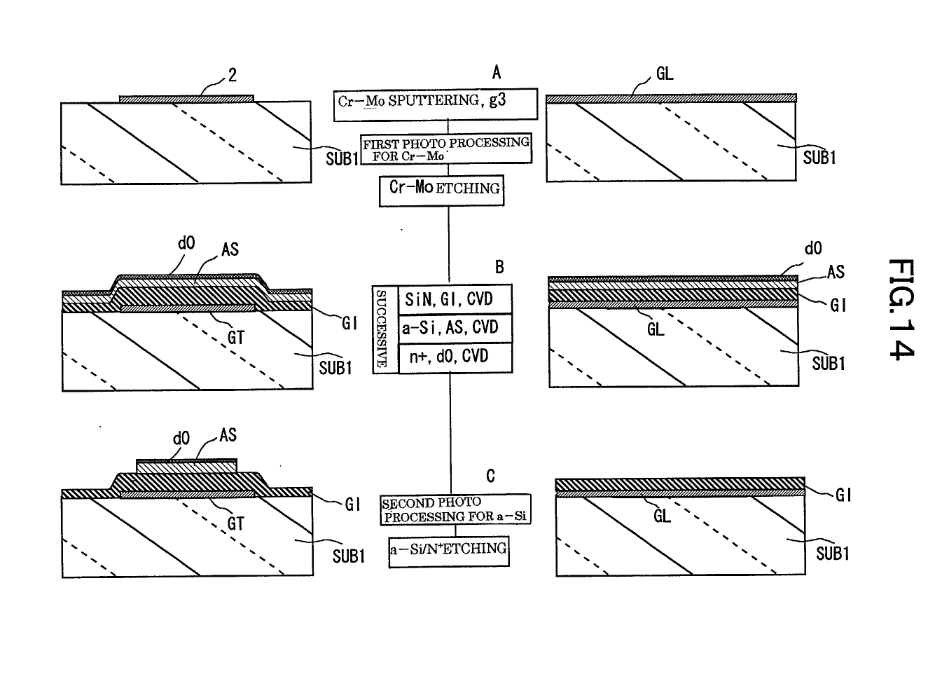

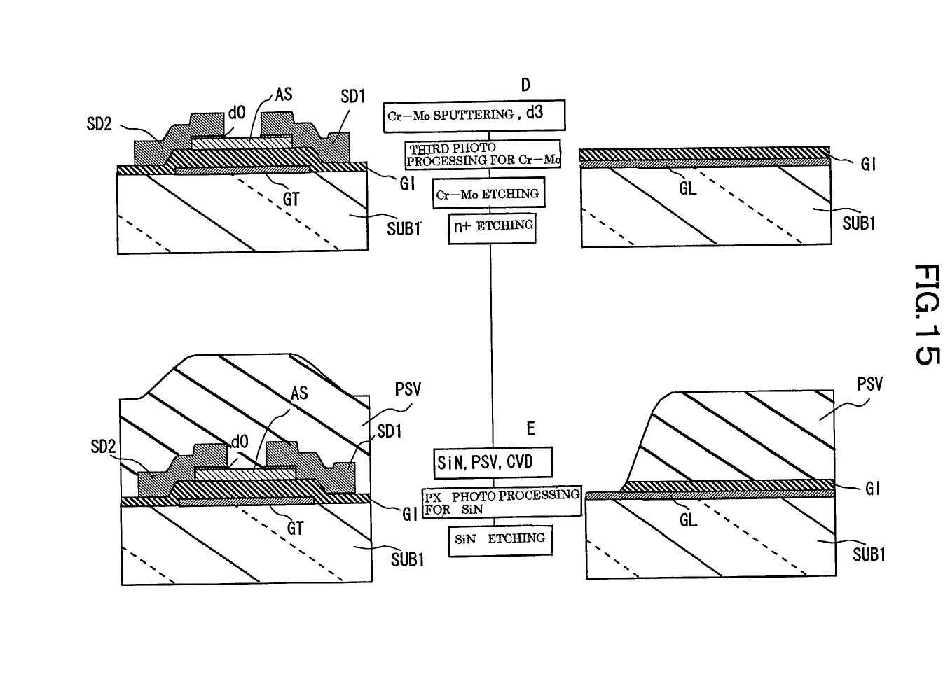

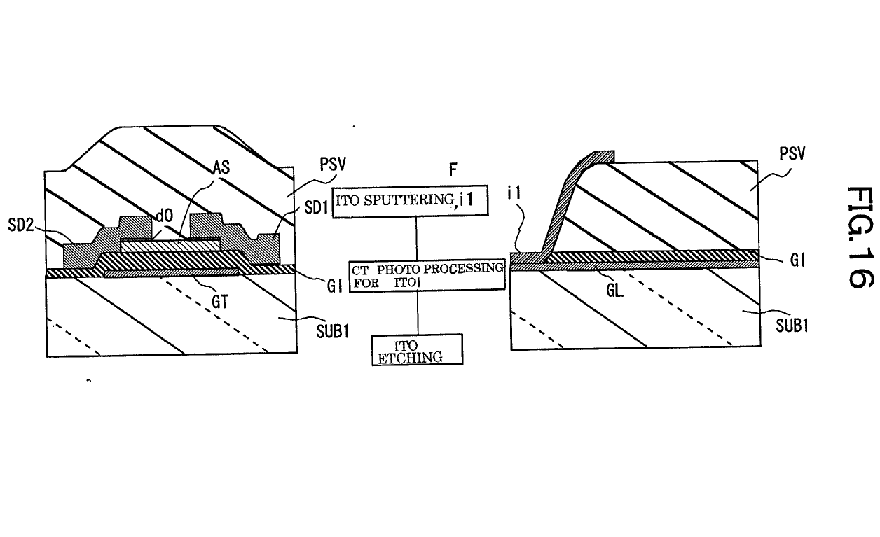

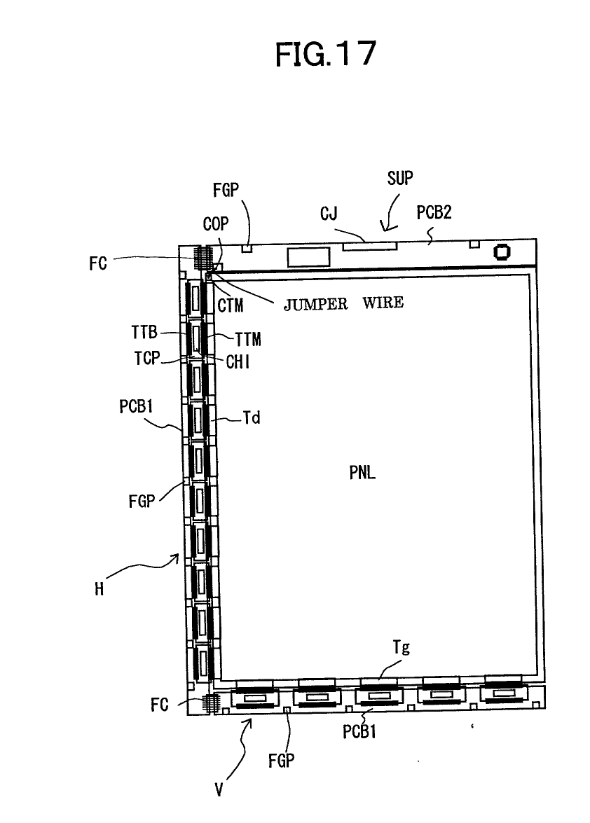

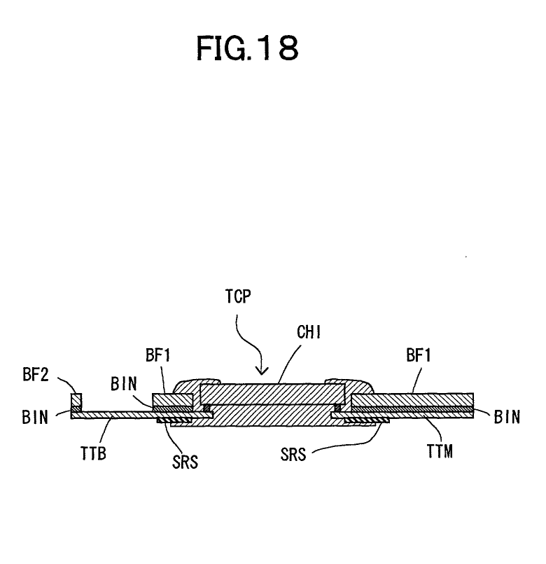

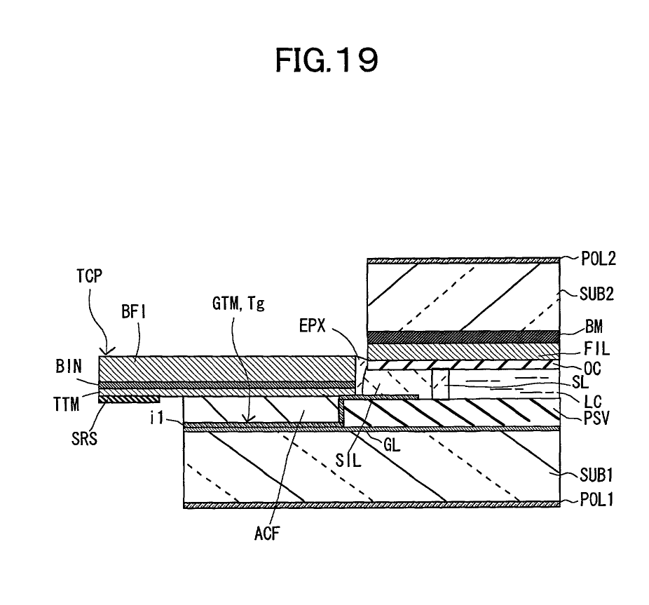

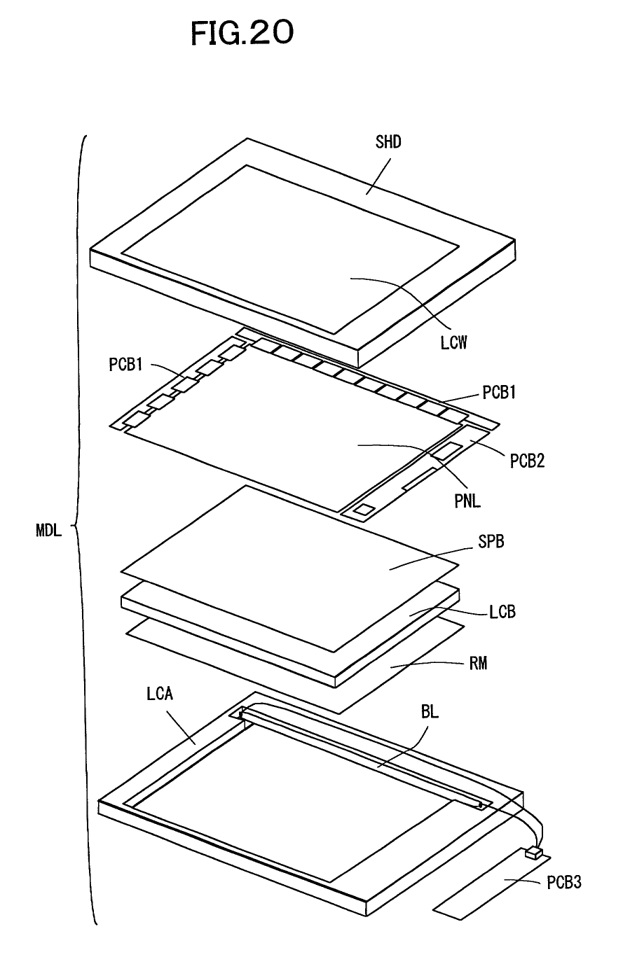

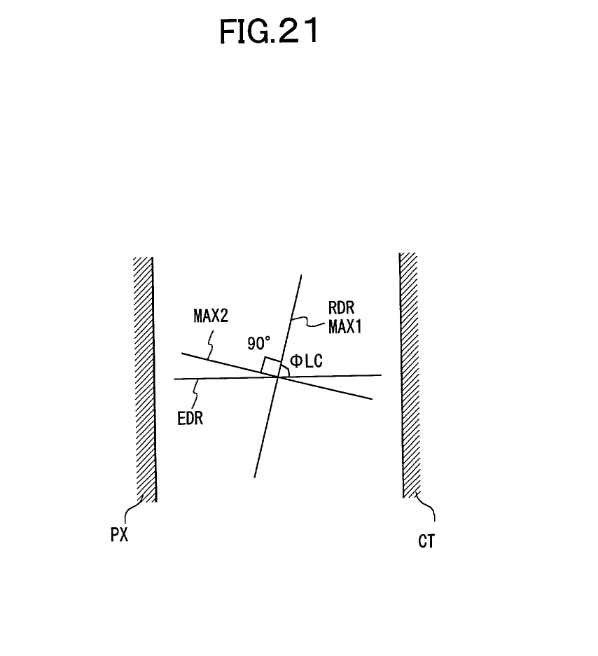

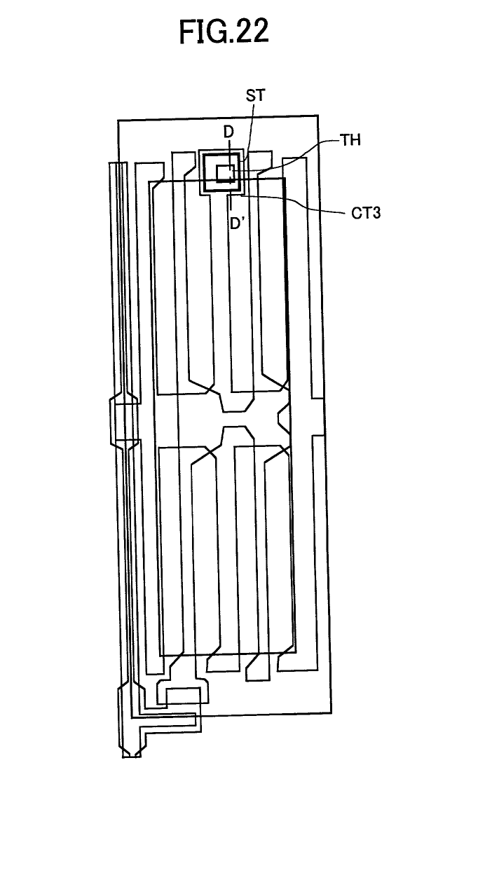

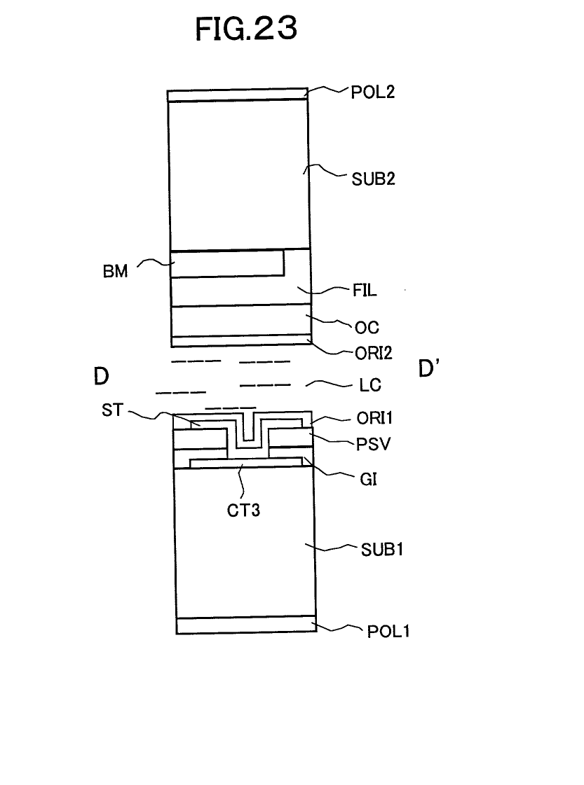

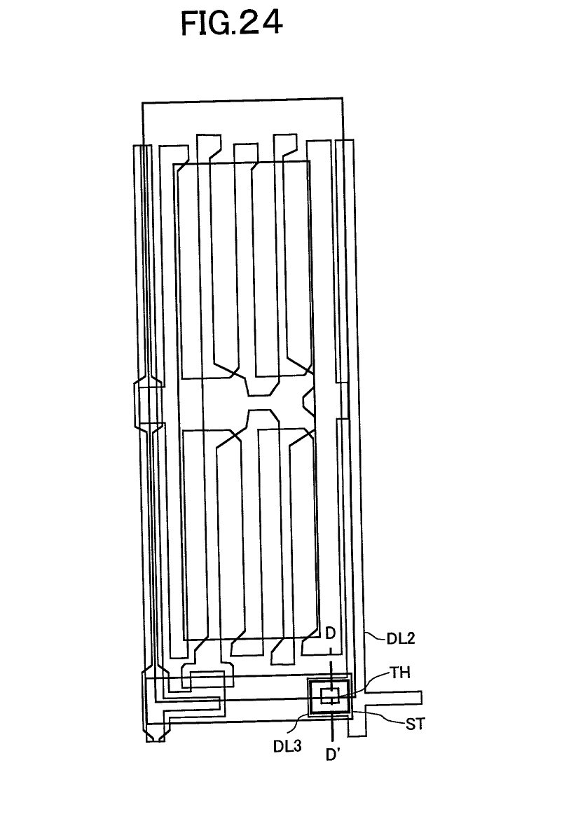

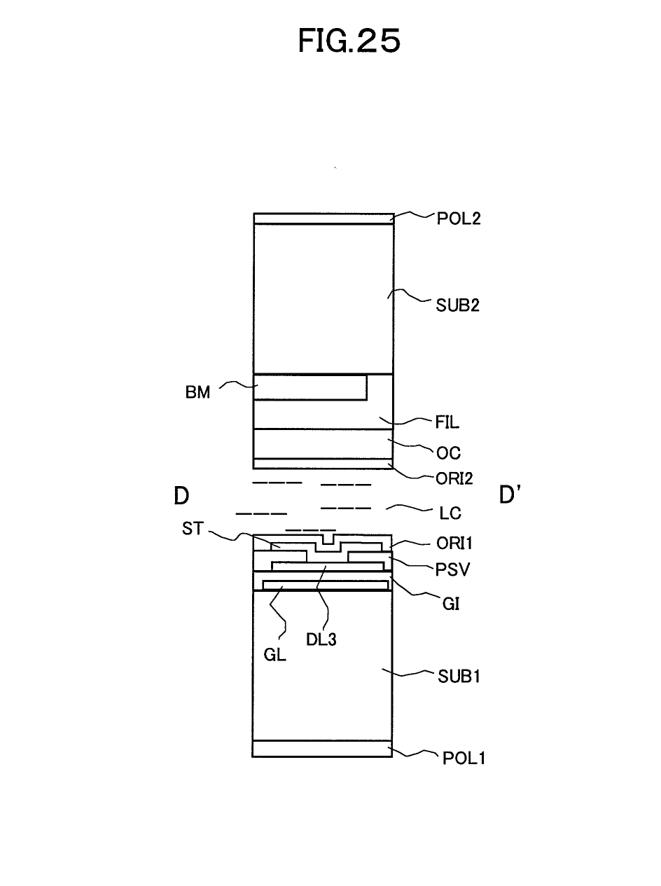

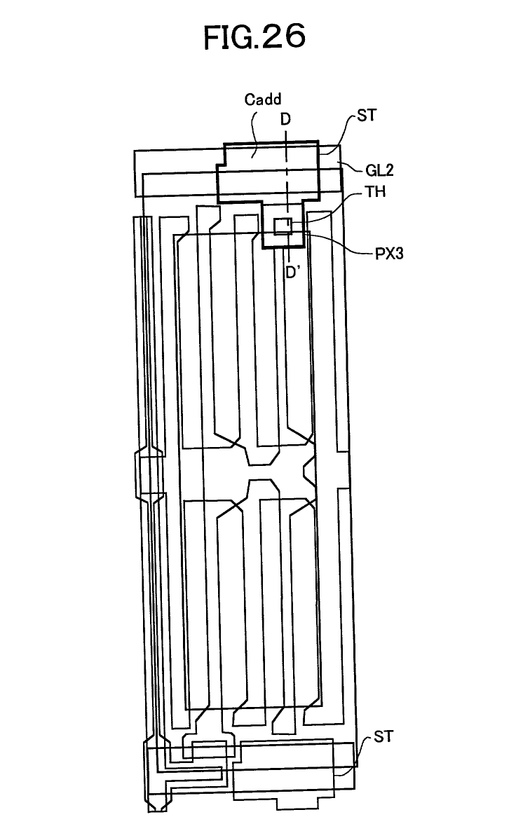

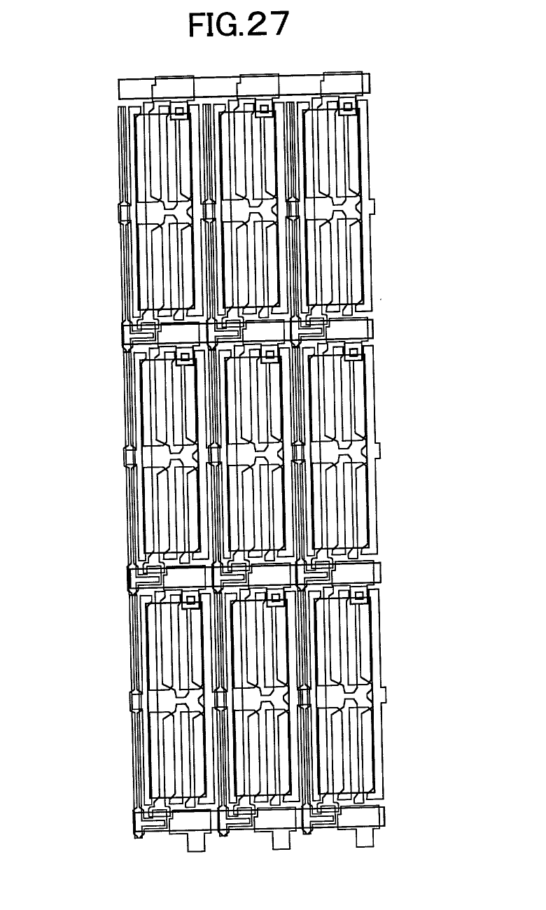

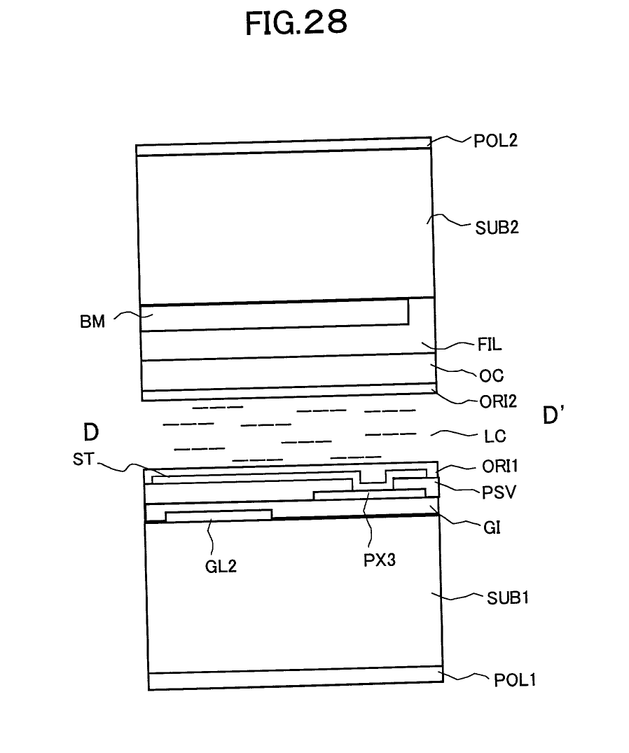

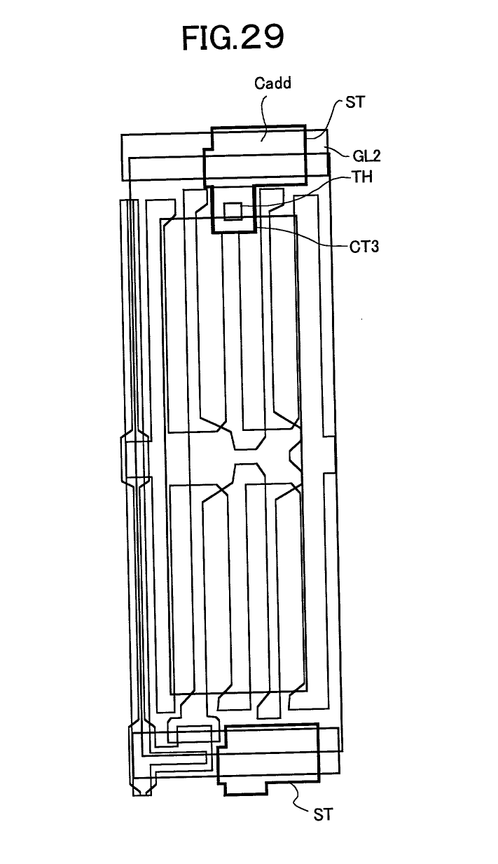

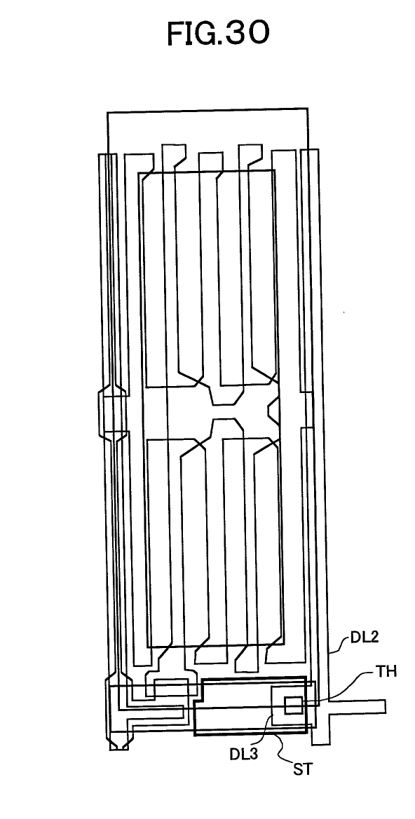

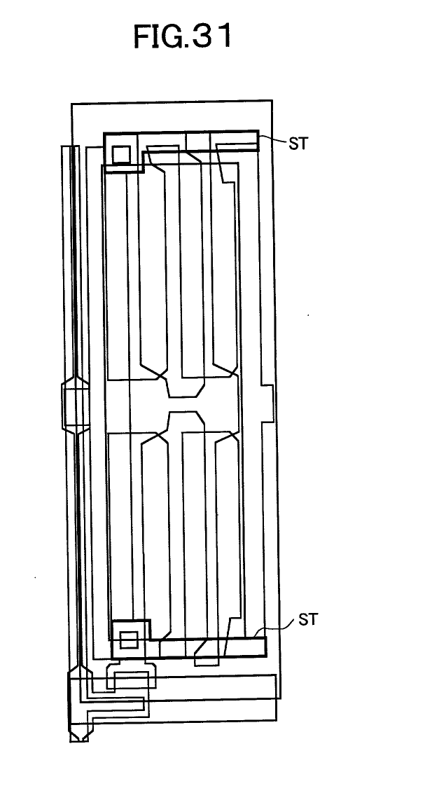

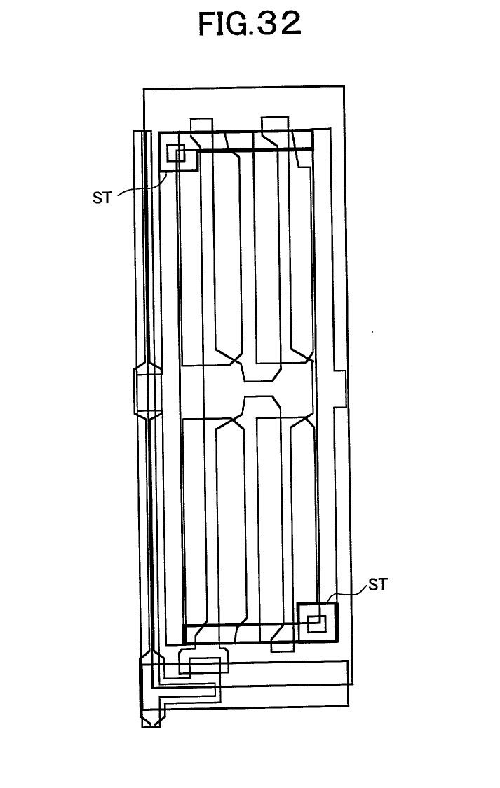

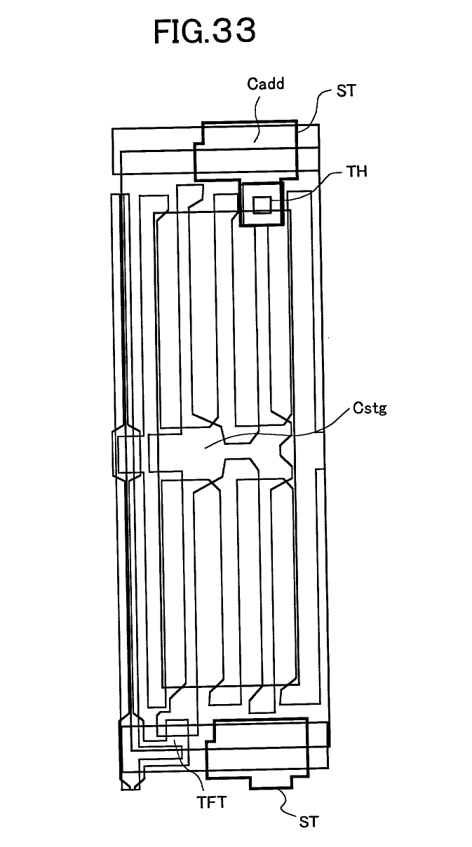

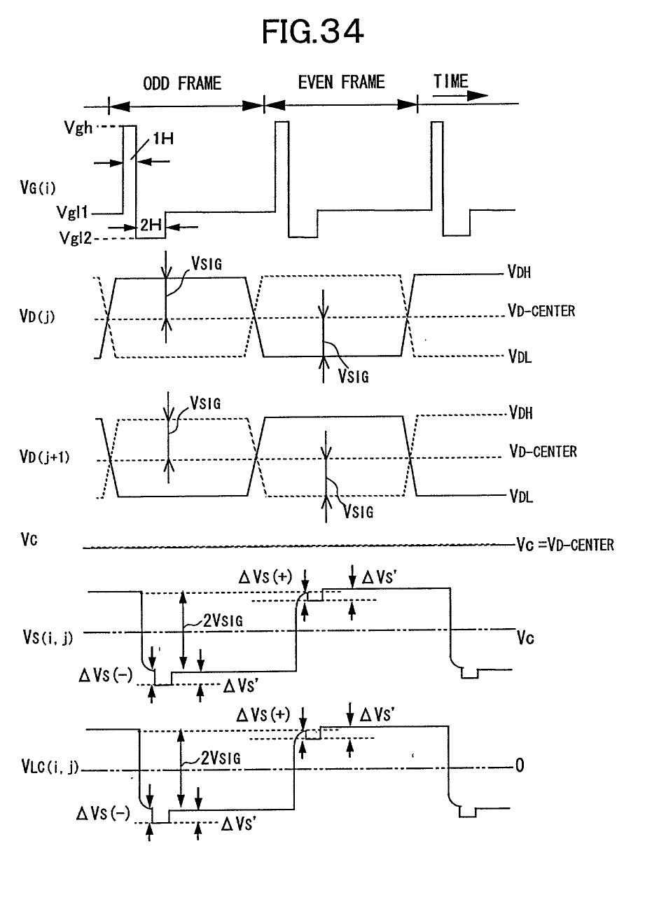

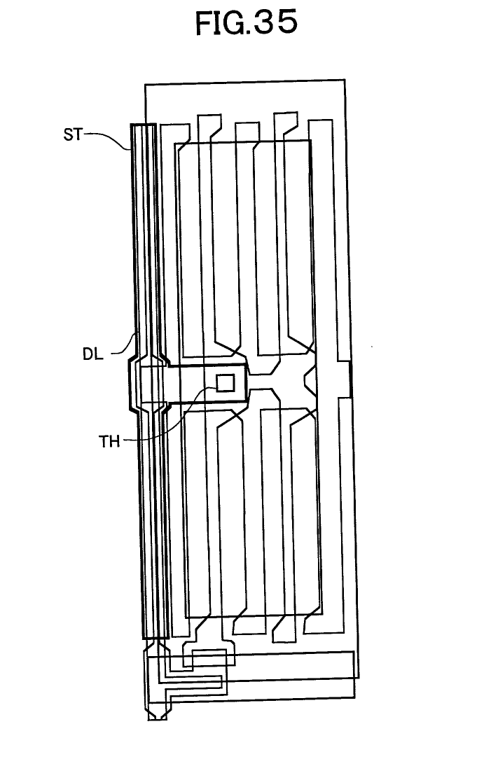

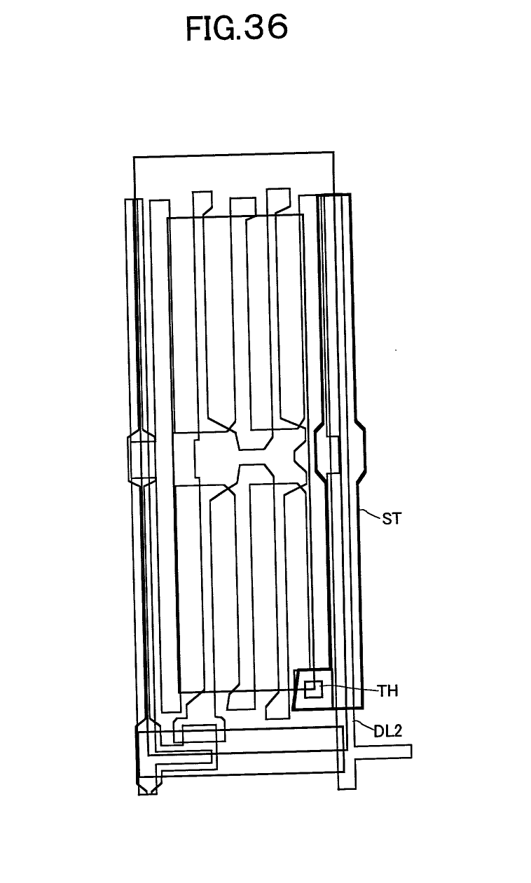

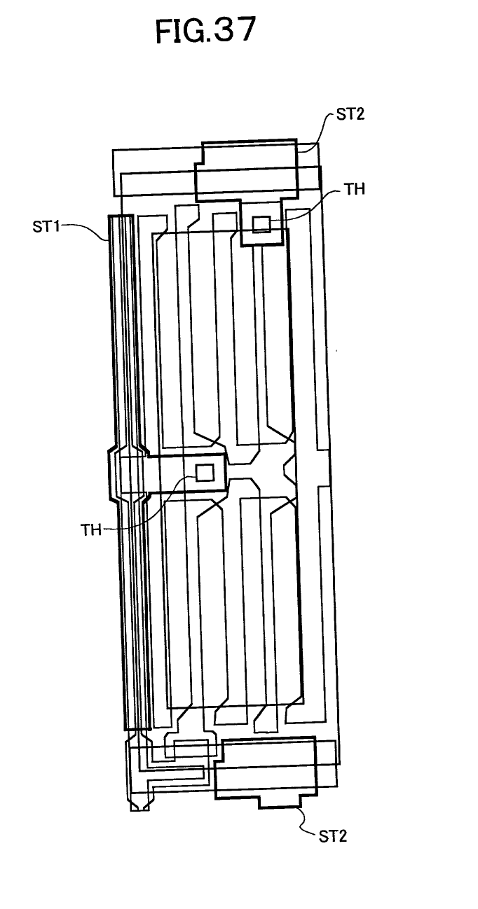

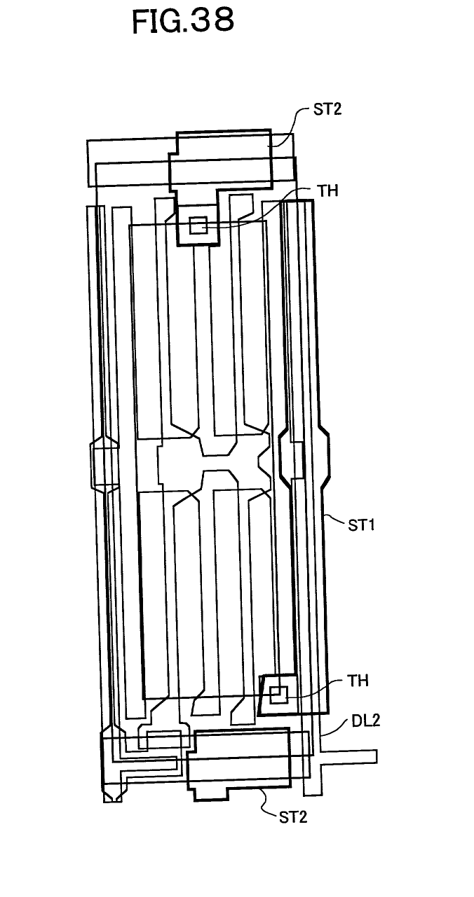

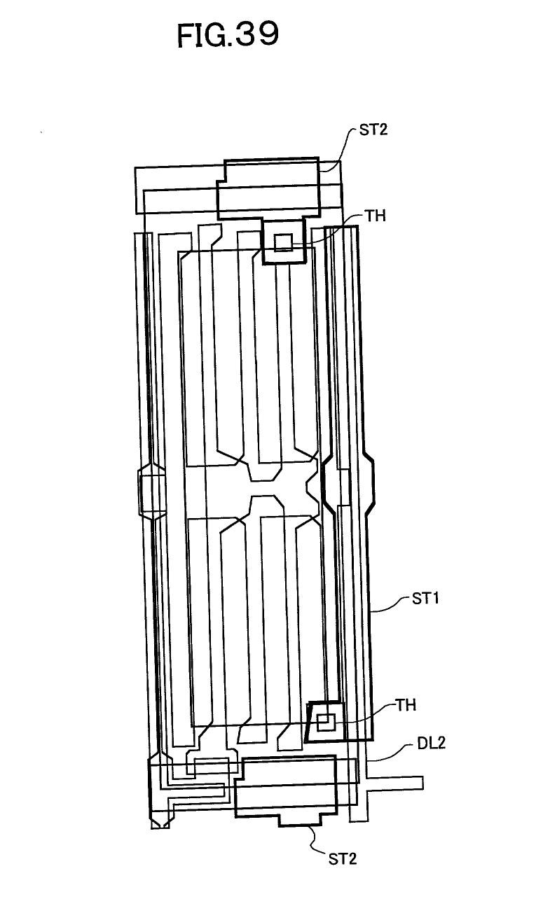

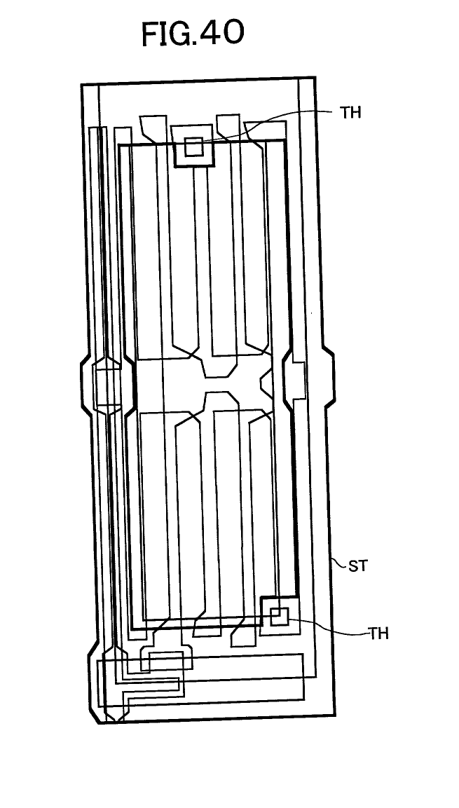

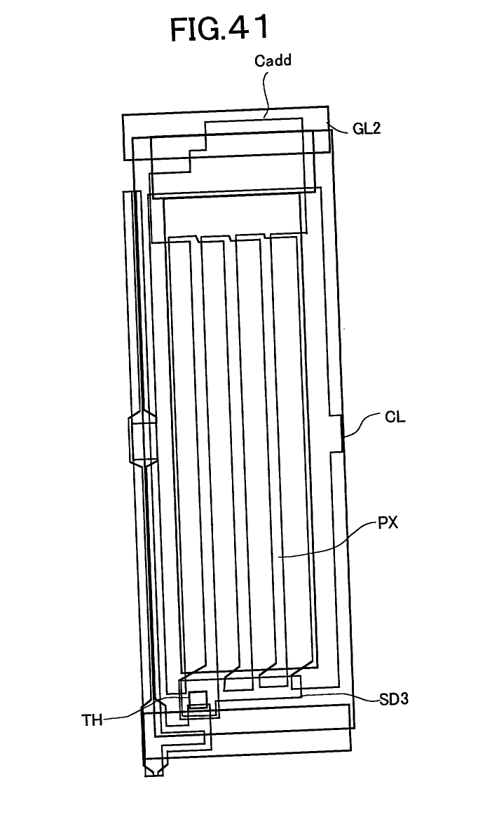

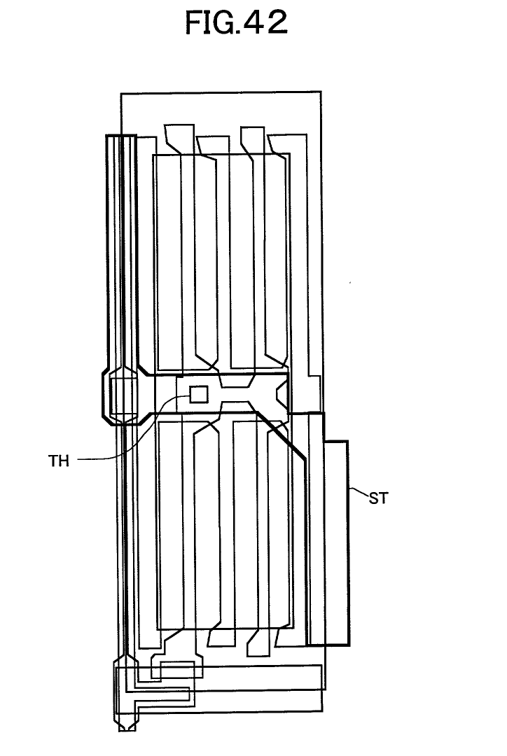

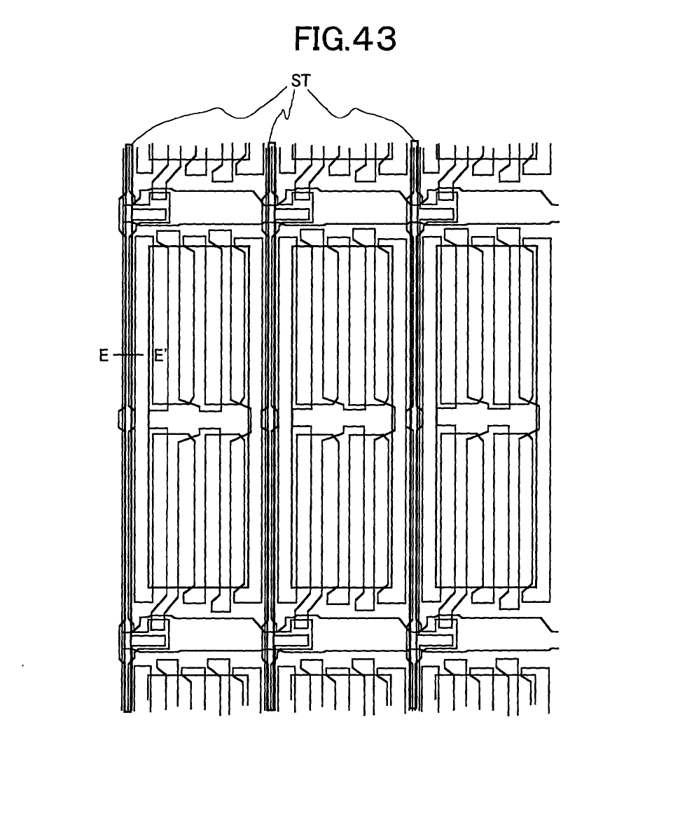

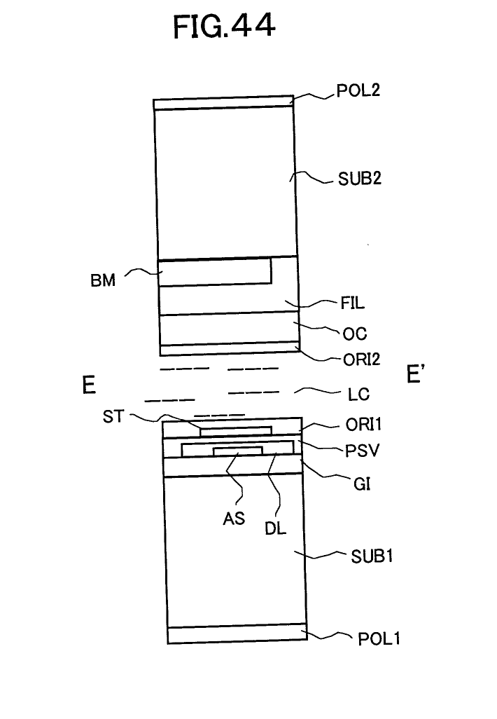

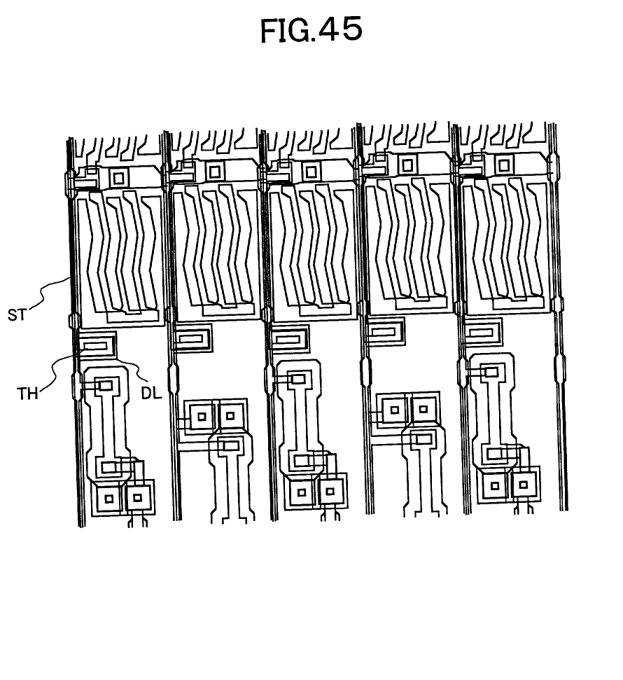

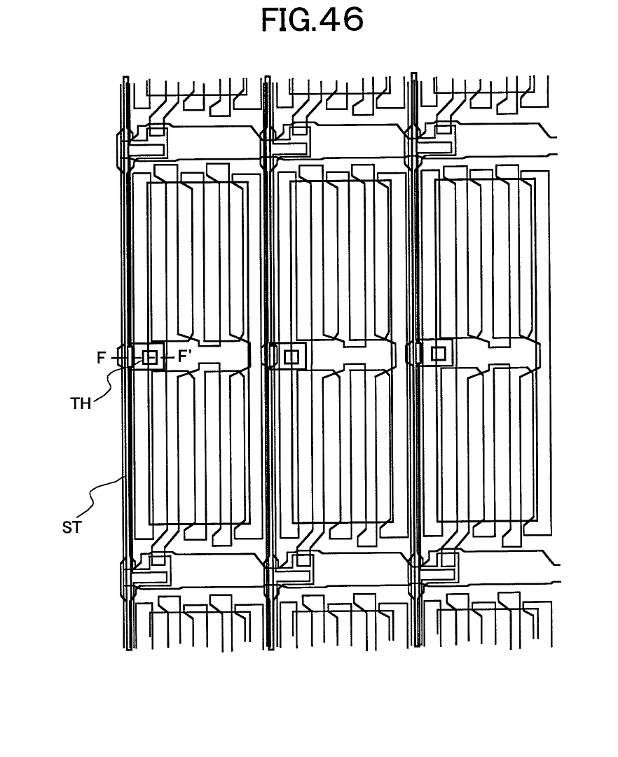

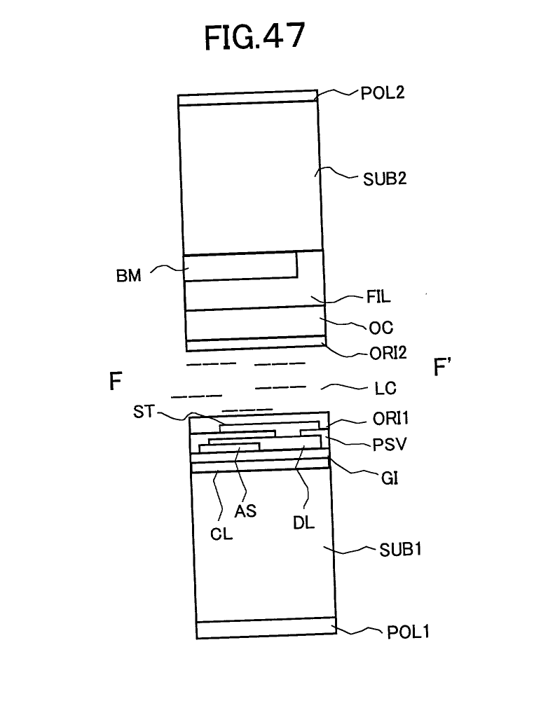

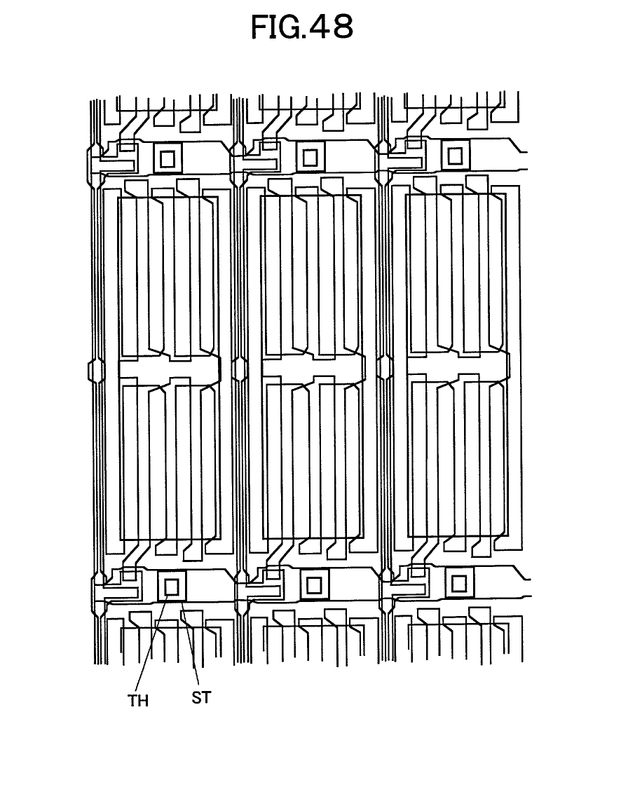

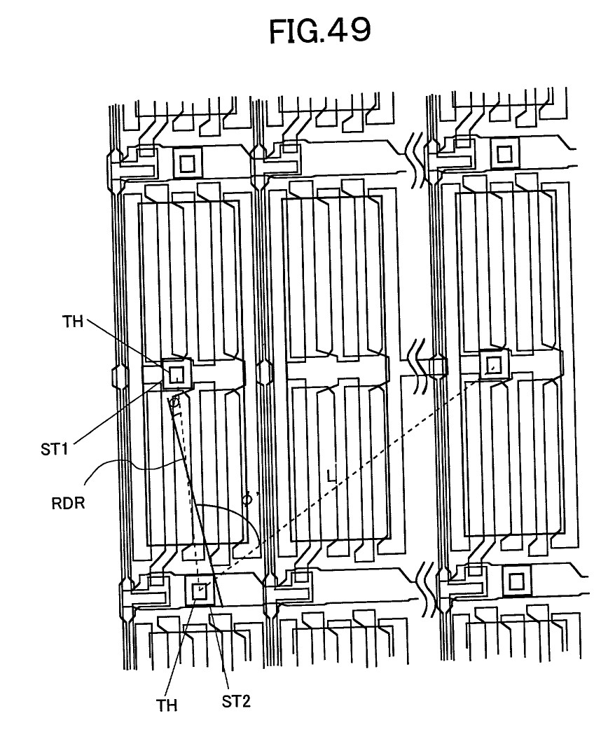

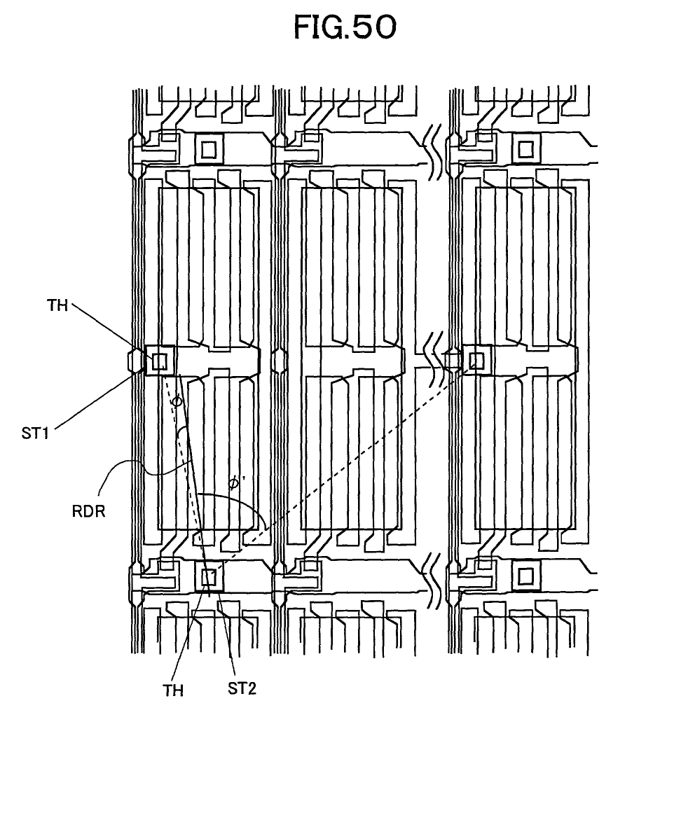

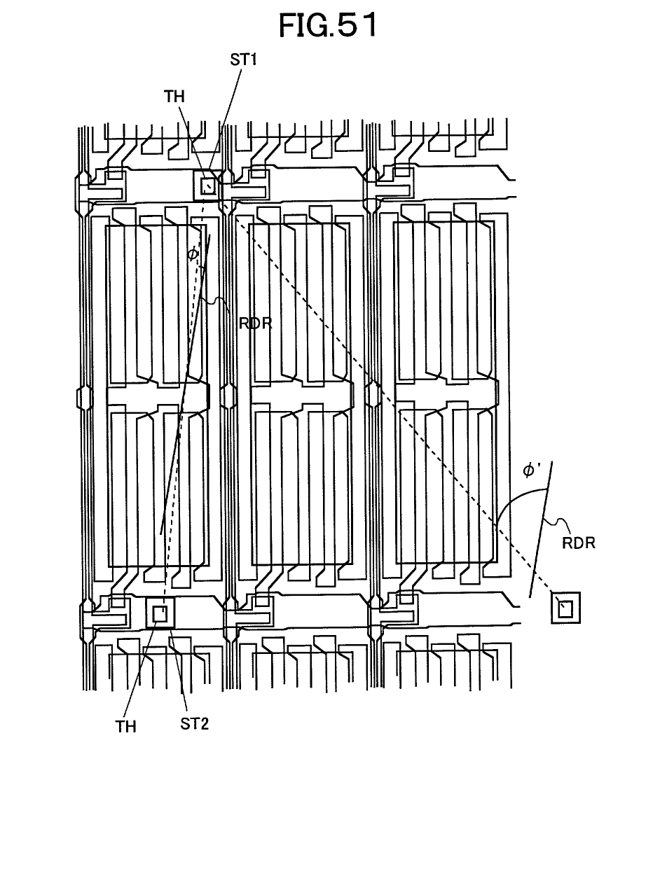

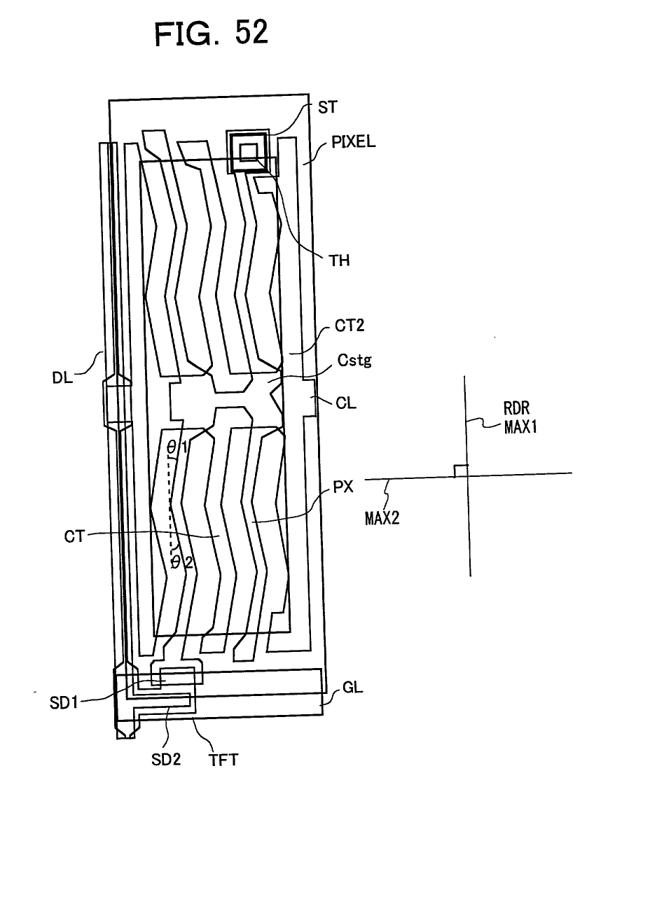

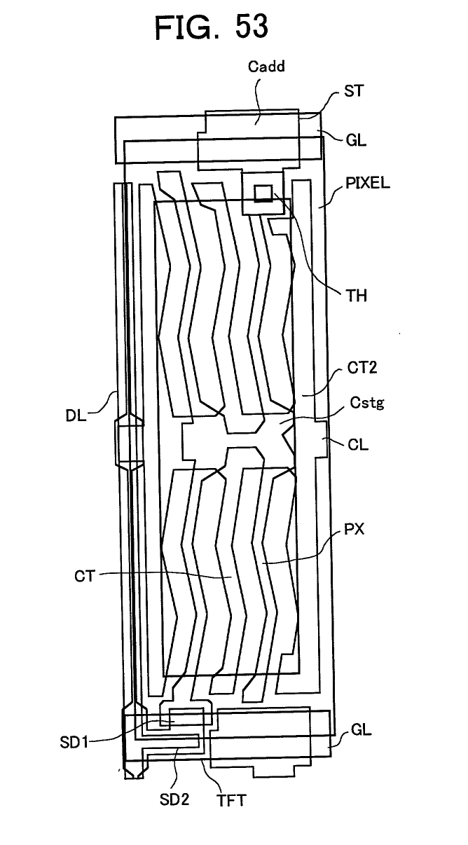

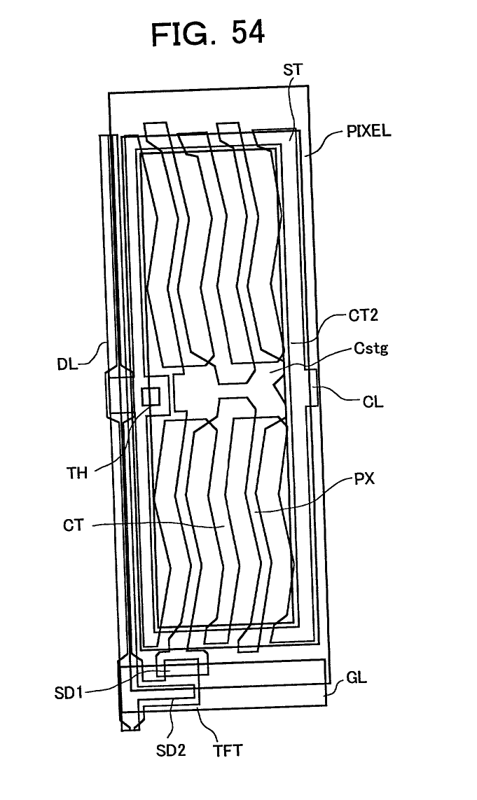

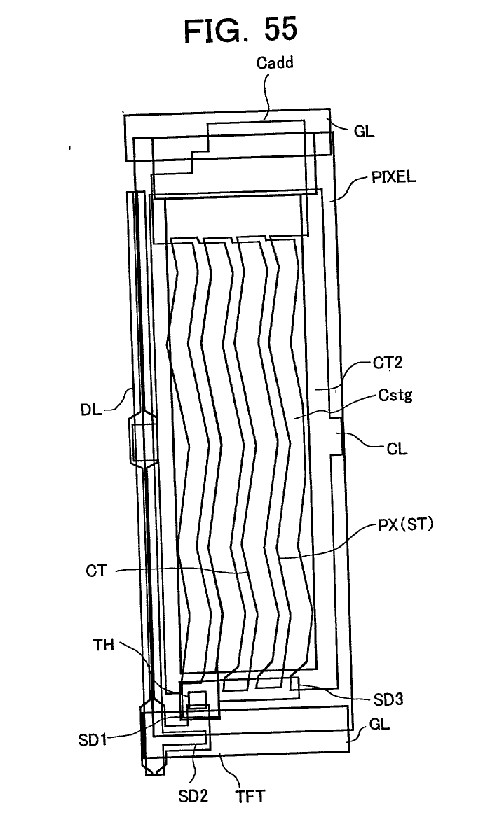

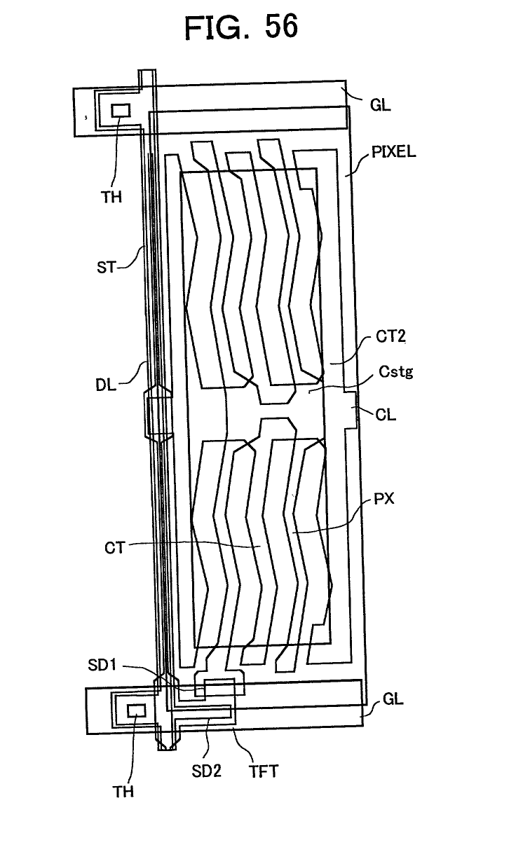

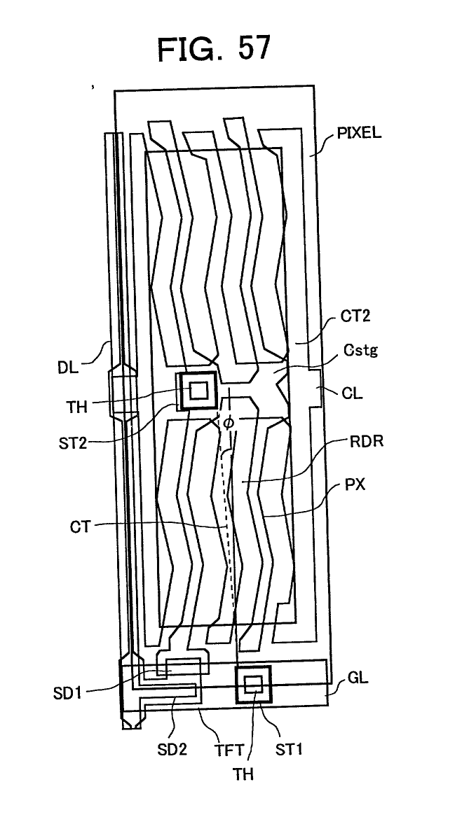

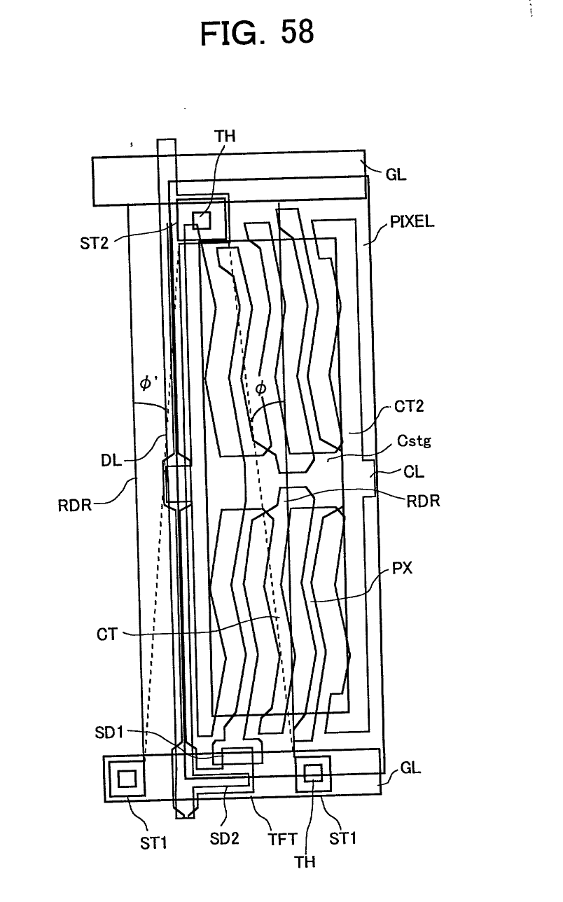

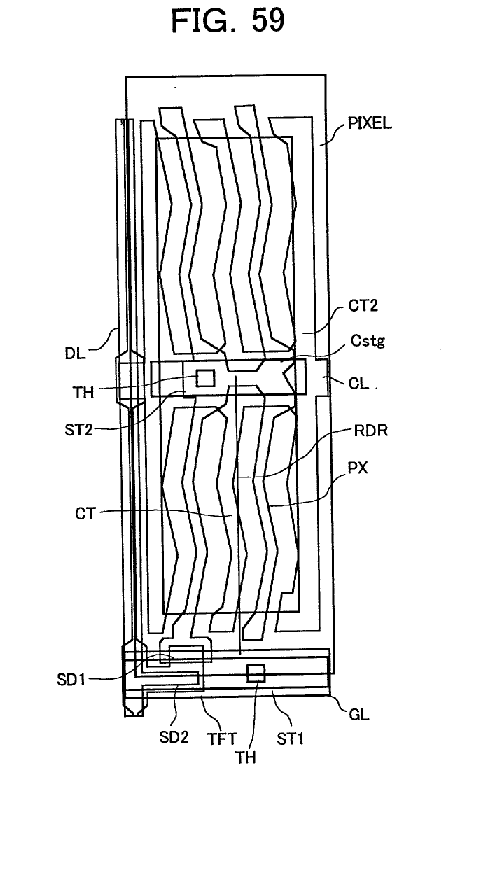

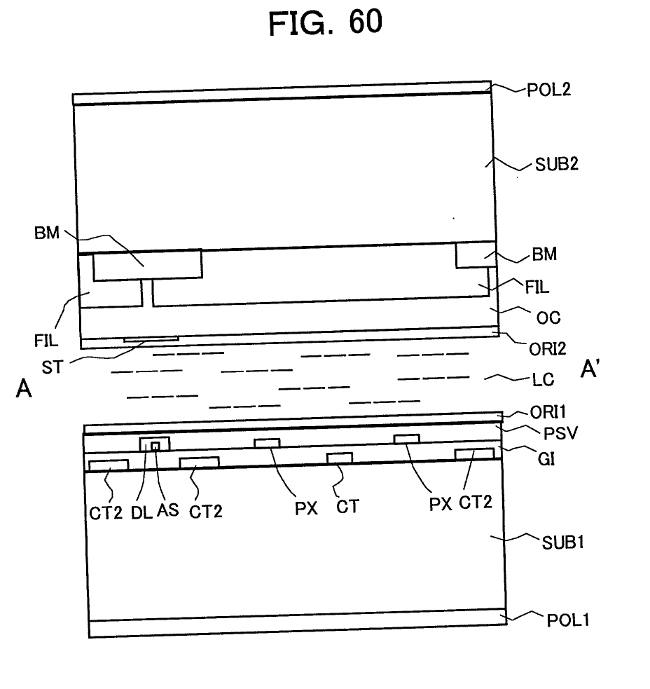

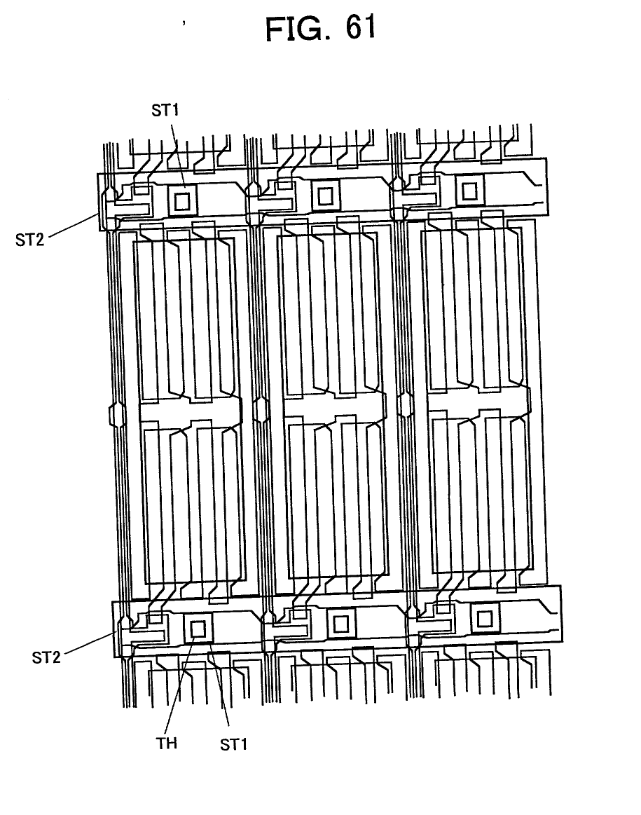

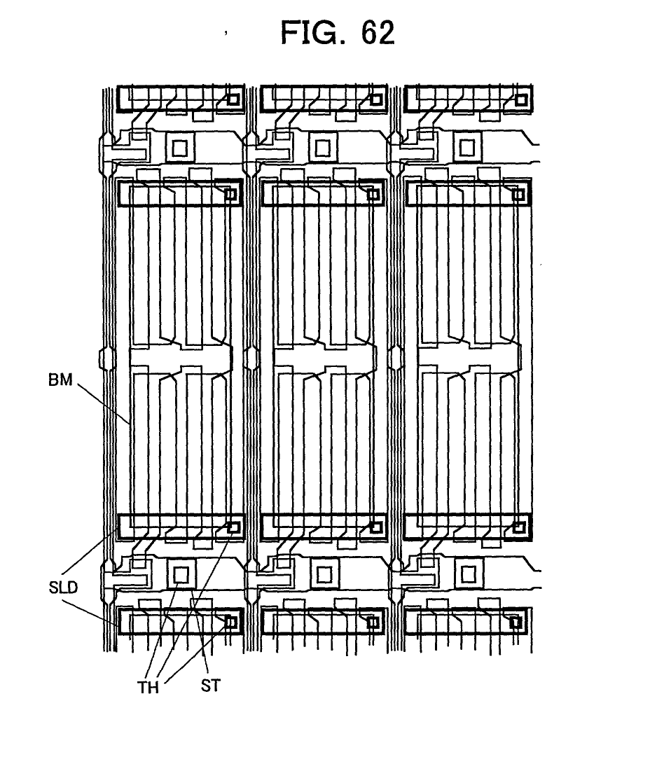

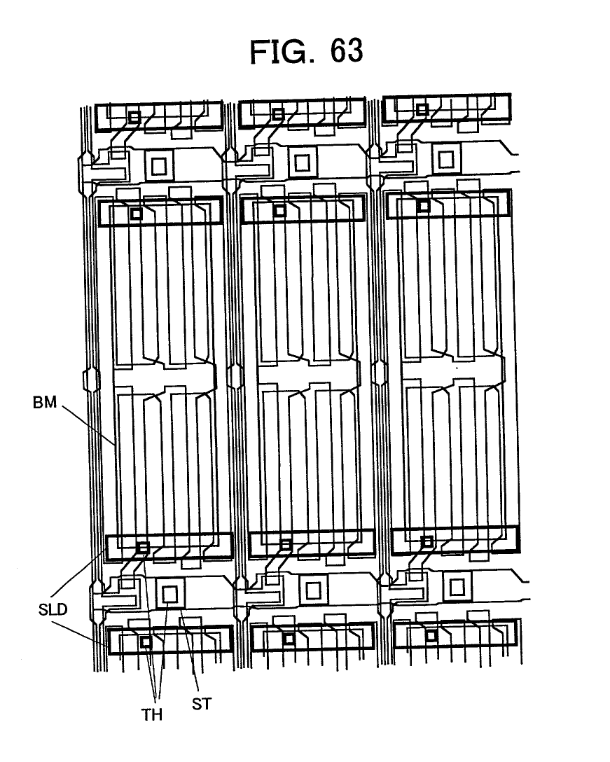

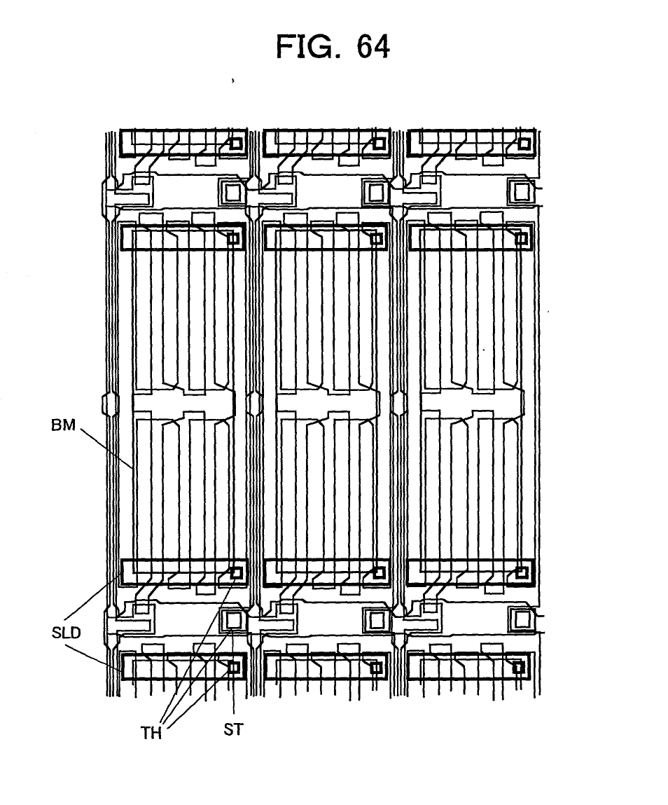

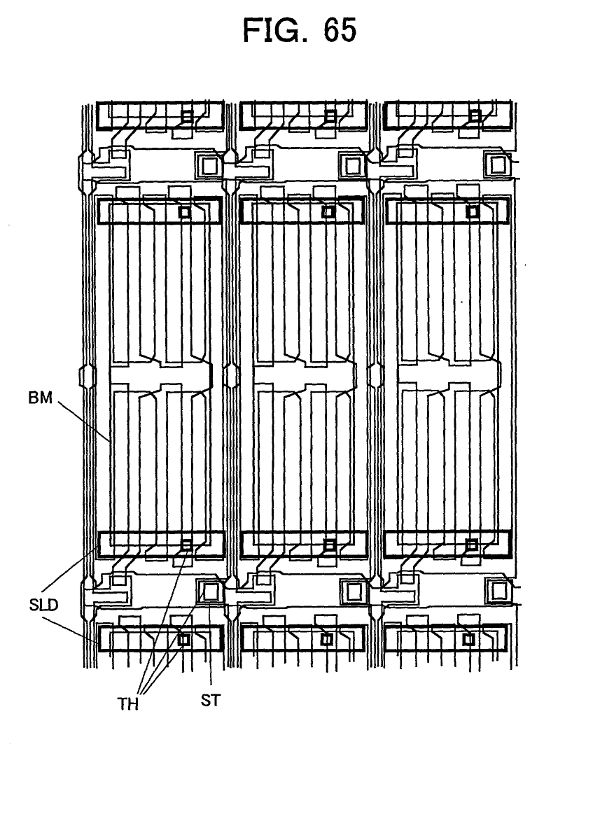

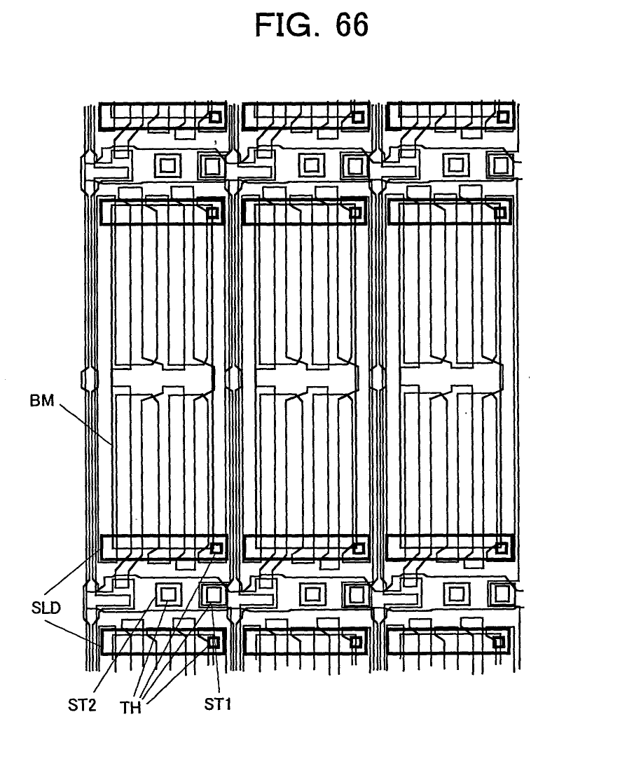

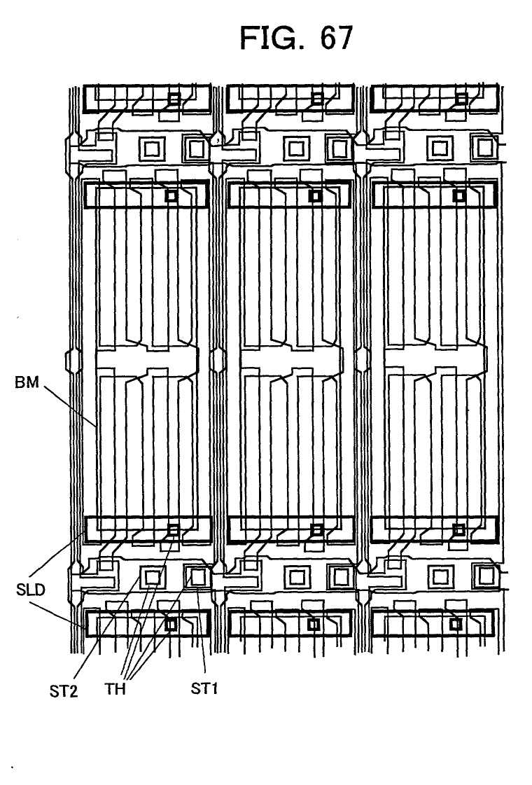

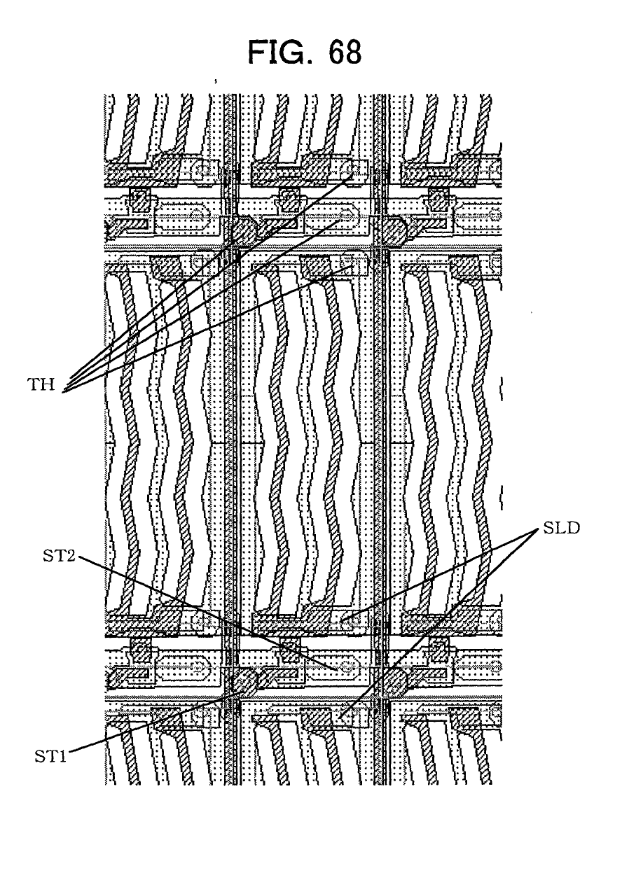

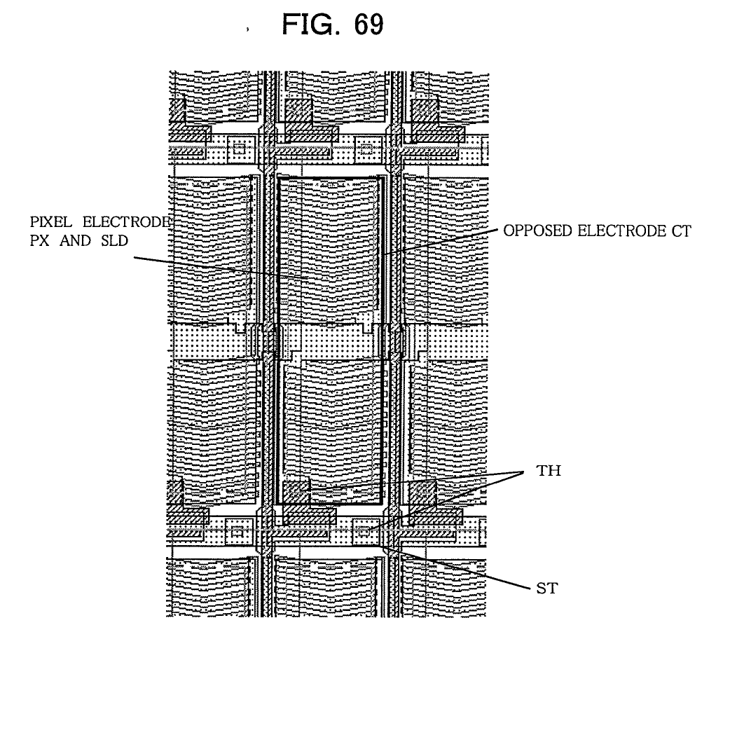

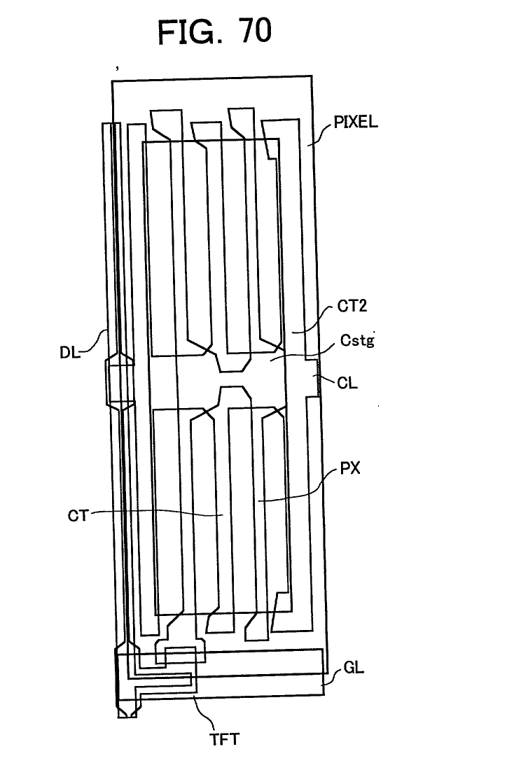

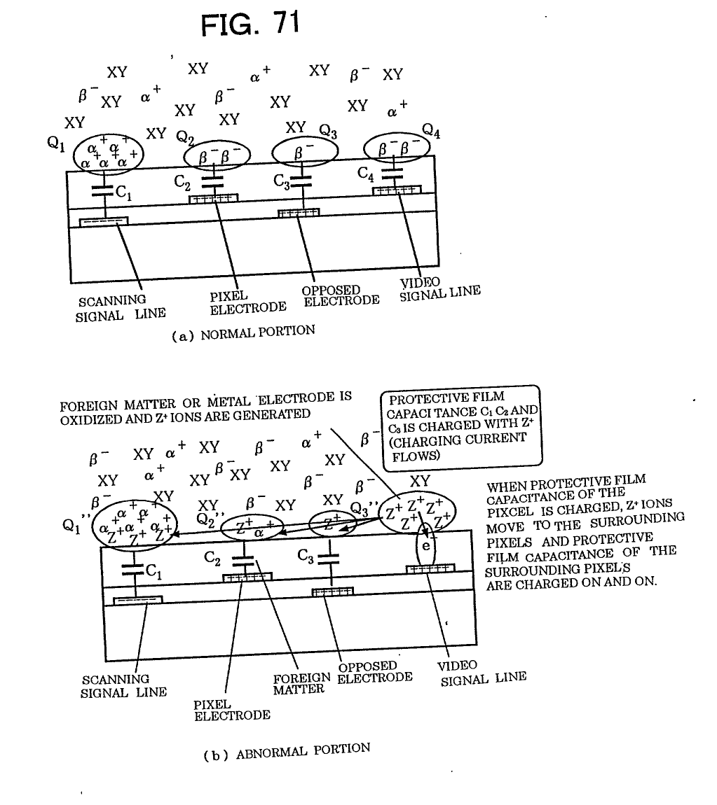

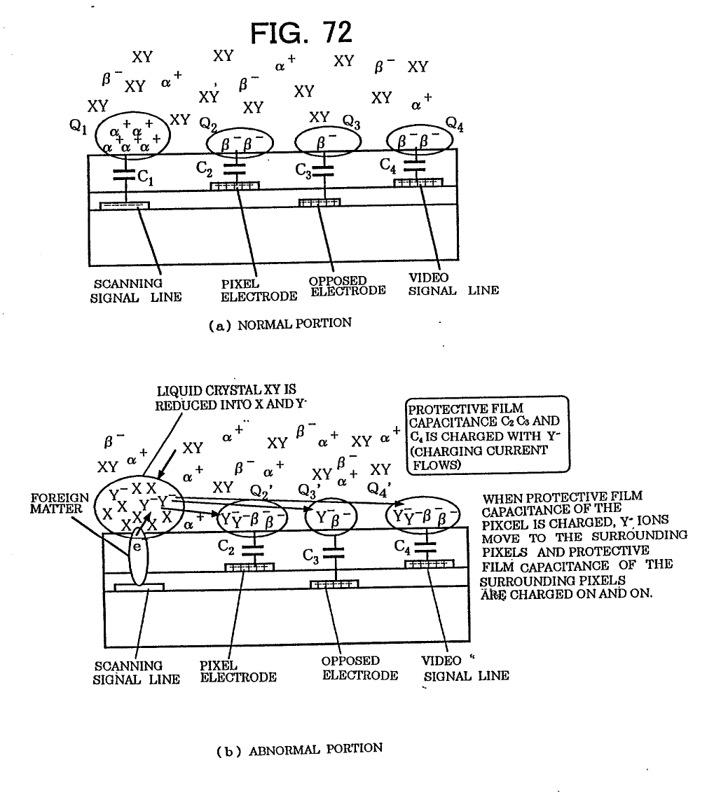

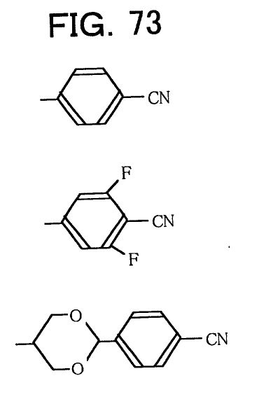

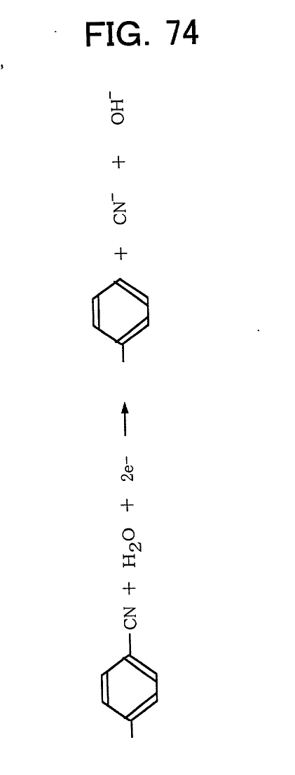

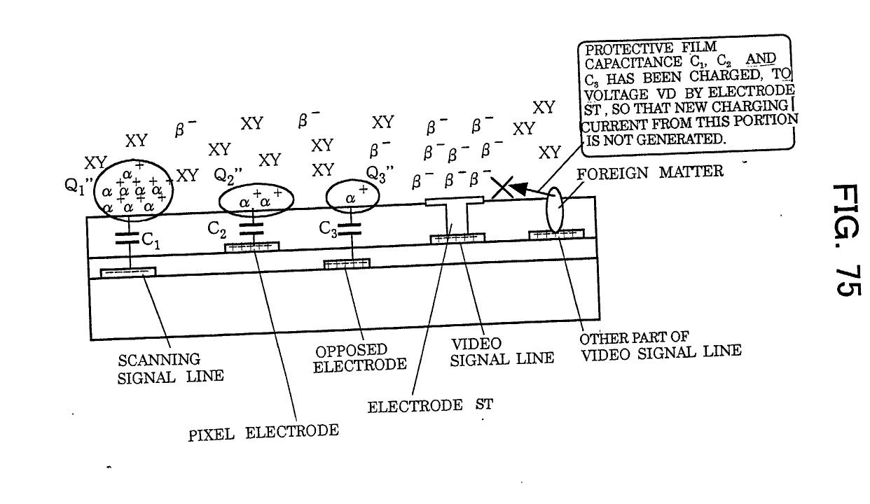

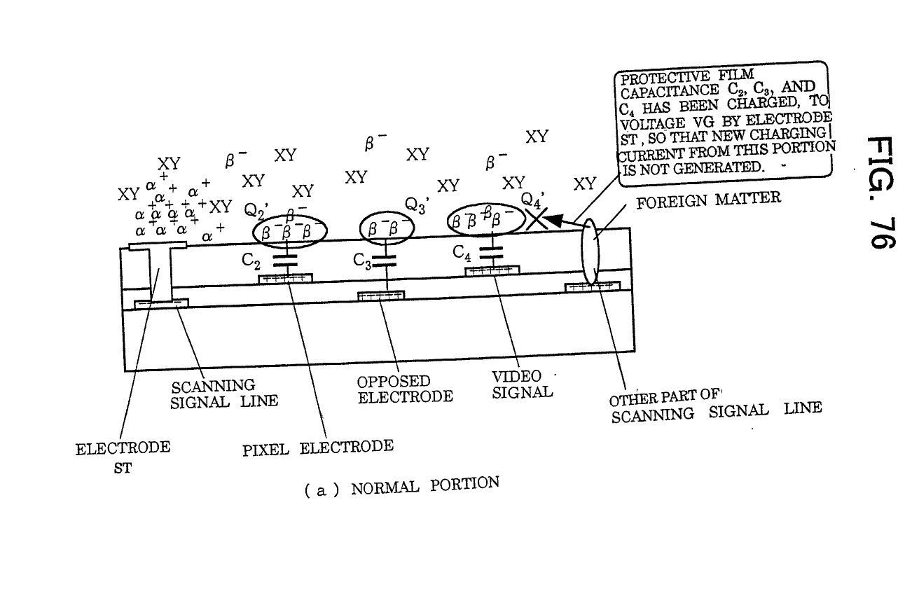

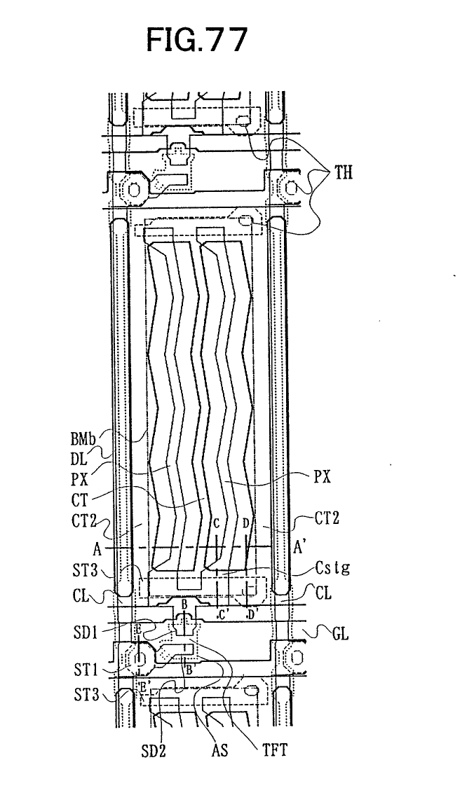

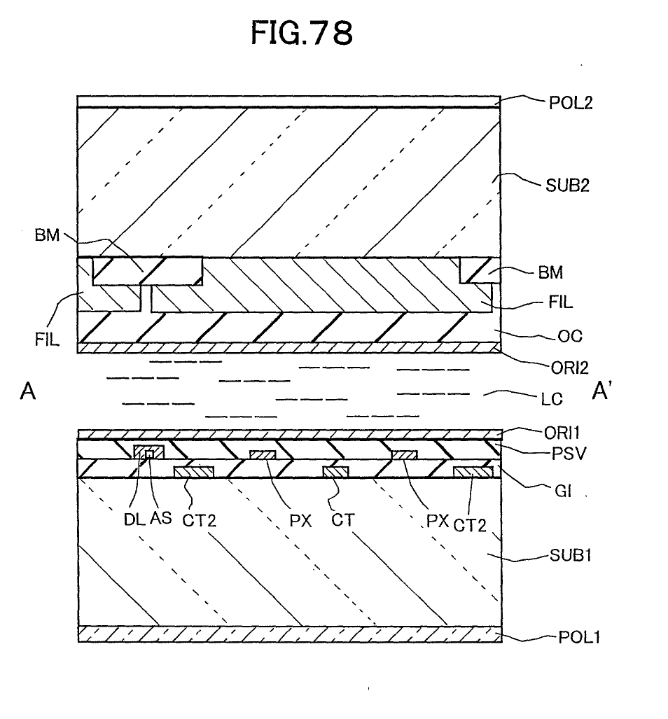

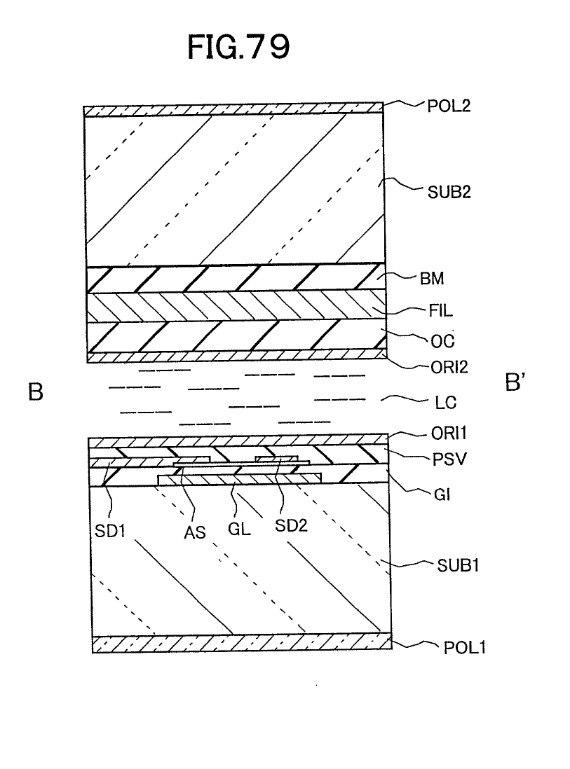

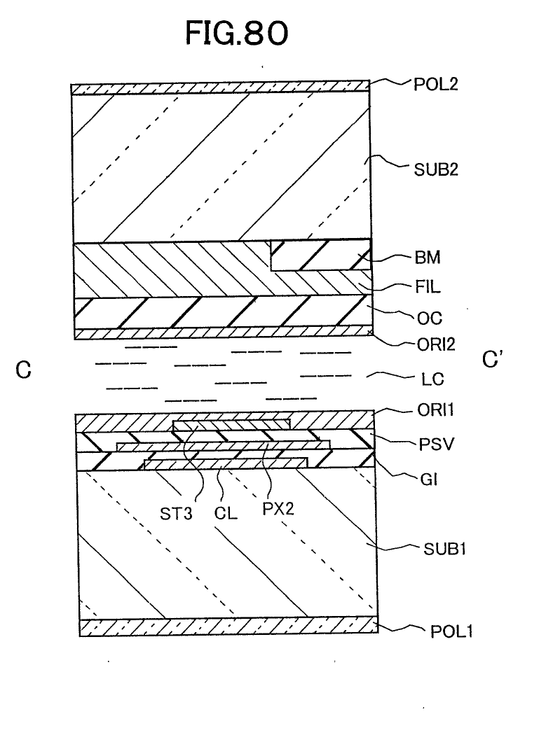

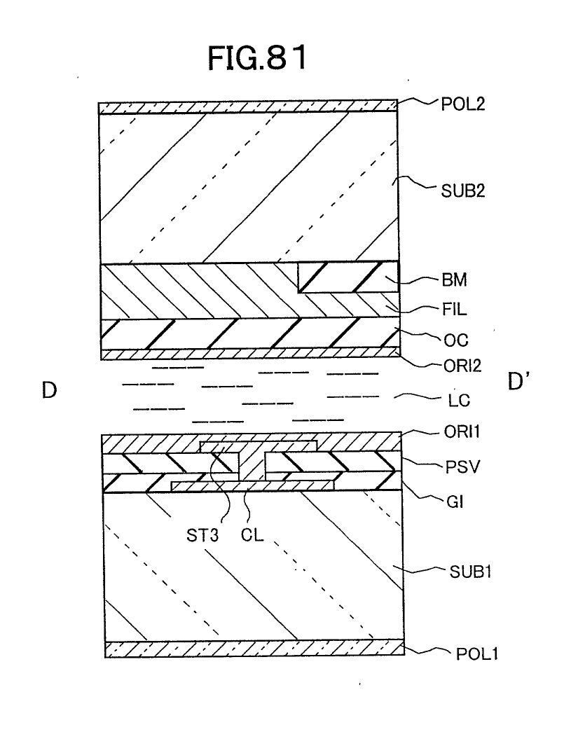

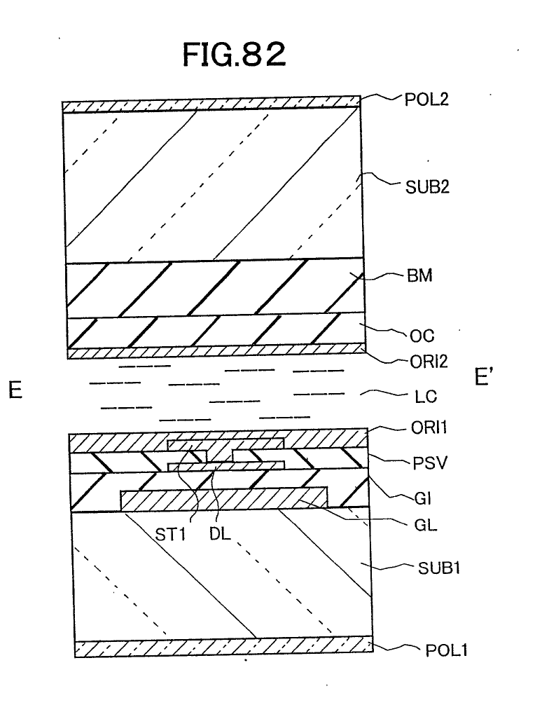

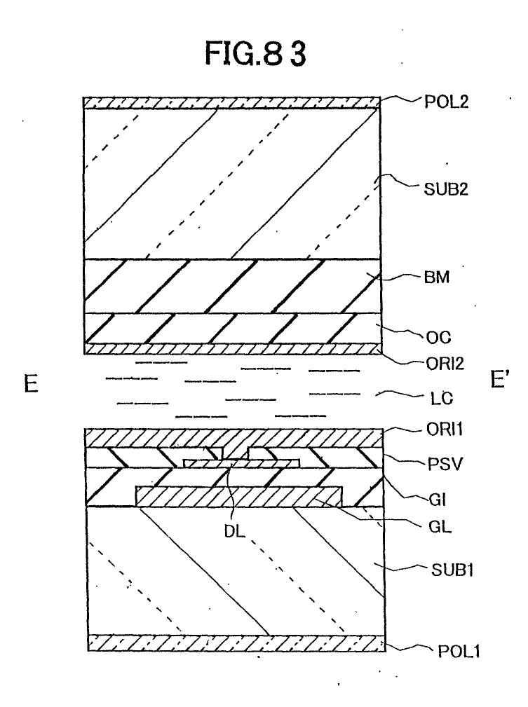

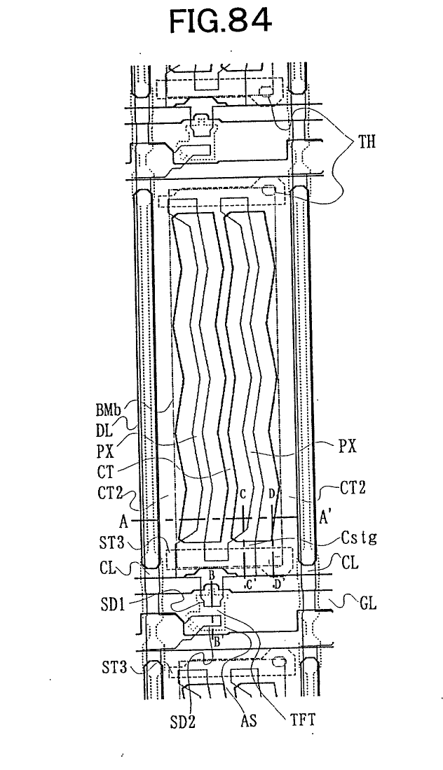

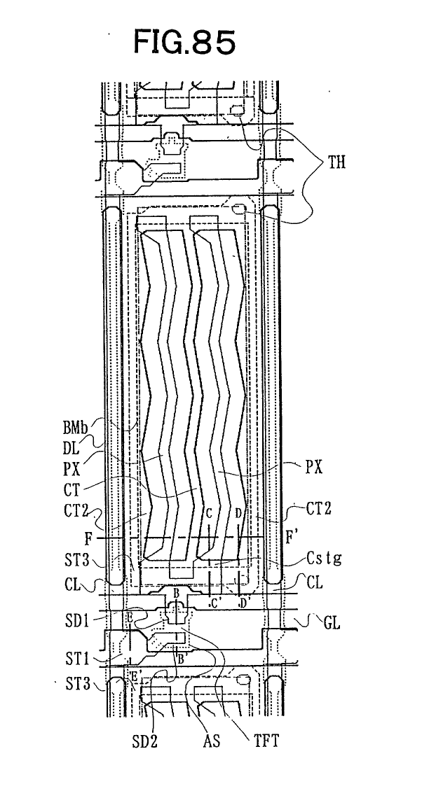

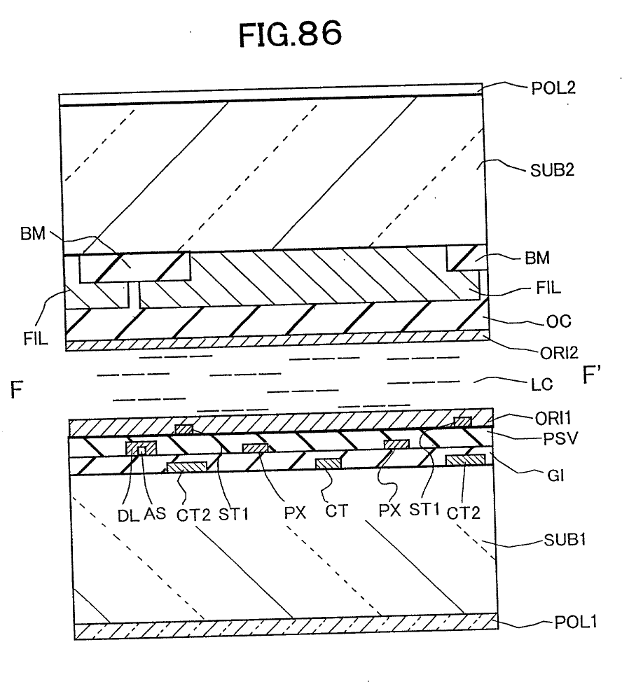

FIG. 7 shows a main portion plan view on the periphery of a matrix (AR) of a display panel PNL including the upper and lower glass substrates SUB1 and SUB2.

This panel is manufactured as follows. That is, if the panel is small in size, a plurality of devices are worked simultaneously in the form of a sheet of glass substrate and thereafter divided in order to improve the throughput. If the panel is large in size, glass substrates each having a standard size are worked regardless of kind, and then reduced into sizes suitable for the kinds respectively in order to share manufacturing equipment. In each case, a glass is cut off after a series of steps. FIG. 7 shows an example of the latter case, illustrating the upper and lower substrates SUB1 and SUB2 which have been cut off. LN designates the edges of the two substrates SUB1 and SUB2 which have not been cut off yet. In each case, in the state where the panel is completed, the size of the upper substrate SUB2 is limited to be located inside the lower substrate SUB1 so that the portions (left and upper sides in FIG. 7) where there are external connection terminal groups Tg and Td and terminals CTM (suffixes are omitted) are exposed to the outside. The terminal groups Tg and Td designate a plurality of terminals collectively in a unit of a tape carrier package TCP (FIGS. 18 and 19) on which an integrated circuit chip CHI is mounted. Such terminals include a scanning signal circuit connection terminal GTM, a video signal circuit connection terminal DTM, and leader line portions of those terminals.

A leader line in each group extending from a matrix portion to an external connection terminal portion is inclined as the leader line goes to either end. Thus, the terminals DTM and GTM of the display panel PNL are matched with the alignment pitch of the packages TCP and the connection terminal pitch in each package TCP. On the other hand, the opposed electrode terminals CTM are terminals for applying an opposed voltage from an external circuit to the opposed electrodes CT and CT2 and the opposed voltage signal lines CL. The opposed voltage signal lines CL of the matrix portion are led out toward the scanning signal circuit terminal GTM and the opposite side thereto (the left and right sides in FIG. 7). The respective opposed voltage signal lines are bundled up by common bus lines CB1 and CB2, and connected to the opposed electrode terminals CTM.

Incidentally, in this embodiment, the opposed voltage terminals CTM are provided separately from the external connection terminal groups Tg and Td. However, the opposed voltage terminals CTM may be provided as a part of the external connection terminal groups Tg and Td. In addition, although two common bus lines are provided in the embodiment, the number of common bus lines may be reduced to one. Note that it is preferable that two common bus lines are provided to eliminate waveform distortion in the opposed voltage.

Although TCP is used in this embodiment, a system (COG, FCA, or the like) in which a driver IC is mounted directly on a glass substrate may be used.

In order to seal the liquid crystal LC, a seal pattern SL is formed between the transparent glass substrates SUB1 and SUB2 along the edges of the transparent glass substrates SUB1 and SUB2 except a liquid crystal injection port INJ. For example, a sealing material therefor is made of epoxy resin.

The layers of the alignment films ORI1 and ORI2 are formed inside the seal pattern SL. The polarizing plates POL1 and POL2 are arranged on the outer surfaces of the lower and upper transparent glass substrates SUB1 and SUB2 respectively. The liquid crystal LC is sealed in an area partitioned by the seal pattern SL between the lower and upper alignment films ORI1 and ORI2 setting the directions of the liquid crystal molecules. The lower alignment film ORI1 is formed on the protective film PSV on the lower transparent glass substrate SUB1.

This liquid crystal display unit is fabricated as follows. That is, various layers are piled up on the lower and upper transparent glass substrates SUB1 and SUB2 respectively. The seal pattern SL is formed on the upper transparent glass substrate SUB2. The lower and upper transparent glass substrates SUB1 and SUB2 are subject to panel alignment. The liquid crystal LC is injected from the opening portion or the injection port INJ of the seal material SL. The injection port INJ is sealed up with epoxy resin or the like. The upper and lower substrates are cut off.

Although the liquid crystal injection port INJ is provided on the opposite side to the scanning signal circuit terminal GTM, it may be provided on the opposite side to the video signal circuit connection terminal DTM. In addition, preferably, not one but two or more injection ports are provided to shorten the injecting time.

<<Gate Terminal Portion>>

Diagrams (a) and (b) of FIG. 8 show the connection structure from the scanning signal line GL of the display matrix to the external connection terminal GTM thereof. FIG. 8(a) is a plan view, and FIG. 8(b) shows a sectional view taken on line B-B in FIG. 8(a). Incidentally, the diagrams (a) and (b) of FIG. 8 correspond to the vicinity of the left side of FIG. 7, and a portion of the inclined line is represented in a straight line for the sake of convenience. In the diagrams (a) and (b) of FIG. 8, the Cr—Mo layer g3 is hatched to be easily understood.

The gate terminal GTM is constituted by the Cr—Mo layer g3 and a transparent conductive layer il for protecting the surface of the Cr—Mo layer g3 and improving the reliability in connection with TCP (Tape Carrier Package). As this transparent conductive layer il, a transparent conductive film ITO formed in the same step as the ST electrode ST is used.

In the plan view, the insulating film GI and the protective film PSV are formed on the right side of the boundary of the gate terminal GTM. Thus, the terminal portion GTM located in the left end is exposed from the insulating film GI and the protective film PSV so that the terminal portion GTM can come in electric contact with an external circuit. In the diagrams (a) and (b) of FIG. 8, only one pair of the gate line GL and the gate terminal are shown. In practice, however, a terminal group Tg (FIG. 7) in which a plurality of such pairs are arrayed vertically is arranged. In a manufacturing process, the left ends of gate terminals are extended beyond the cut-off area of the substrate and short-circuited by wiring SHg (not shown). This short-circuit is useful to prevent static damage when the alignment film ORIL is rubbed in the manufacturing process.

<<Drain Terminal DTM>>

Diagrams (a) and (b) of FIG. 9 show the connection from the video signal line DL to the external connection terminal DTM thereof. FIG. 9(a) is a plan view thereof, and FIG. 9(b) shows a sectional taken on line B-B in FIG. 9(a). Incidentally, the diagrams (a) and (b) of FIG. 9 correspond to the vicinity of the upper side of FIG. 7, and their right ends correspond to the upper end portion of the substrate SUB1 though the directions of the drawings are changed for the sake of convenience.

Each of inspection terminals TSTd is made wider than the wiring portion so that the inspection terminal TSTd can be brought into contact with a probe or the like though an external circuit is not connected thereto. Similarly,each of the drain terminals DTM is also made wider than the wiring portion so that the drain terminal DTM can be connected with an external circuit. Such external connection drain terminals DTM are arrayed in the upper/lower direction. The drain terminals DTM form each terminal group Td (suffixes are omitted) as shown in FIG. 7. The drain terminals DTM are extended beyond the cut-off line of the substrate SUB1, and all the drain terminals DTM are short-circuited with one another by wiring SHd (not shown) so as to prevent static damage in the manufacturing process. Such inspection terminals TSTd are formed on alternate video signal lines DL as shown in FIG. 9(a).

The drain connection terminals DTM are formed of a transparent conductive layer il, and connected to the video signal lines DL respectively in the portion where the protective film PSV is removed. As this transparent conductive layer il, a transparent conductive film ITO formed in the same step as the ST electrode ST is used in the same manner as the gate terminals GTM. A leader line from the matrix portion to the drain terminal portions DTM is formed of a layer d3 which is in the same level as the video signal line DL.

<<Opposed Electrode Terminal CTM>>

Diagrams (a) and (b) of FIG. 10 show the connection from the opposed voltage signal lines CL to the external connection terminal CTM thereof. FIG. 10(a) is a plan view thereof, and FIG. 10(b) shows a sectional taken on line B-B in FIG. 10(a). Incidentally, the diagrams (a) and (b) of FIG. 10 correspond to the vicinity of the upper right side of FIG. 7.

Respective opposed voltage signal lines CL are bundled up by the common bus line CB1, and led out to the opposed electrode terminal CTM. The common bus line CB1 has a structure in which a conductive layer d3 is laminated on a conductive layer g3 and those layers are electrically connected through a transparent conductive layer il. Thus, the resistance of the common bus line CB1 is reduced so that an opposed voltage can be supplied from an external circuit to each opposed voltage signal line CL sufficiently. This structure has a feature that the resistance of the common bus line can be reduced particularly without newly adding another conductive layer.

The opposed electrode terminal CTM has a structure in which a transparent conductive layer il is laminated on a conductive layer g3. As this transparent conductive layer il, a transparent conductive film ITO formed in the same step as the pixel electrode PX is used in the same manner as other terminals. The conductive layer g3 is covered with the transparent conductive layer il having high durability so that the surface of the conductive layer g3 is protected from electric erosion or the like by the transparent conductive layer il. In addition, the transparent conductive layer il is connected to the conductive layers g3 and d3 through holes formed in the protective film PSV and the insulating film GI. Thus, electric conduction is ensured.

On the other hand, diagrams (a) and (b) of FIG. 11 show the connection from the opposed voltage signal lines CL to the external connection terminal CTM2 on the opposite side to the external connection terminal CTM1. FIG. 11(a) is a plan view thereof, and FIG. 11(b) shows a sectional taken on line B-B in FIG. 11(a). Incidentally, the diagrams (a) and (b) of FIG. 11 correspond to the vicinity of the upper left side of FIG. 7. Here, the respective opposed voltage signal lines CL on the opposite ends (on the gate terminal GTM side) are bundled up by the common bus line CB2, and led out to the opposed electrode terminal CTM2. There is a different point from the common bus line CB1 that the common bus line CB2 is formed of a conductive layer d3 and a transparent conductive layer il so as to be insulated from the scanning signal line GL. In addition, the insulation from the scanning signal line GL is attained by the insulating film GI.

<<Equivalent Circuit of Whole Display Unit>>

FIG. 12 shows a connection diagram of an equivalent circuit of the display matrix portion and its peripheral circuits. FIG. 12 is drawn in accordance with real geometrical arrangement though it is a circuit diagram. AR designates a matrix array in which a plurality of pixels are arrayed two-dimensionally. In FIG. 12, X designates video signal lines DL, and suffixes G, B and R are given thereto correspondingly to green, blue and red pixels respectively. Y designates scanning signal lines GL, and suffixes 1, 2, 3, . . . , end are given thereto in accordance with the order of scanning timing.

The scanning signal lines Y (suffixes are omitted) are connected to a vertical scanning circuit V, and the video signal lines X (suffixes are omitted) are connected to a video signal drive circuit H. SUP designates a circuit including a power supply circuit for obtaining a plurality of stabilized voltage sources divided from one voltage source, and a circuit for converting information for a CRT (Cathode Ray Tube) from a host system (upper-rank operation system) for information for a TFT liquid crystal display unit.

<<Driving Method>>

FIG. 13 shows a driving waveform of the liquid crystal display unit according to this embodiment. It is assumed that an opposed voltage Vc is a constant voltage. A scanning signal voltage Vg takes an ON level in every scanning period, and takes an OFF level in the other period. A video signal voltage is applied to one pixel. At this time, the amplitude of the video signal voltage Vd is made twice as large as a desired voltage applied to the liquid crystal layer, and the positive and negative poles are inverted every frame. Here, the video signal voltage Vd is inverted in polarity every column and every two rows. As a result, pixels inverted in polarity are adjacent to each other vertically and horizontally so that it can be made difficult to produce flicker and crosstalk (smear). In addition, the opposed voltage Vc is set to be a voltage lower than a center voltage of polarity inversion of the video signal voltage by a given quantity. This is because a feed through voltage generated when the thin film transistor device is turned from ON to OFF is corrected so that an AC voltage having a small DC component is applied to the liquid crystal (if a DC voltage is applied to the liquid crystal, an after image, degradation, or the like, is intensified). Thus, the potential of the DC component of the pixel electrode becomes substantially equal to the potential of the opposed electrodes. In addition, by making the opposed voltage an AC voltage, the maximum amplitude of the video signal voltage can be reduced. Thus, it is possible to use a video signal drive circuit (signal-side driver) which is low in withstand voltage.

<<Operation of Storage Capacitance Cstg>>

The storage capacitance Cstg is provided for storing video information written in the pixel (after the thin film transistor TFT has been turned OFF), for a long time. In a system according to the present invention in which an electric field is applied in parallel with the substrate surface, there is little capacitance (so-called liquid crystal capacitance) constituted by the pixel electrode and the opposed electrodes, differently from a system in which an electric field is applied perpendicularly to the substrate surface. Thus, video information cannot be stored in the pixel if there is no storage capacitance Cstg. Therefore, in the system in which an electric field is applied in parallel with the substrate surface, the storage capacitance Cstg is an essential constituent.

In addition, the storage capacitance Cstg operates to reduce the influence of the gate potential variation Δvg on the pixel electrode potential Vs when the thin film transistor TFT performs switching. This aspect is expressed in the following expression.

ΔVs={Cgs/(Cgs+Cstg+Cpix)}×ΔVg

Here, Csg designates a parasitic capacitance formed between the gate electrode GT and the source electrode SD1 of the thin film transistor TFT, Cpix designates a capacitance formed between the pixel electrode PX and the opposed electrodes CT and CT2, and ΔVs designates a variation in the pixel electrode potential caused by Δvg, that is, a so-called feed through voltage. This variation Δvs becomes a factor of a DC component applied to the liquid crystal LC. However, the more the storage capacitance Cstg is increased, the more the value of the variation Δvs can be reduced. The reduction of the DC component to be applied to the liquid crystal LC can improve the life of the liquid crystal LC, and reduce so-called image persistence which is a phenomenon that a previous image is left behind when the liquid crystal display screen is switched.

As described previously, as the gate electrode GT is made large enough to cover the i-type semiconductor layer AS perfectly, the overlapping area with the source electrode SD1 and the drain electrode SD2 increases. Thus, there arises an adverse effect that the parasitic capacitance Cgs increases so that the pixel electrode potential Vs is easily affected by the gate (scanning) signal Vg. However, by providing the storage capacitance Cstg, such a demerit can be eliminated.

<<production Method>>

Next, description will be made about a method for producing the substrate SUB1 side of the above-mentioned liquid crystal display unit with reference to FIGS. 14 to 16. Incidentally, in FIGS. 14 to 16, alphabets in the center are abbreviations of step names, and the left side shows the thin film transistor TFT portion shown in FIG. 3, while the right side shows a flow of working in the sectional views of the vicinity of the gate terminal shown in FIG. 8. Steps A to I except steps B and D are divided in accordance with respective photographic processing. The sectional view of each step shows the stage in which working after photographic processing has been terminated and a photo resist has been removed. Incidentally, the photographic processing in this description means a series of work from application of a photo resist through edge exposure of the photo resist with a mask to development of the photo resist. Repeated description about the photographic processing will be avoided here, but description will be made below along the divided steps.

Step A in FIG. 14

A conductive film g3 made of Cr—Mo or the like and having a thickness of 2,000 Å is provided, by sputtering, on the lower transparent glass substrate SUB1 made of AN635 Glass (trade name).

After photographic processing, the conductive film g3 is selectively etched with cerium ammonium nitrate. Thus,the gate electrode GT, the scanning signal line GL, the opposed voltage signal line CL, the gate terminal GTM, the first conductive layer of the common bus line CB1, the first conductive layer of the opposed electrode terminal CTM1, and the bus line SHg (not shown) for connecting the gate terminals GTM are formed.

Step B in FIG. 14

Ammonia gas, silane gas and nitrogen gas are introduced into a plasma CVD apparatus so as to provide an Si nitride film having a thickness of 3,500 Å. Silane gas and hydrogen gas are introduced into the plasma CVD apparatus so as to provide an i-type amorphous Si film having a thickness of 1,200 Å. Then, hydrogen gas and phosphine gas are introduced into the plasma CVD apparatus so as to provide an N(+)-type amorphous Si film having a thickness of 300 Å.

Step C in FIG. 14

After photographic processing, the N(+)-type amorphous Si film and the i-type amorphous Si film are selectively etched by use of SF6 and CC14 as dry etching gas, so as to form the island of the i-type semiconductor layer AS.

Step D in FIG. 15

A conductive film d3 made of Cr and having a thickness of 300 Å is provided by sputtering. After photographic processing, the conductive film d3 is etched with a liquid similar to that in Step A so as to form the video signal line DL, the source electrode SD1, the drain electrode SD2, the first conductive layer of the common bus line CB2, and the bus line SHd (not shown) for short-circuiting the drain terminals DTM.

Next, CC14 and SF6 are introduced into a dry etching apparatus so as to etch the N(+)-type amorphous Si film. Thus, the N(+)-type semiconductor layer d0 between the source and the drain is selectively removed.

Step E in FIG. 15

Ammonia gas, silane gas and nitrogen gas are introduced into the plasma CVD apparatus so as to provide an Si nitride film having a thickness of 0.4 μm. After photographic processing, the Si nitride film is selectively etched by use of SF6 as dry etching gas, so as to pattern the protective film PSV and the insulating film GI.

Step F in FIG. 16

A transparent conductive film il made of an ITO film having a thickness of 1,400 Å is provided by sputtering. After photographic processing, the transparent conductive film il is selectively etched with mixed acid liquid of hydrochloric acid and nitric acid as etching liquid, so as to form the uppermost layer of the gate terminal GTM, the drain terminal DTM, and the second conductive layers of the opposed electrode terminals CTM1 and CTM2.

<<Display Panel PNL and Drive Circuit Board PCB1>>

FIG. 17 is a top view showing the state where a video signal drive circuit H and a vertical scanning circuit V have been connected to the display panel PNL shown in FIG. 7 and so on.

CHI designates a driver IC chip for driving the display panel PNL (the fives chips on the lower side are driver IC chips on the vertical scanning circuit side, and the every ten chips on the left side are driver IC chips on the video signal drive circuit side). TCP designates a tape carrier package on which the driver IC chip CHI is mounted by a tape automated bonding method (TAB), as will be described later in FIGS. 18 and 19. PCB1 designates a drive circuit board on which the TCP, capacitors, and so on are mounted, and which is divided into two parts for the video signal drive circuit and for the scanning signal drive circuit. FGP designates a frame ground pad, to which a spring-like fragment provided by cutting in a shield case SHD is soldered. FC designates a flat cable for electrically connecting the lower drive circuit board PCB1 and the left drive circuit board PCB1.

As illustrated in FIG. 17, a flat cable in which a plurality of lead wires (made of a phosphor bronze raw material plated with Sn) have been sandwiched and supported between a striped polyethylene layer and a polyvinyl alcohol layer is used as the flat cable FC.

<<Connection Structure of TCP>>

FIG. 18 is a diagram showing a sectional structure of the tape carrier package TCP in which the integrated circuit chip CHI constituting the scanning signal drive circuit V or the video signal drive circuit H has been mounted on a flexible wiring board. FIG. 19 is a main portion sectional view showing the state where the tape carrier package TCP has been connected to the scanning signal circuit terminal GTM of the liquid crystal display panel in this embodiment.

In FIGS. 18 and 19, TTB designates an input terminal/wiring portion of the integrated circuit CHI, and TTM designates an output terminal/wiring portion of the integrated circuit CHI. For example, the input and output terminal/wiring portions TTB and TTM are made of Cu. A bonding pad PAD of the integrated circuit CHI is connected to the inner leading ends (so-called “inner leads”) of the terminals TTB and TTM by a so-called face down bonding method respectively. The outer leading ends (so-called “outer leads”) of the terminals TTB and TTM are connected to a CRT/TFT converter/power supply circuit SUP by soldering or the like, and to the liquid crystal display panel PNL through an anisotropic conductive film ACF, respectively, correspondingly to the input and output of the semiconductor integrated circuit chip CHI. The package TCP is connected to the panel so that the leading end of the package TCP covers the protective film PSV from which the panel PNL side connection terminal GTM is exposed. That is, the external connection terminal GTM (DTM) is covered with at least one of the protective film PSV and the package TCP. Thus, the external connection terminal GTM (DTM) is improved in proof against electric erosion.

BF1 designates a base film made of polyimide or the like. SRS designates a solder resist film for masking to thereby prevent solder from adhering to unnecessary places at the time of soldering. The gap between the upper and lower glass substrates outside the seal pattern SL is protected by epoxy resin EPX or the like after cleaning. Further, silicon resin SIL is filled between the packages TCP and the upper substrate SUB2. Thus, protection is multiplied.

<<Drive Circuit Board PCB2>>

Electronic parts such as ICs, capacitors, resistors, etc. are mounted on the drive circuit board PCB2. The circuit SUP is mounted on the drive circuit board PCB2. The circuit SUP includes a power supply circuit for obtaining a plurality of stabilized voltage sources divided from one voltage source, and a circuit for converting information for a CRT (Cathode Ray Tube) from a host system (upper-rank operation system) into information for a TFT liquid crystal display unit. CJ designates a connector connection portion to which a not-shown connector to be connected to the outside is connected. The drive circuit substrates PCB1 and PCB2 are electrically connected through the flat cable FC.

<<Whole Configuration of Liquid Crystal Module>>

FIG. 20 is an exploded perspective view showing respective constituent parts of a liquid crystal display module MDL.

SHD designates a frame-like shield case (metal frame) made of a metal plate; LCW, a display window of the shield case SHD; PNL, a liquid crystal display panel; SPB, a light diffusion plate; LCB, a light guide plate; RM, a reflector; BL, a backlight fluorescent tube; and LCA, a backlight case. The respective members are laminated in the vertical arrangement relationship as illustrated in FIG. 20, and fabricated into a module MDL.

The module MDL is fixed as a whole by claws and hooks provided in the shield case SHD. The backlight case LCA has a shape to receive the backlight fluorescent tube BL, the light diffusion plate SPB,the light guide plate LCB, and the reflector RM. Light from the backlight fluorescent tube BL disposed on a side surface of the light guide plate LCB is made to emit from the liquid crystal display panel PNL so that backlight is formed uniformly on the display surface by the light guide plate LCB, the reflector RM and the light diffusion plate SPB.

An inverter circuit board PCB3 is connected to the backlight fluorescent tube BL. The inverter circuit board PCB3 provides a power supply for the backlight fluorescent tube BL. Incidentally, a so-called side backlight in which a fluorescent tube is disposed in a side surface of a light guide plate is used in this embodiment. However, a so-called direct backlight in which a fluorescent tube is disposed under a light diffusion plate may be used to increase luminance. As described above, in this embodiment, the ST electrode ST electrically connected to the pixel electrode is newly provided and formed on the protective film. In other words, the ST electrode ST is formed just under the alignment film so that spot-like black unevenness (nuclear stains) can be restrained from being generated when there is a protective film defect in a TFT-LCD in an IPS mode or an FFS mode. Particularly, in this embodiment, there is an effect that nuclear stains caused by protective film defects on the pixel electrodes PX, PX2 and PX3 and the source electrode SD1, and protective film defects on the opposed electrodes CT and CT2 and the opposed electrode signal line CL are eliminated substantially perfectly because the ST electrode ST is substantially equal in potential to the electrodes PX, PX2, PX3, SD1, CT and CT2 and the signal line CL (equal potential in DC component in the case of AC).

Further, in this embodiment, while nuclear stains are restrained, a new charging current is prevented from being generated in the protective film capacitance. As a result, ionic impurities are restrained from flowing so that indeterminate black unevenness can be also restrained from being produced. Similarly, by the same effect, it is possible to reduce, on a large scale, an after image (image persistence) which is a phenomenon that, when a fixed pattern is displayed for a long time, an end of the pattern turns black.

(Embodiment 2)

This embodiment is the same as Embodiment 1, except the following points.

FIG. 22 is a plan view showing one pixel in this embodiment. In addition, FIG. 23 shows a sectional view taken on line D-D′ in FIG. 22. In this embodiment, an ST electrode ST is connected to a part CT3 of an opposed electrode through a through hole TH. Therefore, the through hole TH in this embodiment is formed to have a bottom at a level equal to the conductive layer g3.

Differently from pixel electrodes, no voltage is given to each opposed electrode through a switching device, and a sufficient voltage is always applied to each opposed electrode from the outside. Therefore, charging from nuclear stains to protective film capacitance of each pixel is accelerated sufficiently. Thus, the time of a failure in display, such as lowering of the contrast ratio, production of flicker, or the like, in the condition that charging from the ST electrode ST is insufficient, for example, at an early stage of operation, or the like, is shortened on a large scale.

(Embodiment 3)

This embodiment is the same as Embodiment 1, except the following points.

FIG. 24 is a plan view showing one pixel in this embodiment. In addition, FIG. 25 shows a sectional view taken on line D-D′ in FIG. 24.

In this embodiment, an ST electrode ST is connected to a part DL3 of a video signal line through a through hole TH. Therefore, the through hole TH in this embodiment is formed to have a bottom at a level equal to the conductive layer d3.

The video signal line has higher potential in DC component than any other electrode or wire. Therefore, an anode-side oxidation reaction is suppressed perfectly, so that a disconnection failure which may be produced due to the dissolution of an electrode by an oxidation reaction is eliminated.

As described above, in this embodiment, there is an effect that small dark or white spots caused by a protective film defect on the video signal line DL are eliminated substantially perfectly because the video signal line DL is substantially equal in potential to the ST electrode ST (equal potential in DC component in the case of AC). In addition, a disconnection failure which may be produced after a current is fed to the video signal line is eliminated perfectly. Further, in the same manner as in Embodiment 1, ionic impurities are restrained from flowing so that indeterminate black unevenness can be also restrained from being produced. Similarly, by the same effect, it is possible to reduce, on a large scale, an after image (image persistence) which is a phenomenon that, when a fixed pattern is displayed for a long time, an end of the pattern turns black.

Further, differently from the pixel electrode, no voltage is given to the video signal line through a switching device, and a sufficient voltage is always applied to the video signal line from the outside. Therefore, charging from small dark or white spots to protective film capacitance of each pixel is accelerated sufficiently.

Although a cyano liquid crystal is used in this embodiment, it is more preferable that a fluorine liquid crystal is used so that a reduction reaction in the cathode can be restrained. Thus, only if anode-side potential is applied to the ST electrode ST, not only is it possible to restrain small dark or white spots on the anode side, but it is also possible to restrain small dark or white spots on the cathode side.

(Embodiment 4)

This embodiment is the same as Embodiment 1, except the following points.

FIGS. 26 and 27 are plan views showing one pixel and pixels on the periphery thereof in this embodiment. In addition, FIG. 28 shows a sectional view taken on line D-D′ in FIG. 26. In this embodiment, an ST electrode ST is connected to a part PX3 of a pixel electrode through a through hole TH. However, in this embodiment, the ST electrode ST is formed to overlap or protrude over a scanning signal line (gate line) GL2 in the preceding row. By such formation, auxiliary capacitance Cadd is formed in addition to the storage capacitance Cstg.

<<Function of Auxiliary Capacitance Cadd>>

The auxiliary capacitance Cadd is effective in storing video information written in the pixel (after the thin film transistor TFT has been turned OFF), for a long time, in the same manner as the storage capacitance Cstg. Particularly, when the storage capacitance Cstg is not provided, the auxiliary capacitance Cadd becomes an essential constituent.

In addition, the auxiliary capacitance Cadd operates to reduce the influence of the gate potential variation Δvg on the pixel electrode potential Vs in the same manner as the storage capacitance Cstg when the thin film transistor TFT performs switching. This aspect is expressed in the following expression.

ΔVs={Cgs/(Cgs+Cstg+Cadd+Cpix)}×Δvg

This variation ΔVs becomes a factor of a DC component applied to the liquid crystal LC. However,the more the retained capacitance Cadd is increased,the more the value of the variation ΔVs can be reduced. The reduction in the DC component applied to the liquid crystal LC can improve the life of the liquid crystal LC, and reduce so-called image persistence which is a phenomenon that a previous image is left behind when the liquid crystal display screen is switched over.

In the same manner as in Embodiment 1, the ST electrode ST in this embodiment has an effect to substantially perfectly eliminate small dark or white spots caused by a protective film defect on the pixel electrode or a protective film defect on the opposed electrodes or the opposed electrode signal line, because the ST electrode ST is equal in potential to the pixel electrode. In addition, even if there is a foreign substance on the gate line GL and there is a defect on the gate insulating film GI and the protective film PSV, the ST electrode ST has another effect to prevent or reduce the production of small dark or white spots.

This is because, even if there is a protective film defect on the gate line, the ST electrode ST surrounds the defect so that most of electric flux lines from the defect portion converge on the ST electrode ST. Thus, a charging current hardly flows into the protective film capacitance surrounding the ST electrode ST. On the other hand, ions in the liquid crystal are charged up to be minus in the defect portion, but the ions discharge electricity to the ST electrode ST surrounding the defect portion immediately. As a result, the minus ions are difficult to diffuse to the surrounding pixels. It is therefore possible to reduce both the size and the intensity of small dark or white spots on a large scale.

In addition, scanning wiring is coated with an electrode connected to the pixel electrode in this embodiment. Accordingly, even if the pixel electrode and the scanning signal line are short-circuited due to a foreign matter, a defect is limited to a spot defect. Thus, there is no fear that the yield is lowered.

As described above, in addition to the effects of Embodiment 1, there is an effect that nuclear stains caused by a protective film defect on the scanning signal line (gate line) GL are also reduced on a large scale. Thus, the time of a failure in display, such as lowering of the contrast ratio, production of flicker, or the like, in the condition that charging from the ST electrode ST is insufficient at an early stage of operation, or the like, is shortened on a large scale.

(Embodiment 5)

This embodiment is the same as Embodiments 1, 2 and 4, except the following points.

FIG. 29 is a plan view showing one pixel in this embodiment.

In this embodiment, an ST electrode ST is connected to a part CT3 of an opposed electrode through a through hole TH in the same manner as in Embodiment 2. In addition, the ST electrode ST is formed to overlap or protrude over a scanning signal line (gate line) GL2 in the preceding row in the same manner as in Embodiment 4.

Incidentally, in this embodiment, the auxiliary capacitance Cadd is not formed.

As described above, in this embodiment, the effects of Embodiments 1, 2 and 4 can be obtained.

(Embodiment 6)

This embodiment is the same as Embodiments 1, 3 and 4, except the following points.

FIG. 30 is a plan view showing one pixel in this embodiment. In this embodiment, an ST electrode ST is connected to a part DL3 of a video signal line through a through hole TH in the same manner as in Embodiment 3. In addition, the ST electrode ST is formed to overlap or protrude over a video signal line (gate line) DL2 in the preceding column in the same manner as in Embodiment 4. Incidentally, in this embodiment, the auxiliary capacitance Cadd is not formed.

As described above, in this embodiment, the effects of Embodiments 1, 3 and 4 can be obtained.

(Embodiment 7)

This embodiment is the same as Embodiment 1, except the following points.

FIG. 31 is a plan view showing one pixel in this embodiment. In this embodiment, ST electrodes ST are connected to parts of a pixel electrode through holes TH in the same manner as in Embodiment 1.

In this embodiment, two ST electrodes ST are provided to be disposed on sides of scanning signal lines GL respectively. As a result, it is possible to reduce small dark or white spots caused by protective film defects on the scanning signal lines in the same manner as in Embodiment 4. Thus, the time of a failure in display, such as lowering of the contrast ratio, production of flicker, or the like, in the condition that charging from the ST electrode ST is insufficient at a nearly stage of operation, or the like, is shortened on a large scale.

As described above, in this embodiment, the effects of Embodiments 1 and 4 can be obtained.

(Embodiment 8)

This embodiment is the same as Embodiments 1, 2 and 7, except the following points.

FIG. 32 is a plan view showing one pixel in this embodiment. In this embodiment, ST electrodes ST are connected to parts of the opposed electrodes through holes TH in the same manner as in Embodiment 2.

In this embodiment, two ST electrodes ST are provided to be disposed on sides of scanning signal lines GL respectively. As a result, it is possible to reduce small dark or white spots caused by protective film defects on the scanning signal lines in the same manner as in Embodiment 4. In addition, unnecessary electric fields from the scanning signal lines never give an influence to the display area. Thus, a failure in display, such as flicker, an after image, or the like, caused by a DC component due to the electric fields from the scanning signal lines is eliminated.

As described above, in this embodiment, the effects of Embodiments 1, 2 and 4 can be obtained.

(Embodiment 9)

This embodiment is the same as Embodiments 1 and 4, except the following points.

FIG. 33 is a plan view showing one pixel in this embodiment.

In this embodiment, an ST electrode ST is connected to a part of a pixel electrode through a through hole TH so as to overlap a scanning signal line in the preceding row in the same manner as in Embodiment 4.

In addition, in this embodiment, the storage capacitance Cstg is increased, and the parasitic capacitance Cgs of the thin film transistor device TFT is reduced. Thus, the feed through voltage ΔVs (shown in FIG. 13) when the thin film transistor TFT is switched OFF is reduced to be not higher than 1 V. As a result, the pixel electrode, the opposed electrodes and the video signal line are substantially equal in potential. Thus, by connecting the ST electrode ST only to the pixel electrode, a charging current caused by protective film defects on the pixel electrode, the opposed electrodes and the video signal line can be restrained from being generated, so that small dark or white spots can be restrained from being produced. A threshold voltage with which an electrode reaction is generated to produce a n small dark or white spot uclear stain is approximately in a range of from 0.5 V to 1 V. Although the value of the threshold voltage varies in accordance with the liquid crystal material and the electrode material, it is 1 V in accordance with the liquid crystal material and the electrode material used in this embodiment. Therefore, the storage capacitance Cstg and the parasitic capacitance Cgs of the thin film transistor TFT are set so that the feed through voltage Δvs becomes not higher than 1 V.

Incidentally, although the setting is done so that the feed through voltage ΔVs becomes not higher than 1 V in this embodiment, preferably, it is set to be not higher than 0.5 V in order not to depend on the materials.

As described above, in this embodiment, there is an effect that nuclear strains caused by protective film defects on the pixel electrodes PX, PX2 and PX3 and the source electrode SD1, protective film defects on the opposed electrodes CT and CT2 and the opposed electrode signal line CL, and protective film defects on the video signal line DL and the drain electrode SD2 are eliminated substantially perfectly, because the ST electrode ST is substantially equal in potential to the electrodes PX, PX2, PX3, SDI, CT, CT2 and SD2 and the signal lines CL and DL (equal potential in DC component in the case of AC). In addition, in the same manner as in Embodiment 4, there is another effect that small dark or white spots caused by a protective film defect on the scanning signal line (gate line) GL are also reduced on a large scale.

Further, in the same manner as in Embodiment 1, ionic impurities are restrained from flowing so that indeterminate black unevenness can be also restrained from being produced. Similarly, by the same effect, it is possible to reduce, on a large scale, an after image (image persistence) which is a phenomenon that, when a fixed pattern is displayed for a long time, an end of the pattern turns black.

(Embodiment 10)

This embodiment is the same as Embodiments 1, 5 and 9, except the following points.

In this embodiment, an ST electrode ST is connected to a part of an opposed electrode through a through hole TH so as to overlap a scanning signal line in the preceding row in the same manner as in Embodiment 5.

In addition, in this embodiment, in the same manner as in Embodiment 9, the storage capacitance Cstg is increased, and the parasitic capacitance Cgs of the thin film transistor device TFT is reduced. Thus, the feed through voltage ΔVs (shown in FIG. 13) when the thin film transistor TFT is switched OFF is reduced to be not higher than 1 V. As a result,the pixel electrode, the opposed electrodes and the video signal line have substantially equal potential in DC component. Thus, by connecting the ST electrode ST only to the opposed electrode, a charging current caused by a protective film defect on the pixel electrode, the opposed electrodes and the video signal line can be restrained from being generated, so that small dark or white spots can be restrained from being produced. A threshold voltage with which an electrode reaction is generated to produce a small dark or white spot is approximately in a range of from 0.5 V to 1 V. Although the value of the threshold voltage varies in accordance with the liquid crystal material and the electrode material, it is 1 V in accordance with the liquid crystal material and the electrode material used in this embodiment. Therefore, the storage capacitance Cstg and the parasitic capacitance Cgs of the thin film transistor TFT are set so that the feed through voltage ΔVs becomes not higher than 1 V.

Incidentally, although the setting is done so that the feed through voltage ΔVs becomes not higher than 1 V in this embodiment, preferably, it is set to be not higher than 0.5 V in order not to depend on the materials.

(Embodiment 11)

This embodiment is the same as Embodiments 1, 6 and 9, except the following points.

In this embodiment, an ST electrode ST is connected to a part of a video signal line through a through hole TH so as to overlap a scanning signal line in the preceding row in the same manner as in Embodiment 6. In addition,in this embodiment, in the same manner as in Embodiment 9, the storage capacitance Cstg is increased, and the parasitic capacitance Cgs of the thin film transistor device TFT is reduced. Thus, the feed through voltage Δvs (shown in FIG. 13) when the thin film transistor TFT is switched OFF is reduced to be not higher than 1 V. As a result, the pixel electrode, the opposed electrodes and the video signal line have substantially equal potential in DC component. Thus, by connecting the ST electrode ST only to the video signal line, a charging current caused by protective film defects on the pixel electrode, the opposed electrodes and the video signal line can be restrained from being generated, so that small dark or white spots can be restrained from being produced. A threshold voltage with which an electrode reaction is generated to produce a small dark or white spot is approximately in a range of from 0.5 V to 1 V. Although the value of the threshold voltage varies in accordance with the liquid crystal material and the electrode material, it is 1 V in accordance with the liquid crystal material and the electrode material used in this embodiment. Therefore, the storage capacitance Cstg and the parasitic capacitance Cgs of the thin film transistor TFT are set so that the feed through voltage ΔVs becomes not higher than 1 V.

Incidentally, although the setting is done so that the feed through voltage ΔVs becomes not higher than 1 V in this embodiment, preferably, it is set to be not higher than 0.5 V in order not to depend on the materials.

As described above, in this embodiment, in addition to the effects of Embodiment 9, the effects of Embodiment 3 can be obtained.

(Embodiment 12)

This embodiment is the same as Embodiment 4, except the following points.

FIG. 34 shows a driving waveform in this embodiment. In this embodiment, the scanning voltage Vg includes three-valued voltages. Of the three-valued voltages, one is a selective voltage which is a voltage for turning on the thin film transistor TFT, and the other two are voltages for keeping the thin film transistor TFT in an OFF state. In a scanning period, the thin film transistor TFT is turned ON, and a video signal is written in. After that, the thin film transistor TFT is lowered from Vgh to Vgl2. Thus, the thin film transistor TFT is brought into an OFF state. At this time, a feed through voltage ΔVs is generated so that the voltage with which the video signal was written in is shifted to the lower potential side. This feed through voltage Δvs varies slightly between the case where a signal of a positive pole has been written in and the case where a voltage of a negative pole has been written in. After that, after waiting for a scanning period (1H) so that the thin film transistor TFT comes into a thorough OFF state, the non-selective voltage of a scanning signal in the preceding row is lifted from Vgl2 up to Vgl1. At this time, a voltage Δvs' bursts into the pixel electrode voltage through the auxiliary capacitance Cadd so that the pixel electrode voltage is shifted to the higher voltage side again. The voltages Vgl1 and Vgl2 and the auxiliary capacitance Cadd are made proper and the voltage ΔVs' is made proper with respect to the feed through voltage ΔVs, so that the potential of the pixel electrode voltage in DC component, the opposed voltage and the potential of the video signal line potential in DC component can made equal to one another substantially.

The feed through voltage ΔVs and the voltage ΔVs' are defined as the following expression.

Here, Cgs(on) designates a gate-source parasitic capacitance when the thin film transistor TFT is turned ON, and Cgs(off) designates a gate-source parasitic capacitance when the thin film transistor TFT is turned OFF.

Thus, by connecting the ST electrode ST only to one of the pixel electrode, the opposed electrodes, and the video signal line, a charging current caused by protective film defects on the pixel electrode, the opposed electrodes and the video signal line can be restrained from being generated, so that small dark or white spots can be restrained from being produced.

Although the ST electrode ST is connected to the pixel electrode in this embodiment, a similar effect can be obtained if it is connected to the opposed electrode.

As described above, in this embodiment, there is an effect that nuclear strains caused by protective film defects on the pixel electrodes PX, PX2 and PX3 and the source electrode SD1, and protective film defects on the opposed electrodes CT and CT2 and the opposed electrode signal line CL, and protective film defects on the video signal line DL and the drain electrode SD2 are eliminated substantially perfectly, because the ST electrode ST is substantially equal in potential to the electrodes PX, PX2, PX3, SD1, CT, CT2 and SD2, and the signal lines CL and DL (equal potential in DC component in the case of AC). In addition, in the same manner as in Embodiment 4, there is another effect that nuclear stains caused by a protective film defect on the scanning signal line (gate line) GL are also reduced on a large scale. In addition, because an unnecessary electric field from a scanning electrode never gives an influence to the display area. Thus, the time of a failure in display, such as lowering of the contrast ratio, production of flicker, or the like, in the condition that charging from the ST electrode ST is insufficient at an early stage of operation, or the like, is shortened on a large scale.

Further, in this embodiment, ionic impurities are restrained from flowing so that indeterminate black unevenness can be also restrained from being produced. Similarly, by the same effect, it is possible to reduce, on a large scale, an after image (image persistence) which is a phenomenon that, when a fixed pattern is displayed for a long time, an end of the pattern turns black.

(Embodiment 13)

This embodiment is the same as Embodiment 1, except the following points.

FIG. 35 is a plan view showing one pixel in this embodiment. In this embodiment, an ST electrode ST is designed to be connected to a part of a pixel electrode through a through hole TH so as to overlap a video signal line. Although the ST electrode ST is made to overlap the corresponding video signal line in this embodiment, it may be made to overlap a video signal line in the next (adjacent) column.

In the same manner as in Embodiment 1, the ST electrode ST in the embodiment has an effect to substantially perfectly eliminate small dark or white spots caused by a protective film defect on the pixel electrode or a protective film defect on the opposed electrodes or the opposed electrode signal line, because the ST electrode ST is equal in potential to the pixel electrode. In addition, even if there is a foreign matter on the video signal line DL and there is a defect on the protective film PSV, the ST electrode ST has another effect to prevent or reduce the production of small dark or white spots.

This is because, even if there is a protective film defect on the video signal line DL, the ST electrode ST surrounds the defect so that most of electric flux lines generated from the defect portion converge on the ST electrode ST. Thus, a charging current hardly flows into the protective film capacitance surrounding the defect portion. On the other hand, although ions in the liquid crystal are charged up to be plus in the defect portion, the ions immediately discharge electricity to the surrounding ST electrode ST. As a result, the plus ions are difficult to the surrounding pixels. It is therefore possible to reduce both the size and the intensity of small dark or white spots on a large scale. In addition, the video signal line is coated with an electrode connected to the pixel electrode in this embodiment, so that, even if the pixel electrode and the video signal line are short-circuited due to a foreign matter, a defect is limited to a spot defect. Thus, there is no fear that the yield is lowered.

As described above, in addition to the effects of Embodiment 1, there is an effect that nuclear stains caused by a protective film defect on the video signal line (drain line) DL are also reduced on a large scale.

(Embodiment 14)

This embodiment is the same as Embodiment 1, except the following points.

FIG. 36 is a plan view showing one pixel in this embodiment. In this embodiment, an ST electrode ST is designed to be connected to a part of an opposed electrode through a through hole TH so as to overlap an adjacent video signal line. Although the ST electrode ST is made to overlap the video signal line in the adjacent (next) column, it may be made to overlap the corresponding video signal line in its own column.

In the same manner as in Embodiment 13, the ST electrode ST in the embodiment has an effect to substantially perfectly eliminate small dark or white spots small dark or white spots caused by a protective film defect on the pixel electrode or a protective film defect on the opposed electrodes or the opposed electrode signal line, because the ST electrode ST is equal in potential to the opposed electrode. In addition, even if there is a foreign matter on the video signal line DL and there is a defect on the protective film PSV, the ST electrode ST has another effect to prevent or reduce the production of small dark or white spots.

In addition, in this embodiment, since the drain line (video signal line) DL is coated with the opposed electrodes, an unnecessary electric field from the video signal line is cut off so that a phenomenon (vertical smear, crosstalk) that a streak is drawn vertically due to the unnecessary electric field can be eliminated.

(Embodiment 15)

This embodiment is the same as Embodiment 1, except the following points.

FIG. 37 is a plan view showing one pixel in this embodiment. In this embodiment, an ST electrode ST1 is connected to a part of a pixel electrode through a through hole TH so as to overlap the corresponding video signal line in its own column, and an ST electrode ST2 is connected to another part of the pixel electrode through another through hole TH so as to overlap a scanning signal line in the adjacent row. Although the ST electrode ST1 is made to overlap the video signal line in its own column in this embodiment, it may be made to overlap an adjacent (next-column) video signal line.

The ST electrodes ST1 and ST2 in this embodiment have an effect to substantially perfectly eliminate small dark or white spots caused by a protective film defect on the pixel electrode or a protective film defect on the opposed electrodes or the opposed electrode signal line, because the ST electrodes ST1 and ST2 are equal in potential to the pixel electrode. In addition, even if there are foreign matters on the video signal line DL and the scanning signal line GL and there are defects on the gate insulating film GI and the protective film PSV, the ST electrodes ST1 and ST2 have another an effect to prevent or reduce the production of small dark or white spots.

As described above, in this embodiment, there is an effect that small dark or white spots can be restrained even if there are PSV defects (protective film defects) on all the electrodes. Further, in this embodiment, in the same manner as in Embodiment 1, small dark or white spots are restrained while a new charging current is prevented from being generated in the protective film capacitance. As a result, there is an effect that ionic impurities are restrained from flowing so that indeterminate black unevenness can be also restrained from being produced. Similarly, by the same effect, there is another effect that it is possible to reduce, on a large scale, an after image (image persistence) which is a phenomenon that, when a fixed pattern is displayed for a long time, an end of the pattern turns b lack. Thus, the time of a failure in display, such as lowering of the contrast ratio, production of flicker, or the like, in the condition that charging from the ST electrode ST is insufficient at an early stage of operation, or the like, is shortened on a large scale.

(Embodiment 16)

This embodiment is the same as Embodiment 1, except the following points.

FIG. 38 is a plan view showing one pixel in this embodiment. In this embodiment, an ST electrode ST1 is connected to a part of an opposed electrode through a through hole TH so as to overlap a next-column video signal line, and an ST electrode ST2 is connected to a part of another opposed electrode through another through hole TH so as to overlap a next-row scanning signal line. Although the ST electrode ST1 is made to overlap the adjacent (next-column) video signal line in this embodiment, it may be made to overlap the corresponding video signal line in its own column. The ST electrodes ST1 and ST2 in this embodiment have an effect to substantially perfectly eliminate small dark or white spots caused by a protective film defect on the pixel electrode or a protective film defect on the opposed electrodes or the opposed electrode signal line, because the ST electrodes ST1 and ST2 are equal in potential to the opposed electrodes. In addition, even if there are foreign matters on the video signal line DL and the scanning signal line GL and there are defects on the gate insulating film GI and the protective film PSV, the ST electrodes ST1 and ST2 have another effect to prevent or reduce the production of small dark or white spots.

In addition, in this embodiment, since the drain line (video signal line) DL is coated with an opposed electrodes, an unnecessary electric field from the video signal line is cut off by the opposite electrodes so that a phenomenon (vertical smear, crosstalk) that a streak is drawn vertically due to the unnecessary electric field can be eliminated.

(Embodiment 17)

This embodiment is the same as Embodiment 1, except the following points.

FIG. 39 is a plan view showing one pixel in this embodiment. In this embodiment, an ST electrode ST1 is connected to a part of an opposed electrode through a through hole TH so as to overlap a next-column (adjacent) video signal line, and an ST electrode ST2 is connected to a part of a pixel electrode through another through hole TH so as to overlap a next-row scanning signal line. Although the ST electrode ST1 is made to overlap the adjacent (next-column) video signal line in this embodiment, it may be made to overlap the corresponding video signal line in its own column.

Although the ST electrode ST2 to be made to overlap the scanning signal line may be made to overlap the opposed electrode while the ST electrode ST1 to be made to overlap the video signal line is made to overlap the video signal line, it is preferable that the ST electrode ST made to overlap the video signal line is connected to the opposed electrode in order to restrain vertical smear.

The ST electrodes ST1 and ST2 in this embodiment have an effect to substantially perfectly eliminate small dark or white spots caused by a protective film defect on the pixel electrode or a protective film defect on the opposed electrodes or the opposed electrode signal line, because the ST electrodes ST1 and ST2 are equal in potential to the pixel electrode and the opposed electrodes (the pixel electrode in DC component has substantially equal potential to the opposed electrodes). In addition, even if there are foreign matters on the video signal line DL and the scanning signal line GL and there are defects on the gate insulating film GI and the protective film PSV, the ST electrodes ST1 and ST2 have another effect to prevent or reduce the production of small dark or white spots.

In addition, in this embodiment, since the drain line (video signal line) DL is coated with an opposed electrodes, an unnecessary electric field from the video signal line is cut off by the opposed electrodes so that a phenomenon (vertical smear, crosstalk) that a streak is drawn vertically due to the unnecessary electric field can be eliminated.

(Embodiment 18)

This embodiment is the same as Embodiments 1 and 4, except the following points.

FIG. 40 is a plan view showing one pixel in this embodiment. In this embodiment, an ST electrode ST is connected to parts of opposed electrodes through holes TH so as to overlap the corresponding scanning signal line, the corresponding video signal line and the corresponding thin film transistor TFT. Thus, the ST electrode ST is formed all over the area except the display area defined by the pixel electrode and the opposed electrodes.

The ST electrode ST in this embodiment has an effect to substantially perfectly eliminate small dark or white spots caused by a protective film defect on the pixel electrode or a protective film defect on the opposed electrodes or the opposed electrode signal line, because the ST electrode ST is equal in potential to the opposed electrodes. In addition, even if there are foreign matters on the thin film transistor TFT, the video signal line DL and the scanning signal line GL and there are defects on the gate insulating film GI and the protective film PSV, the ST electrode ST has another effect to prevent or reduce the production of small dark or white spots.

As described above, in this embodiment, the effects of Embodiment 16 can be obtained. In addition, it is preferable that an organic protective film of acrylic resin, polyimide, or the like, is used to reduce the capacitance between each wiring and the ST electrode ST. Thus, dullness in the signal waveforms of scanning signals and video signals is reduced.

(Embodiment 19)

This embodiment is the same as Embodiments 1 and 4, except the following points.

FIG. 41 is a plan view showing one pixel in this embodiment. In this embodiment, an ST electrode ST is connected to a part of a source electrode through a through hole TH so as to be used also for a pixel electrode. In this embodiment, since the ST electrode ST is formed of a transparent conductive film ITO, transmitted light in the electrode portion contributes to improvement in transmissivity. In addition, since the liquid crystal in the display area is driven by the uppermost ST electrode ST, a voltage divided into the protective film is low so that the maximum transmissivity can be obtained with a low voltage. In other words, the liquid crystal can be driven with a low voltage. The ST electrode ST in this embodiment has an effect to substantially perfectly eliminate small dark or white spots caused by a protective film defect on the pixel electrode or a protective film defect on the opposed electrodes or the opposed electrode signal line, because the ST electrode ST is equal in potential to the pixel electrode.

As described above, in this embodiment, in addition to the effects of Embodiment 4, there are obtained an effect that the transmissivity is improved and an effect that the voltage can be reduced.

In addition, a shield electrode SD3 prevents the influence of an electric field from the scanning wire from entering the display area. The opposed electrode signal line is made adjacent to the scanning signal line so that the influence of the electric field from a scanning wire in the preceding row is prevented from entering the display area.

(Embodiment 20)

This embodiment is the same as Embodiments 1 and 5, except the following points.

In this embodiment, an ST electrode ST is connected to a part of an opposed electrode signal line CL through a through hole TH so as to be used also for an opposed electrode. In this embodiment, since the ST electrode ST is formed of a transparent conductive film ITO, transmitted light in the electrode portion contributes to improvement in transmissivity. In addition, since the liquid crystal in the display area is driven by the uppermost ST electrode ST, a voltage divided into the protective film is low so that the maximum transmissivity can be obtained with a low voltage. In other words, the liquid crystal can be driven with a low voltage. The ST electrode ST in the embodiment has an effect to substantially perfectly eliminate small dark or white spots caused by a protective film defect on the pixel electrode or a protective film defect on the opposed electrodes or the opposed electrode signal line, because the ST electrode ST is equal in potential to the opposed electrodes.

As described above, in this embodiment, in addition to the effects of Embodiment 5, there are obtained an effect that the transmissivity is improved and an effect that the voltage can be reduced.

(Embodiment 21)

This embodiment is the same as Embodiments 1 and 20, except the following points.

In this embodiment, one of ST electrodes ST is connected to a part of an opposed electrode signal line CL through a through hole TH so as to be used also for an opposed electrode. The other ST electrode ST is connected to a part of a source electrode through another through hole TH so as to be used also for a pixel electrode. In this embodiment, since the ST electrodes ST are formed of a transparent conductive film ITO, transmitted light in the electrode portion contributes to improvement in transmissivity. In addition, since the liquid crystal in the display area is driven by the uppermost ST electrodes ST, a voltage divided into the protective film is low so that the maximum transmissivity can be obtained with a low voltage. In other words, the liquid crystal can be driven with a low voltage.

In this embodiment, there is an effect that small dark or white spots caused by a protective film defect on the pixel electrode or a protective film defect on the opposed electrodes or the opposed electrode signal line are eliminated substantially perfectly because the ST electrodes ST in this embodiment are equal in potential to the opposed electrodes.

As described above, in this embodiment, in addition to the effects of Embodiment 20, there are obtained an effect that the transmissivity is improved and an effect that the voltage can be reduced.

(Embodiment 22)

This embodiment is the same as Embodiment 1, except the following points.

FIG. 42 is a plan view showing one pixel in this embodiment. In this embodiment, an ST electrode ST is connected to a part of a pixel electrode through a through hole TH so as to overlap the corresponding video signal line in its own column partially and overlap a video signal line in the next (adjacent) column partially. In this embodiment, there is an effect that nuclear strains caused by a protective film defect on the pixel electrode or a protective film defect on the opposed electrodes or the opposed electrode signal line are eliminated substantially perfectly because the ST electrode ST in this embodiment is equal in potential to the pixel electrode in the same manner as in Embodiment 1. In addition, there is an effect that, even if there is a foreign matter on the video signal line DL and there is a defect on the protective film PSV, the production of small dark or white spots is prevented or reduced.

In addition, the video signal line is coated with the electrode connected to the pixel electrode in this embodiment. Accordingly, even if the pixel electrode and the video signal line are short-circuited due to a foreign matter, a defect is limited to a spot defect. Thus, there is no fear that the yield is lowered.

In this embodiment, the ST electrode ST is shaped to overlap the drain lines (video signal lines) DL like a crossed belt. Accordingly, if column reversal driving, in which the polarity of a signal to be applied is reversed every column, or dot reversal driving is used, electrode fluctuations caused by capacitive coupling between the ST electrode ST and respective video signal lines compensate one another, so that there is little change in the potential of the ST electrode ST. Thus, the phenomenon (vertical smear, crosstalk) that a streak is drawn vertically due to such capacitive coupling can be restrained.

As described above, in this embodiment, there is an effect that small dark or white spots caused by a protective film defect on the video signal line (drain line) DL are also reduced on a large scale. In addition, there is an effect that vertical crosstalk is eliminated.

(Embodiment 23)

This embodiment is the same as Embodiment 1, except the following points.

FIG. 43 is a plan view showing one pixel and its periphery in this embodiment. In addition, FIG. 44 shows a sectional view taken on line E-E′ in FIG. 43. In addition, FIG. 45 shows a connection portion between an ST electrode ST and a video signal line in the vicinity of the lower side (outside the qualified display area) of FIG. 7. In this embodiment, the ST electrode ST is connected to a part of the video signal line through a through hole TH in a portion outside the qualified display area. As shown in FIGS. 43 and 44, the ST electrode ST has a linear shape, which is provided on the video signal line and in parallel with the video signal line so as to extend vertically. The connection portion shown in FIG. 45 is vertically provided outside the qualified display areas above and below the video signal line. Thus, even if the video signal line DL is disconnected at one place, the disconnected video signal line is kept in an electrically connected state by the ST electrode ST. In other words, the ST electrode ST forms a redundant structure against a disconnection failure of the video signal line.

In the same manner as in Embodiment 3, the video signal line has higher potential in DC component than any other electrode or wire. Therefore, an anode-side oxidation reaction is restrained perfectly so that a disconnection failure produced by dissolution of an electrode due to an oxidation reaction is eliminated. However,when the wire gets over a crossover portion with a scanning wire or an opposed electrode signal line, the wire may be disconnected in the step of the crossover portion. In this embodiment, there is an effect against such disconnection, so that the disconnection of the video signal line can be almost eliminated.

As described above, in this embodiment, in addition to the effects of Embodiment 3, there is obtained an effect that the yield is improved further.

(Embodiment 24)

This embodiment is the same as Embodiment 1, except the following points.

FIG. 46 is a plan view showing one pixel and its periphery in this embodiment. In addition, FIG. 47 shows a sectional view taken on line F-F′ in FIG. 46. In this embodiment, an ST electrode ST is connected to a part of a video signal line through a through hole TH in a portion of the qualified display area. As shown in FIG. 46, the ST electrode is provided on the video signal line and in parallel with the video signal line so as to extend vertically. Consequently, unless the video signal line DL is disconnected at two or more places in one pixel, even if the video signal lines are disconnected at a plurality of places, the disconnected video signal lines are kept in an electrically connected state by the ST electrodes ST. In other words, the ST electrode ST forms a redundant structure against a disconnection failure of the video signal line.

In the same manner as in Embodiment 3, the video signal line has higher potential in DC component than any other electrode or wire. Therefore, an anode-side oxidation reaction is restrained perfectly so that a disconnection failure produced by dissolution of an electrode due to an oxidation reaction is eliminated. However, when the wire gets over a crossover portion with a scanning wire or an opposed electrode signal line, the wire may be disconnected in the step of the crossover portion. This embodiment is more effective in such disconnection than Embodiment 23, so that the disconnection of the video signal line can be perfectly eliminated.

As described above, in this embodiment, in addition to the effects of Embodiment 3, there is obtained an effect that the yield is improved further.

(Embodiment 25)

This embodiment is the same as Embodiment 1, except the following points.

FIG. 48 is a plan view showing one pixel in this embodiment. In this embodiment, an ST electrode ST is connected to a part of a scanning signal line through a through hole TH. Therefore, the through hole TH in this embodiment is formed to have a bottom at a level equal to the conductive layer g3.

The scanning signal line has lower potential in DC component than any other electrode or wire. Therefore, a cathode-side reduction reaction is restrained perfectly so that the production of liquid crystal decomposition caused by such a reduction reaction is eliminated.

As described above, in this embodiment, there is an effect that small dark or white spots caused by a protective film defect on the scanning signal line GL are eliminated substantially perfectly because the scanning signal line GL is substantially equal in potential as the ST electrode ST (equal potential in DC component in the case of AC). Further, in the same manner as Embodiment 1, ionic impurities are restrained from flowing so that indeterminate black unevenness can be also restrained from being produced. Similarly, by the same effect, it is possible to reduce, on a large scale, an after image (image persistence) which is a phenomenon that, when a fixed pattern is displayed for a long time, an end of the pattern turns black. Particularly, no voltage is given to the video signal line through a switching device, differently from the pixel electrode, and a sufficient voltage is always applied to the video signal line from the outside. Therefore, charging from nuclear stains to protective film capacitance of each pixel is accelerated sufficiently. Thus, the time in a display failure state, such as lowering of the contrast ratio, production of flicker, or the like, in the condition that charging from the ST electrode ST is insufficient at an early stage of operation, or the like, is shortened largely.

(Embodiment 26)

This embodiment is the same as Embodiment 1, except the following points.

FIG. 49 is a plan view showing one pixel in this embodiment. In this embodiment, an ST electrode ST1 is connected to a part of a pixel electrode through a through hole TH, and an ST electrode ST2 is connected to a part of a scanning signal line through another through hole TH. Both the anode-side electrode and the cathode-side electrode are formed on the protective film so that charging with an anode-side voltage and charging with a cathode-side voltage are performed simultaneously. Even if the electrodes are exposed due to protective film defects generated in other portions, a charging current is hardly generated from the exposed portions. Therefore, no electrode reaction arises either on the anode side or on the cathode side, so that no small dark or white spot is produced. Incidentally, in this embodiment, the potential of the DC component of the video signal line is higher than the potential of the DC component of the pixel electrode. Therefore, if there is a protective film defect on the video signal line, an anode-side oxidation reaction occurs to produce a small dark or white spot

In this embodiment, a straight line connecting the centers of the ST electrodes ST1 and ST1 with each other is made to be identical with the rubbing direction RDR substantially. Specifically, an angle φ between the straight line connecting the centers of the ST electrodes ST1 and ST1 and the rubbing direction RDR is set to be within ±20, precisely within ±20.5°. This reason will be described as follows. To keep a contrast ratio of 30 or more, the rotation angle of the liquid crystal driven between the ST electrodes ST1 and ST2 is within ±10°, precisely within ±10.5°. In addition, if the angle between an electric field and the major axis of each liquid crystal molecule reaches 10° or more,extremely large energy is required for the liquid crystal to rotate further. Then, the liquid crystal cannot rotate with a DC voltage of 20 V or lower. The above-mentioned value of the angle φ is a total value of these values. Incidentally, it is preferable that the angle φ is set to be within ±15°, precisely within ±15.7° in order to keep a contrast ratio of 100 or more. When an angle φ or φ′ between the rubbing direction and a straight line connecting the ST electrode ST2 and an ST electrode ST1 (including an ST electrode ST1 other than the closest one) is not within the above-mentioned range, a distance L between the ST electrodes ST1 and ST2 is set to be sufficiently longer than the distance between the pixel electrode and the opposed electrode. Specifically, setting is done so that the electric field based on the DC component between the ST electrodes ST1 and ST2 is lower than an optical threshold electric field of the liquid crystal driven by the voltage between the pixel electrode and the opposed electrode.

In this embodiment, the angle between the straight line connecting the centers of the ST electrodes ST1 and ST2 and the rubbing direction is defined. However, the above-mentioned values may be applied to the angle between the straight line connecting ends of the ST electrodes ST1 and ST2 and the rubbing direction if the shapes of the ST electrodes ST1 and ST2 are slender, not circular or not square.

As described above, in this embodiment, both the ST electrode ST1 connected to the pixel electrode and the ST electrode ST2 connected to the scanning signal line are formed on the protective film. Accordingly, there is an effect that small dark or white spots caused by protective film defects on the pixel electrodes PX, PX2 and PX3 and the source electrode SD1, protective film defects on the opposed electrodes CT and CT2 and the opposed electrode signal line CL, and a protective film defect on the scanning signal line GL are substantially perfectly eliminated, because the electrodes PX, PX2, PX3, SD1, CT and CT2 and the signal lines CL and GL are substantially equal in potential to the ST electrodes ST1 and ST2 (equal potential in DC component in the case of AC). In addition, in combination with one or both of Embodiments 10 and 12, small dark or white spots on the video signal line DL are also eliminated in the embodiment.

(Embodiment 27)

This embodiment is the same as Embodiments 1 and 26, except the following points.

FIG. 50 is a plan view showing one pixel in this embodiment. In this embodiment, an ST electrode ST1 is connected to a part of an opposed electrode signal line through a through hole TH, and an ST electrode ST2 is connected to a part of a scanning signal line through another through hole TH.

As described above, in this embodiment, both the ST electrode ST1 connected to the opposed electrode signal line and the ST electrode ST2 connected to the scanning signal line are formed on a protective film. Accordingly, there is an effect that small dark or white spots caused by protective film defects on the pixel electrodes PX, PX2 and PX3 and the source electrode SD1, protective film defects on the opposed electrodes CT and CT2 and the opposed electrode signal line CL, and a protective film defect on the scanning signal line GL are substantially perfectly eliminated, because the electrodes PX, PX2, PX3, SD1, CT and CT2 and the signal lines CL and GL are substantially equal in potential to the ST electrodes ST1 and ST2 (equal potential in DC component in the case of AC). In addition, in combination with one or both of Embodiments 10 and 12, small dark or white spots on the video signal line DL are also eliminated in this embodiment.

(Embodiment 28)

This embodiment is the same as Embodiments 1 and 26, except the following points.

FIG. 51 is a plan view showing one pixel in this embodiment. In this embodiment, an ST electrode ST1 is connected to a part of a video signal line through a through hole TH, and an ST electrode ST2 is connected to a part of a scanning signal line through another through hole TH.

In this embodiment, the anode-side ST electrode ST1 is connected to the video signal line DL having the highest potential, while the cathode-side ST electrode ST2 is connected to the scanning signal line GL having the lowest potential. As a result, all of electrodes and wires are charged with the cathode or anode potential so that a charging current is hardly generated in any electrode having intermediate potential between the cathode and anode potentials. Thus, even if there are protective film defects on all the electrodes and wires, no small dark or white spot is produced.

As described above, in this embodiment, both the ST electrode ST1 connected to the video signal line and the ST electrode ST2 connected to the scanning signal line are formed on a protective film. Accordingly, without having any combination with Embodiment 10 or 12, nuclear stains caused by protective film defects on the pixel electrodes PX, PX2 and PX3, the source electrode SD1, the opposed electrodes CT and CT2, the opposed electrode signal line CL, the scanning signal line GL, and the video signal line DL are eliminated, because all the electrodes and signal lines are either substantially equal in potential to the ST electrode ST1 or ST2 (equal potential in DC component in the case of AC) or intermediate in potential between the ST electrodes ST1 and ST2.

(Embodiment 29)

This embodiment is the same as Embodiment 1, except the following points.

FIG. 52 is a plan view showing one pixel in this embodiment. In this embodiment, a pixel electrode PX and opposed electrodes CT and CT2 are formed into chevron electrodes respectively. As a result, liquid crystal molecules have two rotation directions, and optical properties of the liquid crystal molecules in areas having different rotation directions compensate each other so that a wider viewing angle can be obtained. That is, there is a difference in variation of retardation between the major axis direction and the minor axis direction of liquid crystal molecules when the elevation angle is inclined. If there is only one rotation direction, the retardation becomes small in some fixed direction so as to cause bluish coloring. On the contrary, the retardation becomes large in a direction perpendicular to the fixed direction, so as to cause yellowish coloring. When areas rotating the liquid crystal molecules in opposite directions with each other are provided, such coloring can be eliminated by use of the complementary color relationship of blue and yellow. At the same time, tone reversal in a low tone (dark tone) can be also restrained.

Although it is preferable that angles θ1 and θ2 of the chevron shape with respect to the rubbing direction are equal to each other, they may be not equal. In addition, the bending number of the chevron shape is shown by way of example.

In this embodiment, in addition to the effects of Embodiment 1, a wide viewing angle can be obtained.

(Embodiment 30)

This embodiment is the same as Embodiment 4, except the following point. FIG. 53 is a plan view showing one pixel in this embodiment. This embodiment is a combination of Embodiments 4 and 29.

(Embodiment 31)

This embodiment is the same as Embodiment 18, except the following point. FIG. 54 is a plan view showing one pixel in this embodiment. This embodiment is a combination of Embodiments 18 and 29.

(Embodiment 32)

This embodiment is the same as Embodiment 19, except the following point. FIG. 55 is a plan view showing one pixel in this embodiment. This embodiment is a combination of Embodiments 19 and 29.

(Embodiment 33)

This embodiment is the same as Embodiment 24, except the following point. FIG. 56 is a plan view showing one pixel in this embodiment. This embodiment is a combination of Embodiments 24 and 29.

(Embodiment 34)

This embodiment is the same as Embodiment 26, except the following point. FIG. 57 is a plan view showing one pixel in this embodiment. This embodiment is a combination of Embodiments 26 and 29.

(Embodiment 35)

This embodiment is the same as Embodiment 28, except the following point. FIG. 58 is a plan view showing one pixel in this embodiment. This embodiment is a combination of Embodiments 28 and 29.

(Embodiment 36)

This embodiment is the same as Embodiment 34, except the following points. FIG. 59 is a plan view showing one pixel in this embodiment. In this embodiment, an ST electrode ST1 is formed on a scanning signal line so as to be linear in parallel therewith. In addition, an ST electrode ST2 is connected to a pixel electrode and formed into a slender shape parallel with the ST electrode ST1.

Consequently, the electric field direction of the electric field between the ST electrodes ST1 and ST2 becomes identical in most of portions so that the angle with the rubbing direction can be made conformable in most of portions. Therefore, since there is no fear that the liquid crystal is driven by this electric field, an extremely high contrast ratio can be obtained. In addition, the scanning signal line is connected among a plurality of pixels through the ST electrode ST1. Accordingly, the ST electrode ST1 forms a redundant structure, and a disconnection failure in the scanning signal line is reduced.

As described above, in this embodiment, in addition to the effects of Embodiment 34, there is obtained an effect that a high contrast ratio is obtained, and the yield is improved. In addition, the ST electrode ST2 may be connected to an opposed electrode signal line and formed into a linear shape parallel with the opposed electrode signal line. In this case, it is also possible to reduce a disconnection failure in the opposed electrode signal line.

(Embodiment 37)

This embodiment is the same as Embodiment 1, except the following points. FIG. 60 is a plan view showing one pixel in this embodiment. In this embodiment, an ST electrode ST is provided just under an alignment film on a flattening film OC on a color filter side substrate SUB2. In addition, in plan, the ST electrode ST is made to overlap a video signal line and a scanning signal line.

In this embodiment, an opposed voltage is supplied to this ST electrode ST from a circumferential portion outside a qualified display area. Here, the structure of a TFT side substrate SUB1 is left the same as that in the conventional example.

In a TFT-LCD in an IPS mode, ITO has to be formed all over the back side of the color filter side substrate in order to reduce occurrence of a display failure caused by static electricity. In this embodiment, the ST electrode ST plays the role of ITO. Therefore, the ITO on the back surface is not required. As described above, in this embodiment, in addition to the effects of Embodiment 2, the step of forming the color filter side substrate can be simplified. Incidentally, although the ST electrode ST is provided on the flattening film in this embodiment, it may be formed on a color filter FIL but just under the alignment film if there is no flattening film.

(Embodiment 38)

This embodiment is the same as Embodiments 1 and 26, except the following points.

FIG. 61 is a plan view showing one pixel in this embodiment.

In this invention, an ST electrode ST1 is connected to a part of a scanning signal line through a through hole TH, and an ST electrode ST2 is provided just under an alignment film but on a flattening film OC on a color filter side substrate SUB2. In plan, in FIG. 61, the ST electrode ST2 is formed into a linear shape to overlap the scanning signal line. However, the ST electrode ST2 may be formed into a matrix to overlap the scanning signal line and a video signal line. In this embodiment, an opposed voltage is supplied to this ST electrode ST2 from a circumferential portion outside a qualified display area.

In this embodiment, since the ST electrodes ST1 and ST2 are formed on different substrates, a short-circuit failure caused by an etching failure or the like in an electrode formation step is inevitably eliminated. In addition, the ST electrodes ST1 and ST2 can be formed to overlap each other in plan. Thus, an electric field parallel with the substrate surface is hardly generated, and there is no fear that the liquid crystal between the pixel electrode and the opposed electrodes is driven by such an electric field. It is therefore possible to obtain a high contrast ratio.

As described above, in this embodiment, both the ST electrode ST1 connected to the scanning signal line and the ST electrode ST2 connected to the opposed electrode obtains not only the effects of Embodiment 27 but also an effect that occurrence of a short-circuit failure between the ST electrodes ST1 and ST2 is reduced. In addition, there is also obtained an effect that properties with a higher contrast ratio are obtained.

(Embodiment 39) Gate-Common Shield

This embodiment is the same as Embodiment 25, except the following points.

FIG. 62 is a plan view showing one pixel in this embodiment. In this embodiment, an ST electrode ST is connected to a part of a scanning signal line through a through hole TH.

The scanning signal line has lower potential in DC component than any other electrode or wire. Therefore, in the same manner as in Embodiment 25, a cathode-side reduction reaction is restrained so that the production of liquid crystal decomposition caused by such a reduction reaction is eliminated.

In this embodiment, SLD electrodes SLD (these SLD electrodes are occasionally referred to as “second electrodes” in this specification) connected to the opposed electrodes through holes (contact holes) TH are disposed on opposite sides of the ST electrode connected to the scanning signal line. Thus, the potential of the ST electrode is shielded not to enter the display area. In other words, SLD electrodes for preventing the potential of the ST electrode from entering an active area are disposed between the ST electrode and the active area and between the ST electrode and an adjacent area. Here, the active area means an area where the liquid crystal operates to contribute to display. The active area corresponds to an aperture portion of a black matrix BM. The area between the ST electrode and the active area designates the area between the ST electrode and the aperture portion of the black matrix BM. In addition, as shown in this embodiment, parts of the SLD electrodes may protrude over the aperture portion of the black matrix BM or an aperture portion of an adjacent black matrix BM. In other words, it will go well if parts of the SLD electrodes exist between the ST electrode and the aperture portion of the black matrix BM and between the ST electrode and the aperture portion of the adjacent black matrix BM, that is, if parts of the SLD electrodes overlap on the black matrix BM.

In Embodiment 25, a contrast ratio of 300 or more can be obtained in this embodiment.

In addition, the SLD electrodes operate as ST electrodes so as to obtain effects equivalent to those of Embodiment 27. That is, in addition to eliminating small dark or white sots caused by a protective film defect on the scanning signal line GL, there is an effect that small dark or white sots caused by protective film defects on the pixel electrodes PX, PX2 and PX3 and the source electrodes SD1, and protective film defects on the opposed electrodes CT and CT2 and the opposed electrode signal line CL are eliminated substantially perfectly, because the electrodes PX, PX2, PX3, SD1, CT and CT2 and the signal line CL are substantially equal in potential to the SLD electrodes (equal potential in DC component in the case of AC).

As described above, in this embodiment, the ST electrode connected to the scanning signal line and the SLD electrodes connected to the opposed electrodes are formed on the protective film. Thus, there is an effect that small dark or white sots caused by protective film defects on the pixel electrodes PX, PX2 and PX3 and the source electrode SD1, protective film defects on the opposed electrodes CT and CT2 and the opposed electrode signal line CL, and a protective film defect on the scanning signal line GL are eliminated substantially perfectly, because the electrodes PX, PX2, PX3, SD1, CT and CT2 and the signal lines CL and GL are substantially equal in potential to the ST electrode or the SLD electrodes (equal potential in DC component in the case of AC).

Further, in the same manner as in Embodiment 1, ionic impurities are restrained from flowing so that indeterminate black unevenness can be also restrained from being produced. Similarly, by the same effect, it is possible to reduce, on a large scale, an after image (image persistence) which is a phenomenon that, when a fixed pattern is displayed for a long time, an end of the pattern turns black.

Although these SLD electrodes have electrode shapes, they may be formed, for example, like wires (occasionally referred to as “second wires” in this specification).

(Embodiment 40) Gate-Pixel Shield

This embodiment is the same as Embodiments 1 and 40, except the following points.

FIG. 63 is a plan view showing one pixel in this embodiment. In this embodiment, an ST electrode ST is connected to a part of a scanning signal line through a through hole TH. In addition, in this embodiment, SLD electrodes SLD are connected to pixel electrodes PX through holes TH.

As a result, in the same manner as in Embodiment 40, excellent display properties can be obtained.

In addition, the SLD electrodes are equal in potential to the pixel electrode. Therefore, the SLD electrodes have an effect to substantially perfectly eliminate small dark or white spots caused by protective film defects on the pixel electrodes PX, PX2 and PX3 and the source electrode SD1, and protective film defects on the opposed electrodes CT and CT2 and the opposed electrode signal line CL, because the electrodes PX, PX2, PX3, SD1, CT and CT2 and the signal line CL are substantially equal in potential to the SLD electrodes (equal potential in DC component in the case of AC).

As described above, in this embodiment, there are obtained effects equivalent to those in Embodiment 40.

(Embodiment 41) Drain-Common Shield

This embodiment is the same as Embodiments 1 and 3, except the following points.

FIG. 64 is a plan view showing one pixel in this embodiment. In this embodiment, an ST electrode ST is connected to a part of a video signal line through a through hole TH.

In this embodiment, SLD electrodes SLD connected to the opposed electrodes through holes (contact holes) TH are disposed on opposite sides of the ST electrode connected to the video signal line. Thus, the potential of the ST electrode is shielded not to enter the display area. In other words, SLD electrodes for preventing the potential of the ST electrode from entering an active area are disposed between the ST electrode and the active area and between the ST electrode and an adjacent active area. Here, the active are a means an are a where the liquid crystal operates to contribute to display. The active area corresponds to an aperture portion of a black matrix BM. The area between the ST electrode and the active area designates the area between the ST electrode and the aperture portion of the black matrix BM. In addition, as shown in this embodiment, parts of the SLD electrodes may protrude over the aperture portion of the black matrix BM or an aperture portion of an adjacent black matrix BX. In other words, it will go well if parts of the SLD electrodes exist between the ST electrode and the aperture portion of the black matrix BM and between the ST electrode and the aperture portion of the adjacent black matrix BM, that is, if parts of the SLD electrodes overlap the black matrixes BM.

Thus, in this embodiment, the production of vertical smear which is a side effect of the ST electrode is restrained from exceeding 1%.

In addition, the SLD electrodes operate also as ST electrodes. Thus, in addition to eliminating small dark or white spots caused by a protective film defect on the video signal line DL, the SLD electrodes have an effect to substantially perfectly eliminate small dark or white spots caused by protective film defects on the pixel electrodes PX, PX2 and PX3 and the source electrode SD1, and protective film defects on the opposed electrodes CT and CT2 and the opposed electrode signal line CL, because the electrodes PX, PX2, PX3, SD1, CT and CT2 and the signal line CL are substantially equal in potential to the SLD electrodes (opposed electrode potential) (equal potentials in DC component in the case of AC).

As described above, in this embodiment, the ST electrode connected to the video signal line and the SLD electrodes connected to the opposed electrodes are formed on the protective film. Thus, there is an effect that small dark or white spots caused by protective film defects on the pixel electrodes PX, PX2 and PX3 and the source electrode SD1, protective film defects on the opposed electrodes CT and CT2 and the opposed electrode signal line CL, and a protective film defect on the scanning signal line GL are eliminated substantially perfectly, because the electrodes PX, PX2, PX3, SD1, CT and CT2 and the signal lines CL and GL are substantially equal in potential to the ST electrode or the SLD electrodes (equal potential in DC component in the case of AC).

Further, in the same manner as in Embodiment 1, ionic impurities are restrained from flowing so that indeterminate black unevenness can be also restrained from being produced. Similarly, by the same effect, it is possible to reduce, on a large scale, an after image (image persistence) which is a phenomenon that, when a fixed pattern is displayed for a long time, an end of the pattern turns black.

(Embodiment 42) Drain-Pixel Shield

This embodiment is the same as Embodiments 1 and 40, except the following points.

FIG. 65 is a plan view showing one pixel in this embodiment. In this embodiment, an ST electrode ST is connected to a part of a video signal line through a through hole TH. In addition, in this embodiment, SLD electrodes SLD are connected to pixel electrodes PX through holes TH.

In addition, the SLD electrodes are equal in potential to the pixel electrodes. Therefore,there is obtained an effect that small dark or white spots caused by protective film defects on the pixel electrodes PX, PX2 and PX3 and the source electrode SD1, and protective film defects on the opposed electrodes CT and CT2 and the opposed electrode signal line CL are eliminated substantially perfectly, because the electrodes PX, PX2, PX3, SD1, CT and CT2 and the signal line CL are substantially equal in potential to the SLD electrodes (equal potential in DC component in the case of AC).

As described above, in this embodiment, effects equivalent to those in Embodiment 40 are obtained.

(Embodiment 43) Gate, Drain-Common Shield

This embodiment is the same as Embodiments 1, 40 and 42, except the following points.

FIG. 66 is a plan view showing one pixel in this embodiment. In this embodiment, ST electrodes ST1 and ST2 are connected to a part of a video signal line and a part of a scanning signal line through holes TH respectively.

The scanning signal line has lower potential in DC component than any other electrode or wire. On the other hand, the video signal has higher potential in DC component than any other electrode or wire. Therefore, a cathode-side reduction reaction and an anode-side oxidation reaction are restrained.

In addition, in this embodiment, SLD electrodes SLD are connected to the opposed electrodes CT through holes TH. Thus, in the same manner as in Embodiments 40 and 42, the lowering of the contrast ratio and the production of vertical smear can be restrained.

Further, in this embodiment, the ST electrodes are connected to the scanning signal line and the video signal line, and the SLD electrodes are connected to the opposed electrodes. Thus, there is an effect that small dark or white spots caused by protective film defects on all the electrodes or wires are eliminated.

Further, in the same manner as in Embodiment 1, ionic impurities are restrained from flowing so that indeterminate black unevenness can be also restrained from being produced. Similarly, by the same effect, it is possible to reduce, on a large scale, an after image (image persistence) which is a phenomenon that, when a fixed pattern is displayed for a long time, an end of the pattern turns black.

(Embodiment 44) Gate, Drain-Pixel Shield

This embodiment is the same as Embodiments 1 and 43, except the following points.

FIG. 67 is a plan view showing one pixel in this embodiment. In this embodiment, ST electrodes ST1 and ST2 are connected to a part of a video signal line and a part of a scanning signal line through holes TH respectively. In addition, in this embodiment, SLD electrodes SLD are connected to pixel electrodes PX through holes TH.

As a result, effects equivalent to those in Embodiment 43 are obtained in this embodiment.

(Embodiment 45) Gate, Drain-Common Shield, Multidomain

This embodiment is the same as Embodiments 1, 29 and 44, except the following points.

FIG. 68 is a plan view showing one pixel in this embodiment. In this embodiment, ST electrodes ST1 and ST2 are connected to a part of a video signal line and a part of a scanning signal line through through holes TH respectively. In addition, in this embodiment, SLD electrodes SLD are connected to opposed electrode signal lines through through holes TH.

Further, each of pixel electrodes and the opposed electrodes is designed to have a chevron structure.

Thus, in this embodiment, effects equivalent to those of Embodiment 29 are obtained in addition to the effects of Embodiment 44.

Incidentally, in this embodiment, two opposed electrode signal lines CL are disposed in each pixel so as to be adjacent to scanning signal lines GL respectively.

Therefore, the respective SLD electrodes SLD connected to the opposed electrode signal lines CL are disposed to make the ST electrodes ST held between the SLD electrodes SLD. Thus, the SLD electrodes SLD can prevent substantial pixel areas (aperture portions of black matrixes BM) from being affected by an electric field from the ST electrodes ST.

In addition, a part of the pixel electrode PX is extended between each opposed electrode signal line CL and each SLD electrode SLD. A dielectric film used as a gate insulating film GI for a thin film transistor TFT is interposed between the pixel electrode PX and the opposed electrode signal line CL. A dielectric film used as a protective film PSV1 is interposed between the pixel electrode PX and the SLD electrode SLD.

That is, a capacitance device Cstg having a two-stage structure is formed between the pixel electrode PX and the opposed electrode signal line CL. Thus, there is an effect that a large capacitance device can be formed without increasing the area the device occupies.

(Embodiment 46) Drain-Common Shield, Multidomain

FIG. 77 is a plan view showing one pixel in this embodiment. In addition, FIG. 78 shows a sectional view taken on line A-A′ in FIG. 77; FIG. 79, a sectional view taken on line B-B′ in FIG. 77; FIG. 80, a sectional view taken on line C-C′ in FIG. 77; FIG. 81, a sectional view taken on line D-D′ in FIG. 77; and FIG. 82, a sectional view taken on line E-E′ in FIG. 77.

This embodiment is the same as Embodiment 45 (FIG. 68), except the following points.

In comparison with the case of Embodiment 45 (FIG. 68), the respective drawings show a structure in which the ST electrode ST2 connected to the gate signal line GL through the contact hole is not provided.

FIG. 83 is a sectional view for explaining another embodiment of the present invention. FIG. 83 corresponds to FIG. 82. In this embodiment, the ST electrode ST1 in FIG. 82 is omitted. Also in this embodiment, effects similar to those in the above embodiment are obtained.

(Embodiment 48) Common Shield

FIG. 84 is a plan view showing another embodiment of one pixel of a liquid crystal display unit according to the present invention.

FIG. 84 corresponds to FIG. 77, except the configuration that the ST electrode ST1 connected to the drain signal line DL is not provided.

This is because, if there is a protective film defect on the scanning signal line GL, each electrode ST3 surrounds the defect so that most of electric flux lines generated from the defect portion converge on the electrode ST3. Thus, a charging current hardly flows into the protective film capacitance surrounding the defect portion. On the other hand, ions in the liquid crystal are charged up to be minus in the defect portion. However, the electrode ST3 connected to the opposed voltage signal line CL is higher in potential than the scanning signal line GL. Therefore, the minus ions discharge electricity to the electrode ST3 immediately. As a result, the minus ions are difficult to diffuse to the surrounding pixels. It is therefore possible to reduce both the size and the intensity of small dark or white spots.

Incidentally, if the electrode width of the electrode ST3 is enlarged, the above-mentioned discharge quantity of the minus ions can be increased. Thus, both the size and the intensity of small dark or white spots can be further reduced.

That is, there is a potential difference of about 10 V between the scanning signal line GL and any other electrode. This value is much larger than that between the other electrodes. Accordingly, if there is a protective film defect on the scanning signal line GL, a charging current flowing into the protective film capacitance surrounding the defect portion becomes extremely large.

On the other hand, the electrode width of the electrode ST3 in the direction parallel with the video signal line DL is set to a width enough to be disposed outside the aperture pattern (transmission area) of the opposed electrode signal line CL.

(Embodiment 49) Common Ring

FIG. 85 is a plan view showing another embodiment of one pixel of a liquid crystal display unit according to the present invention. FIG. 86 shows a sectional view taken on line F-F in FIG. 85.

FIG. 85 corresponds to FIG. 84, except the configuration that the ST electrodes ST3 connected to the opposed voltage signal lines CL surround the aperture pattern (light transmission area) in cooperation with the electrodes CT2.

With this structure, it is also possible to reduce, on a large scale, both the size and the intensity of small dark or white spots caused by a protective film defect on the video signal line DL.

This is because, if there is a protective film defect on the video signal line DL, each electrode ST3 surrounds the defect so that the relative distance between the electrode ST3 and the defect portion is reduced. Accordingly, most of electric flux lines generated from the defect portion converge on the electrode ST3. Thus, a charging current flowing into the protective film capacitance surrounding the defect portion is shielded effectively. On the other hand, ions in the liquid crystal are charged up to be plus in the defect portion. However, the potential of the electrode ST3 connected to the opposed electrode signal line CL is about 1 to 2 V lower than the average potential of the video signal line DL. Therefore, the plus ions discharge electricity to the surrounding electrode ST3 immediately. As a result, the plus ions becomes difficult to diffuse to the surrounding pixels. It is therefore possible to reduce both the size and the intensity of small dark or white spots on a large scale.

In addition, also as for a protective film defect on the scanning signal line GL, both the size and the intensity of small dark or white spots can be reduced on a large scale in the same manner as in Embodiment 47 (FIG. 22).

That is, each electrode ST3 in this embodiment is disposed between the aperture pattern (light transmission area) and the video and scanning signal lines DL and GL so as to surround the aperture pattern (light transmission area). Thus, the size and the intensity of small dark or white spots are reduced.

(Embodiment 50) Another Modification of Horizontal Electric Field System

This embodiment is the same as Embodiments 1 and 25, except the following points.

FIG. 69 is a plan view showing a pixel in this embodiment. In this embodiment, an ST electrode ST is connected to a part of a scanning signal line through a through hole TH.

In this embodiment, only the pixel electrode PX is formed like comb teeth while the opposed electrode CT is formed into a sheet electrode. When the opposed electrode CT is formed like a sheet, the pixel electrode PX and the opposed electrode CT overlap each other in plan. Thus, an extremely intensive fringe electric field (including a horizontal electric field) is generated to drive the liquid crystal on the electrodes. Therefore, in this embodiment, the pixel electrode PX and the opposed electrode CT are made of transparent conductive films of ITO, IZO or the like so as to allow light to transmit through those electrode portions. Thus, the transmissivity is improved. Further, in this embodiment, since the opposed electrode CT is formed into a sheet electrode, the distance between the pixel electrode and the opposed electrode becomes extremely narrow. Thus, the drive voltage can be reduced on a large scale.

In addition, in this embodiment, the pixel electrode PX is formed on the protective film PSV. Therefore, the pixel electrode PX also operates as an ST electrode. In addition, the pixel electrodes PX are inevitably formed on opposite sides of the ST electrode connected to a part of the scanning signal line. Thus, the pixel electrode PX also operates as an SLD electrode.

Thus, there is obtained an effect that small dark or white spots stains caused by protective film defects on the pixel electrodes PX, PX2 and PX3 and the source electrode SD1, protective film defects on the opposed electrodes CT and CT2 and the opposed electrode signal line CL, and a protective film defect on the scanning signal line GL are eliminated substantially.

Incidentally, in this embodiment, if the permittivity anisotropy of the liquid crystal material is negative, that is, if a material in which the permittivity in the optical axis direction of liquid crystal molecules is smaller than the permittivity in the direction perpendicular to the optical axis direction is used, a higher transmissivity can be obtained. If the permittivity anisotropy of the liquid crystal material is positive, that is, if a material in which the permittivity in the optical axis direction of liquid crystal molecules is larger than the permittivity in the direction perpendicular to the optical axis direction is used, the driving voltage can be reduced.

In addition, although the pixel electrode PX is made to have a chevron structure in this embodiment, it may have a linear structure like other embodiments. Further, although the pixel electrode is formed on the protective film in this embodiment, the opposed electrode may be formed on the protective film. Not to say, any combination between this embodiment and other embodiments is included in the category of the present invention.

[Effects of the Invention]

As described above, in the present invention, an ST electrode ST is provided newly and formed on a protective film. Alternatively, the ST electrode ST is formed on a flattening film or a color filter. In other words, the ST electrode ST is formed under an alignment film. Thus, in a TFT-LCD in an IPS mode (including an FFS mode), spot-like black unevenness (nuclear stains) generated when there are protective film defects on respective electrodes and wires can be restrained by the provision of the ST electrode ST.

Further, in this embodiment, small dark or white spots are restrained while a new charging current is prevented from being generated in protective film capacitance. Thus, ionic impurities are restrained from flowing so that indeterminate black unevenness can be also restrained from being produced. Similarly, by the same effect, it is possible to reduce, on a large scale, an after image (image persistence) which is a phenomenon that, when a fixed pattern is displayed for a long time, an end of the pattern turns black.

What is claimed is

1. A liquid crystal display unit comprising:
a liquid crystal layer held between a pair of substrates; and
a plurality of pixels formed into a matrix on one of said pair of substrates by a plurality of scanning signal lines and a plurality of video signal lines;
wherein each of said plurality of pixels includes:
a pixel electrode formed on said one of said pair of substrates, and supplied with a video signal from corresponding one of said video signal lines through a corresponding thin film transistor on the basis of a scanning signal from corresponding one of said scanning signal lines; and
opposed electrodes formed on said one of said pair of substrates, and supplied with an opposed voltage through an opposed voltage signal line;
wherein a protective film is formed between said liquid crystal layer and at least one group selected from a group of said scanning signal lines and a group of said video signal lines;
a through hole exposing at least one of said electrodes and lines to said liquid crystal layer is formed onto said protective film.

2. A liquid crystal display unit comprising:
a liquid crystal layer held between a pair of substrates; and
a plurality of pixels formed into a matrix on one of said pair of substrates by a plurality of scanning signal lines and a plurality of video signal lines;
wherein each of said plurality of pixels includes:
a pixel electrode formed on said one of said pair of substrates, and supplied with a video signal from corresponding one of said video signal lines through a corresponding thin film transistor on the basis of a scanning signal from corresponding one of said scanning signal lines; and
opposed electrodes formed on said one of said pair of substrates, and supplied with an opposed voltage through an opposed voltage signal line;
wherein a protective film is formed between said liquid crystal layer and at least one group selected from a group of said scanning signal lines and a group of said video signal lines;
wherein at least one first electrode or wire connected to corresponding one of said scanning signal lines or corresponding one of said video signal lines in said plurality of pixels is formed on said protective film; and
wherein second electrodes or wires connected to at least one group selected from a group of said pixel electrodes, a group of said opposed electrodes and a group said opposed voltage signal lines are formed on opposite sides of said first electrode or wire on said protective film.

3. A liquid crystal display unit comprising:
a liquid crystal layer held between a pair of substrates; and
a plurality of pixels formed into a matrix on one of said pair of substrates by a plurality of scanning signal lines and a plurality of video signal lines;
wherein each of said plurality of pixels includes:
a pixel electrode formed on said one of said pair of substrates, and supplied with a video signal from corresponding one of said video signal lines through a corresponding thin film transistor on the basis of a scanning signal from corresponding one of said scanning signal lines; and
opposed electrodes formed on said one of said pair of substrates, and supplied with an opposed voltage through an opposed voltage signal line;
wherein a protective film is formed between said liquid crystal layer and at least one group selected from a group of said scanning signal lines and a group of said video signal lines;
wherein at least one first electrode or wire connected to corresponding one of said scanning signal lines or corresponding one of said video signal lines in said plurality of pixels through a contact hole is formed on said protective film;
wherein at least two second electrodes or wires connected to at least one group selected from a group of said pixel electrodes, a group of said opposed electrodes and a group of said opposed voltage signal lines in said plurality of pixels are formed on said protective film;
wherein a black matrix is formed on said one or the other of said pair of substrates; and
wherein at least a part of said second electrodes or wires is formed between said first electrode or wire and an aperture portion of said black matrix.

4. A liquid crystal display unit comprising:
a liquid crystal layer held between a pair of substrates; and
a plurality of pixels formed into a matrix on one of said pair of substrates by a plurality of scanning signal lines and a plurality of video signal lines;
wherein each of said plurality of pixels includes:
a pixel electrode formed on said one of said pair of substrates, and supplied with a video signal from corresponding one of said video signal lines through a corresponding thin film transistor on the basis of a scanning signal from corresponding one of said scanning signal lines; and
opposed electrodes formed on said one of said pair of substrates, and supplied with an opposed voltage through an opposed voltage signal line so as to form a light transmission area for changing light transmissivity of said liquid crystal layer through an electric field generated between said opposed electrodes and said pixel electrode;
wherein a protective film is formed between said liquid crystal layer and at least one group selected from a group of said scanning signal lines and a group of said video signal lines;
wherein a first electrode or wire connected to corresponding one of said scanning signal lines or corresponding one of said video signal lines is formed on said protective film;
wherein a second electrode or wire connected to at least one of said pixel electrodes, said opposed electrodes and said opposed voltage signal lines is formed on said protective film; and
wherein at least a part of said second electrode or wire is formed between said first electrode or wire and said light transmission area.

5. A liquid crystal display unit comprising:
a liquid crystal layer held between a pair of substrates; and
a plurality of pixels formed into a matrix on one of said pair of substrates by a plurality of scanning signal lines and a plurality of video signal lines;
wherein each of said plurality of pixels includes:
a pixel electrode formed on said one of said pair of substrates, and supplied with a video signal from corresponding one of said video signal lines through a corresponding thin film transistor on the basis of a scanning signal from corresponding one of said scanning signal lines; and
opposed electrodes formed on said one of said pair of substrates, and supplied with an opposed voltage through an opposed voltage signal line;
wherein a protective film is formed between said liquid crystal layer and at least one group selected from a group of said scanning signal lines and a group of said video signal lines;
wherein at least one first electrode or wire connected to corresponding one of said scanning signal lines or corresponding one of said video signal lines in said plurality of pixels through a contact hole is formed on said protective film;
wherein at least two second electrodes or wires connected to at least one group selected from a group of said pixel electrodes, a group of said opposed electrodes and a group of said opposed voltage signal lines in said plurality of pixels are formed on said protective film;
wherein a black matrix is formed on said one or the other of said pair of substrates; and
wherein at least a part of said second electrodes or wires is formed to overlap said black matrix.

6. A liquid crystal display unit according to any one of claims 1 to 5, wherein a protective film is formed between said liquid crystal layer and at least one group selected from said group of said pixel electrodes, said group of said opposed electrodes and said group of said opposed voltage signal lines.

7. A liquid crystal display unit comprising:
a liquid crystal layer held between a pair of substrates; and
a plurality of pixels formed into a matrix on one of said pair of substrates by a plurality of scanning signal lines and a plurality of video signal lines;
wherein each of said plurality of pixels includes:
a pixel electrode formed on said one of said pair of substrates, and supplied with a video signal from corresponding one of said video signal lines through a corresponding thin film transistor on the basis of a scanning signal from corresponding one of said scanning signal lines; and
opposed electrodes formed on said one of said pair of substrates, and supplied with an opposed voltage through an opposed voltage signal line;
wherein a protective film is formed between said liquid crystal layer and each of said scanning signal lines, said video signal lines, said pixel electrodes, said opposed electrodes and said opposed voltage signal lines;
wherein at least one first electrode or wire connected to corresponding one of said scanning signal lines or corresponding one of said video signal lines in said plurality of pixels through a contact hole is formed on said protective film;
wherein at least two second electrodes or wires connected to at least one group selected from a group of said pixel electrodes, a group of said opposed electrodes and a group of said opposed voltage signal lines in said plurality of pixels through contact holes are formed on said protective film; and
wherein said second electrodes or wires are formed on opposite sides of said first electrode or wire.

8. A liquid crystal display unit comprising:
a liquid crystal layer held between a pair of substrates; and
a plurality of pixels formed into a matrix on one of said pair of substrates by a plurality of scanning signal lines and a plurality of video signal lines;
wherein each of said plurality of pixels includes:
a pixel electrode formed on said one of said pair of substrates, and supplied with a video signal from corresponding one of said video signal lines through a corresponding thin film transistor on the basis of a scanning signal from corresponding one of said scanning signal lines; and
opposed electrodes formed on said one of said pair of substrates, and supplied with an opposed voltage through an opposed voltage signal line;
wherein a protective film is formed between said liquid crystal layer and each of said scanning signal lines, said video signal lines, said pixel electrodes, said opposed electrodes and said opposed voltage signal lines;
wherein at least one first electrode or wire connected to corresponding one of said scanning signal,lines or corresponding one of said video signal lines in said plurality of pixels through a contact hole is formed on said protective film;
wherein at least two second electrodes or wires connected to at least one group selected from a group of said pixel electrodes, a group of said opposed electrodes and a group of said opposed voltage signal lines in said plurality of pixels through contact holes are formed on said protective film;
wherein a black matrix is formed on said one or the other of said pair of substrates; and
wherein at least a part of said second electrodes or wires is formed between said first electrode or wire and an aperture portion of said black matrix.

9. A liquid crystal display unit comprising:
a liquid crystal layer held between a pair of substrates; and
a plurality of pixels formed into a matrix on one of said pair of substrates by a plurality of scanning signal lines and a plurality of video signal lines;
wherein each of said plurality of pixels includes:
a pixel electrode formed on said one of said pair of substrates, and supplied with a video signal from corresponding one of said video signal lines through a corresponding thin film transistor on the basis of a scanning signal from corresponding one of said scanning signal lines; and
opposed electrodes formed on said one of said pair of substrates, and supplied with an opposed voltage through an opposed voltage signal line;
wherein a protective film is formed between said liquid crystal layer and each of said scanning signal lines, said video signal lines, said pixel electrodes, said opposed electrodes and said opposed voltage signal lines;
wherein at least one first electrode or wire connected to corresponding one of said scanning signal lines or corresponding one of said video signal lines in said plurality of pixels through a contact hole is formed on said protective film;
wherein at least two second electrodes or wires connected to at least one group selected from a group of said pixel electrodes, a group of said opposed electrodes and a group of said opposed voltage signal lines in said plurality of pixels through contact holes are formed on said protective film;
wherein a black matrix is formed on said one or the other of said pair of substrates; and
wherein at least a part of said second electrodes or wires is formed to overlap said black matrix.

10. A liquid crystal display unit according to any one of claims 1 to 9, wherein at least one group selected from said group of said pixel electrodes and said group of said opposed electrodes is formed like comb teeth.

11. A liquid crystal display unit according to anyone of claims 1 to 9, wherein one group selected from said group of said pixel electrodes and said group of said opposed electrodes is formed like comb teeth while the other group selected from said group of said pixel electrodes and said group of said opposed electrodes is formed like sheets.

12. A liquid crystal display unit comprising:
a liquid crystal layer held between a pair of substrates; and
a plurality of pixels formed into a matrix on one of said pair of substrates by a plurality of scanning signal lines and a plurality of video signal lines;
wherein each of said plurality of pixels includes:
a pixel electrode formed on said one of said pair of substrates, and supplied with a video signal from corresponding one of said video signal lines through a corresponding thin film transistor on the basis of a scanning signal from corresponding one of said scanning signal lines; and
opposed electrodes formed on said one of said pair of substrates, and supplied with an opposed voltage through an opposed voltage signal line;
wherein a protective film is formed between said liquid crystal layer and each of said scanning signal lines, said video signal lines, said pixel electrodes, said opposed electrodes and said opposed voltage signal lines;
wherein at least one first electrode or wire connected to corresponding one of said scanning signal lines or corresponding one of said video signal lines in said plurality of pixels through a contact hole is formed on said protective film;
wherein one group selected from a group of said pixel electrodes and a group of said opposed electrodes is formed on said protective film so as to be shaped like comb teeth; and
while the other group selected from said group of said pixel electrodes and said group of said opposed electrodes is formed like sheets.

13. A liquid crystal display unit comprising:
a liquid crystal layer held between a pair of substrates; and
a plurality of pixels formed into a matrix on one of said pair of substrates by a plurality of scanning signal lines and a plurality of video signal lines;
wherein each of said plurality of pixels includes:
a pixel electrode formed on said one of said pair of substrates, and supplied with a video signal from corresponding one of said video signal lines through a corresponding thin film transistor on the basis of a scanning signal from corresponding one of said scanning signal lines; and
opposed electrodes formed on said one of said pair of substrates, and supplied with an opposed voltage through an opposed voltage signal line disposed adjacently to said corresponding scanning signal line;
wherein a protective film is formed between said liquid crystal layer and at least said opposed voltage signal lines;
wherein at least one first electrode or wire connected to corresponding one of said scanning signal lines or corresponding one of said video signal lines in said plurality of pixels so as to overlap said corresponding scanning signal line or said corresponding video signal line is formed on said protective film;
wherein a second electrode or wire connected to corresponding one of said opposed voltage signal lines so as to overlap said corresponding opposed voltage signal line is formed on said protective film;
wherein a part of a pixel electrodes is elongated between said second electrode or wire and said opposed voltage signal line; and
wherein dielectric films are interposed between said pixel electrodes and said second electrode or wire and between said pixel electrodes and said opposed voltage signal lines respectively.

14. A liquid crystal display unit according to claim 12, wherein a dielectric film for use as said protective film is interposed between said pixel electrodes and said second electrode or wire, while a dielectric film for use as a gate insulating film for said thin film transistors is interposed between said pixel electrodes and said opposed voltage signal lines.

15. A liquid crystal display unit according to any one of claims 1 to 14, wherein as said first electrode or wire, at least one electrode or wire is formed in every pixel of said plurality of pixels.

16. A liquid crystal display unit according to any one of claims 1 to 13, wherein as said first electrode or wire, a plurality of electrodes or wires are formed in every pixel of said plurality of pixels.

17. A liquid crystal display unit according to any one of claims 1 to 16, wherein as said second electrodes or wires, at least two electrodes or wires are formed in every pixel of said plurality of pixels.

18. A liquid crystal display unit according to any one of claims 1 to 17, wherein said first electrode or wire is formed of an oxide electric conductor.

19. A liquid crystal display unit according to any one of claims 1 to 18, wherein said second electrodes or wires are formed of an oxide electric conductor.

20. A liquid crystal display unit according to claims 18 or 19, wherein said oxide electric conductor is ITO or IZO.

21. A liquid crystal display unit according to any one of claims 1 to 20, wherein said protective film is a film of at least one layer made of an inorganic material.

22. A liquid crystal display unit according to any one of claims 1 to 20, wherein said protective film is a film of at least one layer made of an organic material.

23. A liquid crystal display unit according to anyone of claims 1 to 20, wherein said protective film is a laminate film constituted by a film of at least one layer made of an inorganic material and a film of at least one layer made of an organic material.

24. A liquid crystal display unit according to claims 21 or 23, wherein said inorganic material is a material containing either silicon nitride or silicon oxide.

25. A liquid crystal display unit according to claims 22 or 23, wherein said organic material is a material containing one of acrylic resin, epoxy, and polyimide.

26. A liquid crystal display unit comprising:
a liquid crystal layer held between a pair of substrates; and
a plurality of pixels formed into a matrix on one of said pair of substrates by a plurality of scanning signal lines and a plurality of video signal lines;
wherein each of said plurality of pixels includes:
a pixel electrode formed on said one of said pair of substrates, and supplied with a video signal from corresponding one of said video signal lines through a corresponding thin film transistor on the basis of a scanning signal from corresponding one of said scanning signal lines; and
opposed electrodes formed on said one of said pair of substrates, and supplied with an opposed voltage through an opposed voltage signal line;
wherein said opposed voltage signal lines are formed correspondingly adjacently to and in parallel with said scanning signal lines, while a protective film is formed between said opposed voltage signal lines and said liquid crystal layer; and
wherein an electrode or a wire connected to said opposed voltage signal lines is formed on said protective film.

27. A liquid crystal display unit comprising:
a liquid crystal layer held between a pair of substrates; and
a plurality of pixels formed into a matrix on one of said pair of substrates by a plurality of scanning signal lines and a plurality of video signal lines;
wherein each of said plurality of pixels includes:
a pixel electrode formed on said one of said pair of substrates, and supplied with a video signal from corresponding one of said video signal lines through a corresponding thin film transistor on the basis of a scanning signal from corresponding one of said scanning signal lines; and
opposed electrodes formed on said one of said pair of substrates, and supplied with an opposed voltage through an opposed voltage signal line formed adjacently to and in parallel with said scanning signal line;
wherein at least one first electrode or wire connected to corresponding one of said video signal lines in said plurality of pixels so as to overlap said corresponding scanning signal line is formed on a protective film; and
wherein second electrodes or wires connected to said opposed voltage signal lines are formed on opposite sides of said first electrode or wire on said protective film.

28. A liquid crystal display unit comprising:
a liquid crystal layer held between a pair of substrates; and
a plurality of pixels formed into a matrix on one of said pair of substrates by a plurality of scanning signal lines and a plurality of video signal lines;
wherein each of said plurality of pixels includes:
a pixel electrode formed on said one of said pair of substrates, and supplied with a video signal from corresponding one of said video signal lines through a corresponding thin film transistor on the basis of a scanning signal from corresponding one of said scanning signal lines; and
opposed electrodes formed on said one of said pair of substrates, and supplied with an opposed voltage through an opposed voltage signal line formed adjacently to and in parallel with said scanning signal line;
wherein at least one first electrode or wire connected to corresponding one of said video signal lines in said plurality of pixels so as to overlap said corresponding scanning signal line is formed on a protective film; and
wherein second electrodes or wires connected to said opposed voltage signal lines through contact holes are formed on opposite sides of said first electrode or wire on said protective film.

29. A liquid crystal display unit comprising:
a liquid crystal layer held between a pair of substrates; and
a plurality of pixels formed into a matrix on one of said pair of substrates by a plurality of scanning signal lines and a plurality of video signal lines;
wherein each of said plurality of pixels includes:
a pixel electrode formed on said one of said pair of substrates, and supplied with a video signal from corresponding one of said video signal lines through a corresponding thin film transistor on the basis of a scanning signal from corresponding one of said scanning signal lines; and
opposed electrodes formed on said one of said pair of substrates, and supplied with an opposed voltage through an opposed voltage signal line formed adjacently to and in parallel with said scanning signal line;
wherein at least one first electrode or wire connected to corresponding one of said video signal lines in said plurality of pixels so as to overlap said corresponding scanning signal line is formed on a protective film;
wherein second electrodes or wires connected to said opposed voltage signal lines are formed on opposite sides of said first electrode or wire on said protective film;
wherein a black matrix is formed on said one or the other of said pair of substrates; and
wherein at least a part of said second electrodes or wires is formed between said first electrode or wire and an aperture portion of said black matrix.

30. A liquid crystal display unit comprising:
a liquid crystal layer held between a pair of substrates; and
a plurality of pixels formed into a matrix on one of said pair of substrates by a plurality of scanning signal lines and a plurality of video signal lines;
wherein each of said plurality of pixels includes:
a pixel electrode formed on said one of said pair of substrates, and supplied with a video signal from corresponding one of said video signal lines through a corresponding thin film transistor on the basis of a scanning signal from corresponding one of said scanning signal lines; and
opposed electrodes formed on said one of said pair of substrates, and supplied with an opposed voltage through an opposed voltage signal line;
wherein said opposed voltage signal lines are formed correspondingly adjacently to and in parallel with said scanning signal lines, while a protective film is formed between said opposed voltage signal lines and said liquid crystal layer;
wherein a black matrix is formed on said one or the other of said pair of substrates; and
wherein an electrode or a wire connected to said opposed voltage signal lines is formed on said protective film so as to surround an aperture portion of said black matrix.

31. A liquid crystal display unit according to claim 28 or 29, wherein said second electrodes or wires connected to said opposed voltage signal lines are formed in one pixel so as to extend in a direction in which said opposed electrode signal lines extend.

32. A liquid crystal display unit according to any one of claims 28 to 30, wherein a dielectric film for use as said protective film is interposed between said pixel electrodes and said second electrodes or wires, while a dielectric film for use as a gate insulating film for said thin film transistors is interposed between said pixel electrodes and said opposed voltage signal lines.

33. A liquid crystal display unit according to any one of claims 28 to 30, wherein said first electrode or wire is formed of an oxide electric conductor.

34. A liquid crystal display unit according to any one of claims 28 to 30, wherein said second electrodes or wires are formed of oxide electric conductors.

35. A liquid crystal display unit according to any one of claims 26 to 30, wherein said protective film is a film of at least layer made of an inorganic material.

36. A liquid crystal display unit according to any one of claims 26 to 30, wherein said protective film is a film of at least layer made of an organic material.

37. A liquid crystal display unit according to any one of claims 26 to 30, wherein at least one group selected from a group of said pixel electrodes and a group of said opposed electrodes is formed like comb teeth.

38. A liquid crystal display unit according to any one of claims 26 to 30, wherein one group selected from a group of said pixel electrodes and a group of said opposed electrodes is formed like comb teeth while the other group selected from said group of said pixel electrodes and said group of said opposed electrodes is formed like sheets.

39. A liquid crystal display unit according to any one of claims 26 to 30, wherein no electrode or no wire is formed on said protective film on said scanning signal lines to be connected to said scanning signal line through any contact hole.
